(19) United States
(12) Patent Application Publication
(10) Pub. No.: US 2025/0275532 A1
(43) Pub. Date: Sep. 4, 2025

(54) LOW DRIFT AQUEOUS LIQUID FORMULATIONS FOR LOW, MEDIUM, AND HIGH SPRAY VOLUME APPLICATION

(71) Applicant: BAYER AKTIENGESELLSCHAFT, LEVERKUSEN (DE)

(72) Inventors: Malcom Andrew FAERS, Dusseldorf (DE); Arno RATSCHINSKI, Dusseldorf (DE)

(21) Appl. No.: 18/863,772

(22) PCT Filed: May 4, 2023
(86) PCT No.: PCT/EP2023/061762

§ 371 Date: Nov. 7, 2024

(30) Foreign Application Priority Data
May 7, 2022 (EP) 22172206.9

(51) Int. Cl. A01N 25/24; A01N 25/06; A01N 37/18; A01N 37/40; A01N 41/10; A01N 43/12; A01N 43/56; A01N 43/653; A01N 43/66; A01N 43/80; A01N 47/06; A01N 53/00; A01P 7/04

(52) U.S. Cl. CPC A01N 25/24; A01N 25/06; A01N 37/18; A01N 37/40; A01N 41/10; A01N 43/12; A01N 43/56; A01N 43/653; A01N 43/66; A01N 43/80; A01N 47/06; A01N 53/00; A01P 7/04

(57) ABSTRACT

The instant invention is directed to low drift aqueous liquid formulations for low, medium, and high 5 spray volume application, which contain a combination of different drift reducing agents.

The instant invention is directed to low drift aqueous liquid formulations for low, medium, and high spray volume application, which contain a combination of different drift reducing agents.

Low and medium volume spray applications are becoming more and more popular, since they require less water, lighter vehicles, and in some cases, less adjuvants to be brought into the environment.

However, formulations currently in the market are often available only for high or medium spray volumes, or low and medium spray volumes, but never cover all ranges. For the farmer it is nevertheless desired and economically feasible, if one formulation could be used for all types of application depending on the application method, requirements, environmental conditions etc.

On the other hand, it is of economic advantage for the supplier to provide only one formulation for all ranges.

It is known in the art that different drift reducing additives work better at different spray volumes owing to their different concentrations in the spray liquid after dilution.

Polymer-based drift reducing additives work best at higher concentrations where their viscosity increasing effect is stronger. However, drift reducing polymers increase the viscosity of flowable formulations and there is a viscosity upper limit beyond which the formulation is too thick to use. A consequence of this is that in a 1 l/ha formulation it is difficult to include sufficient polymer to reduce drift when sprayed at high spray volumes since the high amount of polymer makes the formulation too viscous to use. However, this is not the case at low spray volumes where much lower amounts of polymer are required in the formulation to give an effective concentration in the spray liquid. Conversely, a formulation containing sufficient polymer to reduce drift at high spray volumes will be unsprayable at low spray volumes where the high polymer concentration will stop with the atomization process, making the spray liquid unsprayable.

Oil-based drift reducing additives work well over a wide range of concentrations. However, their effect can be reduced by required surfactants in the formulation either as dispersants, wetters, spreading agents or uptake enhancing agents with the consequence that oil-based drift reducing additives can lose their effect at lower spray volumes where the concentration of these surfactants in the spray liquid is higher.

There is therefore a need for drift reducing additives that can work at both low and high spray volumes without causing high viscosity or other undesired effects in the formulation. This is achieved by the invention here where both polymer-based drift reducing additives and oil-based drift reducing additives are combined in effective levels in formulations. This invention is especially beneficial when the formulation contains surfactant-based spreading and uptake enhancing additives since otherwise these formulations risk higher drift and off-field losses.

The combination of hydroxypropylated guar or other guar gums with oils in drift reducing compositions is already disclosed in US2002/108415 A1, WO2022/023255 A1, WO2021/127865 A1 and US2018/184647 A1. However, the oil component is always used in very high amounts and serves different purposes beside drift-reduction, e.g. as carrier and uptake enhancer.

Oils in addition to drift reduction effects are also commonly used as uptake enhancing agents but here the amount required is much higher, typically 100 to 500 g/ha, which leaves little space in the formulation to include a second polymer drift reducing agent. In this context the amount of drift reducing oil in the formulation according to the invention is much lower than 100 g/ha allowing a second polymer drift reducing agent to be readily included in the formulation.

Furthermore, the various surfactant-based components in formulations increase their concentration in the spray liquid as the spray volume decreases. The relative high concentration of these surfactants at low spray volumes can neutralize the drift reducing effect of oils, thus necessitating the requirement of a second drift reducing agent that can still reduce drift in the presence of higher surfactant concentrations. This can be achieved by drift reducing polymers. It is also important to note in this context that every further adjuvant can affect the efficacy and handling of the formulation as well as interact physically and chemically with other adjuvants and active ingredients, leading to unstable or efficacy reduced formulations.

Surprisingly, it has been found that agrochemical formulations comprising combinations of certain polymers and oils in quite low concentrations provide a drift reduction in formulations over a wide range of spray volumes.

The respective formulations are described in the following.

In one aspect, the invention refers to an agrochemical formulation comprising:
a) One or more active ingredient,
b) one or more polymer-based drift reducing additive selected from the group of poly(ethylene-oxide) (PEO in the following) and hydroxypropylated guar (HP guar in the following),
c) one or more oil-based drift reducing additive,
d) one or more spreading agents and/or uptake promoting additive,
e) other formulants,
f) one or more carrier to volume, wherein at least one carrier is water,
   wherein a) is present in 10-550 g/l, preferably in 15-300 g/l, and more preferably in 20-200 g/l,
   wherein b) is present in 0.2-50 g/l, preferably in 0.5-40 g/l, and more preferably in 1-15 g/l,
   wherein c) is present in 0.5-45 g/l, preferably in 1-30 g/l, and more preferably in 5-25 g/l,
   wherein d) is present in 10-200 g/l, preferably in 20-160 g/l, and more preferably in 25-140 g/l, and
   wherein e) is present in 20-300 g/l, preferably in 30-180 g/l, and more preferably in 30-135 g/l.

In a preferred embodiment,
a) is present in 10-550 g/l,
b) is present in 0.2-50 g/l,
c) is present in 0.5-45 g/l,
d) is present in 10-200 g/l,
e) is present in 20-300 g/l,
f) carrier to volume.

In a further preferred embodiment
a) is present in 15-300 g/l,
b) is present in 0.5-40 g/l,
c) is present in 1-30 g/l,
d) is present in 20-160 g/l,
e) is present in 30-180 g/l,
f) carrier to volume.

In an even further preferred embodiment
a) is present in 20-200 g/l,
b) is present in 1-15 g/l,
c) is present in 5-25 g/l,
d) is present in 25-140 g/l,
e) is present in 30-135 g/l,
f) carrier to volume.

It is understood that in case of combinations of various components, the percentages of all components of the formulation always sum up to 100.

If not otherwise indicated, % in this application means percent by weight (% w/w).

Further, if not otherwise indicated, the reference “to volume” for the carrier indicates that the carrier, especially water, is added to a total volume of the formulation of 1000 ml (11). For the sake of clarity it is understood that if unclear the density of the formulation is understood as to be 1 g/cm³.

If not otherwise defined in this application, the molecular weight refers to the weight-average molecular weight Mw which is determined by GPC in methylene chloride at 25° C. with polystyrene as the standard.

In the context of the instant invention, the formulation can be applied using the wide range of spray volumes from 1 l/ha to 2000 l/h, preferably 5 l/ha to 1500 l/ha and more preferably from 8 l/ha to 1200 l/ha.

One further aspect of the present invention is therefore a method of applying a formulation according to the invention onto crops, wherein the formulation is applied at a spray volume of between 1 l/ha to 2000 l/ha, preferably 5 l/ha to 1500 l/ha and more preferably from 8 l/ha to 1200 l/ha.

Another aspect of the present invention is therefore the use of the formulation according to the invention for applying it onto crops, wherein the formulation is applied at a spray volume of between 1 l/ha to 2000 l/ha, preferably 5 l/ha to 1500 l/ha and more preferably from 8 l/ha to 1200 l/ha.

Moreover, for low spray volumes the formulation according to the instant invention is applied at a spray volume of between 1 and 25 l/ha, preferably 2 and 20 l/ha, and more preferably 5 and 15 l/ha.

One further aspect of the present invention is therefore a method of applying a formulation according to the invention onto crops, wherein the formulation is applied at a spray volume of between 1 and 25 l/ha, preferably 2 and 20 l/ha, and more preferably 5 and 15 l/ha.

Another aspect of the present invention is therefore the use of the formulation according to the invention for applying it onto crops, wherein the formulation is applied at a spray volume of between 1 and 25 l/ha, preferably 2 and 20 l/ha, and more preferably 5 and 15 l/ha.

Preferably the formulation is applied at the above-mentioned spray volumes as a spray liquid containing the formulation.

The ratio in the formulation according to the invention of b) to c) is from 1:40 to 10:1, more preferably from 1:10 to 5:1, most preferred 1:6 to 2:1.

The ratio in the formulation according to the invention of b) to c) to d) is from 1:40:150 to 10:1:10, more preferably from 1:12:120 to 2:1:5, most preferred 1:8:50 to 1:2:5.

Preferably the above mentioned ratios are also the same for a spray liquid containing the formulation.

On further aspect of the invention is the use of the formulation according to the invention to deliver to the agricultural target plot:

An amount of b) between 0.5 and 15 g/ha, more preferably between 1 and 12 g/ha, most preferred between 1 and 10 g/ha.

An amount of c) between 0.5 and 40 g/ha, more preferably between 1 and 20 g/ha, most preferred between 2 and 10 g/ha.

An amount of d) between 10 and 200 g/ha, more preferably between 15 and 160 g/ha, most preferred between 20 and 100 g/ha.

In a further preferred embodiment of the present invention the formulation consists only of the above described ingredients a) to f) in the specified amounts and ranges.

Further, it is understood, that the preferred given ranges of the application volumes or application rates as well as of the respective ingredients as given in the instant specification can be freely combined and all combinations are disclosed herein, however, in a more preferred embodiment, the ingredients are preferably present in the ranges of the same degree of preference, and even more preferred the ingredients are present in the most preferred ranges.

In the context of the present invention, suitable formulation types are by definition suspension concentrates, aqueous suspensions, suspo-emulsions, capsule suspensions, aqueous dispersion concentrates, soluble liquids, aqueous emulsions or aqueous emulsion concentrates, preferably suspension concentrates, aqueous suspensions and suspo-emulsions.

### Active Ingredients a):

The active compounds identified here by their common names are known and are described, for example, in the pesticide handbook (“The Pesticide Manual” 16th Ed., British Crop Protection Council 2012) or can be found on the Internet (e.g. http://www.alanwood.net/pesticides). The classification is based on the current IRAC Mode of Action Classification Scheme at the time of filing of this patent application.

The active ingredient a) is preferably an agrochemically active compound selected from fungicides, herbicides or insecticides.

Examples of fungicides a) according to the invention are:

1) Inhibitors of the ergosterol biosynthesis, for example (1.001) cyproconazole, (1.002) difenoconazole, (1.003) epoxiconazole, (1.004) fenhexamid, (1.005) fenpropidin, (1.006) fenpropimorph, (1.007) fenpyrazamine, (1.008) fluquinconazole, (1.009) flutriafol, (1.010) imazalil, (1.011) imazalil sulfate, (1.012) ipconazole, (1.013) metconazole, (1.014) myclobutanil, (1.015) paclobutrazol, (1.016) prochloraz, (1.017) propiconazole, (1.018) prothioconazole, (1.019) pyrisoxazole, (1.020) spiroxamine, (1.021) tebuconazole, (1.022) tetraconazole, (1.023) triadimenol, (1.024) tridemorph, (1.025) triticonazole, (1.026) (1R,2S,5S)-5-(4-chlorobenzyl)-2-(chloromethyl)-2-methyl-1-(1H-1,2,4-triazol-1-ylmethyl)cyclopentanol, (1.027) (1S,2R,5R)-5-(4-chlorobenzyl)-2-(chloromethyl)-2-methyl-1-(1H-1,2,4-triazol-1-ylmethyl)cyclopentanol, (1.028) (2R)-2-(1-chlorocyclopropyl)-4-[(1R)-2,2-dichlorocyclopropyl]-1-(1H-1,2,4-triazol-1-yl)butan-2-ol, (1.029) (2R)-2-(1-chlorocyclopropyl)-4-[(1S)-2,2-dichlorocyclopropyl]-1-(1H-1,2,4-triazol-1-yl)butan-2-ol, (1.030) (2R)-2-[4-(4-chlorophenoxy)-2-(trifluoromethyl)phenyl]-1-(1H-1,2,4-triazol-1-yl)propan-2-ol, (1.031) (2S)-2-(1-chlorocyclopropyl)-4-[(1R)-2,2-dichlorocyclopropyl]-1-(1H-1,2,4-triazol-1-yl)butan-2-ol, (1.032) (2S)-2-(1-chloro-cyclopropyl)-4-[(1S)-2,2-dichlorocyclopropyl]-1-(1H-1,2,4-triazol-1-yl)butan-2-ol, (1.033) (2S)-2-[4-(4-chlorophenoxy)-2-(trifluoromethyl)phenyl]-1-(1H-1,2,4-triazol-1-yl)propan-2-ol, (1.034) (R)-[3-(4-chloro-2-fluorophenyl)-5-(2,4-difluorophenyl)-1,2-oxazol-4-yl](pyridin-3-yl)methanol, (1.035) (S)-[3-(4-chloro-2-fluorophenyl)-5-(2,4-difluorophenyl)-1,2-oxazol-4-yl](pyridin-3-yl)methanol, (1.036) [3-(4-chloro-2-fluorophenyl)-5-(2,4-difluorophenyl)-1,2-oxazol-4-yl](pyridin-3-yl)methanol, (1.037) 1-({(2R,4S)-2-[2-chloro-4-(4-chlorophenoxy)phenyl]-4-methyl-1,3-dioxolan-2-yl}methyl)-1H-1,2,4-triazole, (1.038) 1-({(2S,4S)-2-[2-chloro-4-(4-chlorophenoxy)phenyl]-4-methyl-1,3-dioxolan-2-yl}methyl)-1H-1,2,4-triazole, (1.039) 1-{[3-(2-chlorophenyl)-2-(2,4-difluorophenyl)oxiran-2-yl]methyl}-1H-1,2,4-triazol-5-yl thiocyanate, (1.040) 1-{[rel(2R,3R)-3-(2-chlorophenyl)-2-(2,4-difluorophenyl)oxiran-2-yl]methyl}-1H-1,2,4-triazol-5-yl thiocyanate, (1.041) 1-{[rel(2R,3S)-3-(2-chlorophenyl)-2-(2,4-difluorophenyl)oxiran-2-yl]methyl}-1H-1,2,4-triazol-5-yl thiocyanate, (1.042) 2-[(2R,4R,5R)-1-(2,4-dichlorophenyl)-5-hydroxy-2,6,6-trimethylheptan-4-yl]-2,4-dihydro-3H-1,2,4-triazole-3-thione, (1.043) 2-[(2R,4R,5S)-1-(2,4-dichlorophenyl)-5-hydroxy-2,6,6-trimethylheptan-4-yl]-2,4-dihydro-3H-1,2,4-triazole-3-thione, (1.044) 2-[(2R,4S,5R)-1-(2,4-dichlorophenyl)-5-hydroxy-2,6,6-trimethylheptan-4-yl]-2,4-dihydro-3H-1,2,4-triazole-3-thione, (1.045) 2-[(2R,4S,5S)-1-(2,4-dichloro-phenyl)-5-hydroxy-2,6,6-trimethylheptan-4-yl]-2,4-dihydro-3H-1,2,4-triazole-3-thione, (1.046) 2-[(2S,4R,5R)-1-(2,4-dichlorophenyl)-5-hydroxy-2,6,6-trimethylheptan-4-yl]-2,4-dihydro-3H-1,2,4-triazole-3-thione, (1.047) 2-[(2S,4R,5S)-1-(2,4-dichlorophenyl)-5-hydroxy-2,6,6-trimethylheptan-4-yl]-2,4-dihydro-3H-1,2,4-triazole-3-thione, (1.048) 2-[(2S,4S,5R)-1-(2,4-dichlorophenyl)-5-hydroxy-2,6,6-trimethylheptan-4-yl]-2,4-dihydro-3H-1,2,4-triazole-3-thione, (1.049) 2-[(2S,4S,5S)-1-(2,4-dichlorophenyl)-5-hydroxy-2,6,6-trimethylheptan-4-yl]-2,4-dihydro-3H-1,2,4-triazole-3-thione, (1.050) 2-[1-(2,4-dichlorophenyl)-5-hydroxy-2,6,6-trimethylheptan-4-yl]-2,4-dihydro-3H-1,2,4-triazole-3-thione, (1.051) 2-[2-chloro-4-(2,4-dichlorophenoxy)phenyl]-1-(1H-1,2,4-triazol-1-yl)propan-2-ol, (1.052) 2-[2-chloro-4-(4-chlorophenoxy)phenyl]-1-(1H-1,2,4-triazol-1-yl)butan-2-ol, (1.053) 2-[4-(4-chlorophenoxy)-2-(trifluoromethyl)phenyl]-1-(1H-1,2,4-triazol-1-yl)butan-2-ol, (1.054) 2-[4-(4-chlorophenoxy)-2-(trifluoromethyl)phenyl]-1-(1H-1,2,4-triazol-1-yl)pentan-2-ol, (1.055) mefentrifluconazole, (1.056) 2-{[3-(2-chlorophenyl)-2-(2,4-difluorophenyl)oxiran-2-yl]methyl}-2,4-dihydro-3H-1,2,4-triazole-3-thione, (1.057) 2-{[rel(2R,3R)-3-(2-chlorophenyl)-2-(2,4-difluoro-phenyl)oxiran-2-yl]methyl}-2,4-dihydro-3H-1,2,4-triazole-3-thione, (1.058) 2-{[rel(2R,3S)-3-(2-chlorophenyl)-2-(2,4-difluorophenyl)oxiran-2-yl]methyl}-2,4-dihydro-3H-1,2,4-triazole-3-thione, (1.059) 5-(4-chlorobenzyl)-2-(chloromethyl)-2-methyl-1-(1H-1,2,4-triazol-1-ylmethyl)cyclopentanol, (1.060) 5-(allylsulfanyl)-1-{[3-(2-chlorophenyl)-2-(2,4-difluorophenyl)oxiran-2-yl]methyl}-1H-1,2,4-triazole, (1.061) 5-(allylsulfanyl)-1-{[rel(2R,3R)-3-(2-chlorophenyl)-2-(2,4-difluorophenyl)oxiran-2-yl]methyl}-1H-1,2,4-triazole, (1.062) 5-(allylsulfanyl)-1-{[rel(2R,3S)-3-(2-chlorophenyl)-2-(2,4-difluorophenyl)oxiran-2-yl]methyl}-1H-1,2,4-triazole, (1.063) N′-(2,5-dimethyl-4-{[3-(1,1,2,2-tetrafluoroethoxy)phenyl]sulfanyl}phenyl)-N-ethyl-N-methylimidoformamide, (1.064) N′-(2,5-dimethyl-4-{[3-(2,2,2-trifluoroethoxy)phenyl]sulfanyl}phenyl)-N-ethyl-N-methylimidoformamide, (1.065) N′-(2,5-dimethyl-4-{[3-(2,2,3,3-tetrafluoropropoxy)phenyl]sulfanyl}phenyl)-N-ethyl-N-methylimidoformamide, (1.066) N′-(2,5-dimethyl-4-{[3-(pentafluoroethoxy)phenyl]sulfanyl}phenyl)-N-ethyl-N-methylimidoformamide, (1.067) N′-(2,5-dimethyl-4-{3-[(1,1,2,2-tetrafluoroethyl)sulfanyl]-phenoxy}phenyl)-N-ethyl-N-methylimidoformamide, (1.068) N′-(2,5-dimethyl-4-{3-[(2,2,2-trifluoro-ethyl)sulfanyl]phenoxy}phenyl)-N-ethyl-N-methylimidoformamide, (1.069) N′-(2,5-dimethyl-4-{3-[(2,2,3,3-tetrafluoropropyl)sulfanyl]phenoxy}phenyl)-N-ethyl-N-methylimidoformamide, (1.070) N′-(2,5-dimethyl-4-{3-[(pentafluoroethyl)sulfanyl]phenoxy}phenyl)-N-ethyl-N-methylimidoformamide, (1.071) N′-(2,5-dimethyl-4-phenoxyphenyl)-N-ethyl-N-methylimidoformamide, (1.072) N′-(4-{[3-(difluoromethoxy)phenyl]sulfanyl}-2,5-dimethylphenyl)-N-ethyl-N-methylimidoformamide, (1.073) N′-(4-{3-[(difluoromethyl)sulfanyl]phenoxy}-2,5-dimethylphenyl)-N-ethyl-N-methylimidoformamide, (1.074) N′-[5-bromo-6-(2,3-dihydro-1H-inden-2-yloxy)-2-methylpyridin-3-yl]-N-ethyl-N-methylimido-formamide, (1.075) N′-{4-[(4,5-dichloro-1,3-thiazol-2-yl)oxy]-2,5-dimethylphenyl}-N-ethyl-N-methylimidoformamide, (1.076) N′-{5-bromo-6-[(1R)-1-(3,5-difluorophenyl)ethoxy]-2-methylpyridin-3-yl}-N-ethyl-N-methylimidoformamide, (1.077) N′-{5-bromo-6-[(1S)-1-(3,5-difluorophenyl)ethoxy]-2-methylpyridin-3-yl}-N-ethyl-N-methylimidoformamide, (1.078) N′-{5-bromo-6-[(cis-4-isopropyl-cyclohexyl)oxy]-2-methylpyridin-3-yl}-N-ethyl-N-methylimidoformamide, (1.079) N′-{5-bromo-6-[(trans-4-isopropylcyclohexyl)oxy]-2-methylpyridin-3-yl}-N-ethyl-N-methylimidoformamide, (1.080) N′-{5-bromo-6-[1-(3,5-difluorophenyl)ethoxy]-2-methylpyridin-3-yl}-N-ethyl-N-methylimido-formamide, (1.081) ipfentrifluconazole, (1.082) 2-[4-(4-chlorophenoxy)-2-(trifluoromethyl)phenyl]-1-(1H-1,2,4-triazol-1-yl)propan-2-ol, (1.083) 2-[6-(4-bromophenoxy)-2-(trifluoromethyl)-3-pyridyl]-1-(1,2,4-triazol-1-yl)propan-2-ol, (1.084) 2-[6-(4-chlorophenoxy)-2-(trifluoromethyl)-3-pyridyl]-1-(1,2,4-triazol-1-yl)propan-2-ol, (1.085) 3-[2-(1-chlorocyclopropyl)-3-(3-chloro-2-fluoro-phenyl)-2-hydroxy-propyl]imidazole-4-carbonitrile, (1.086) 4-[[6-[rac-(2R)-2-(2,4-difluorophenyl)-1,1-difluoro-2-hydroxy-3-(5-thioxo-4H-1,2,4-triazol-1-yl)propyl]-3-pyridyl]oxy]benzonitrile, (1.087) N-isopropyl-N′-[5-methoxy-2-methyl-4-(2,2,2-trifluoro-1-hydroxy-1-phenylethyl)phenyl]-N-methylimidoformamide, (1.088) N′-{5-bromo-2-methyl-6-[(1-propoxypropan-2-yl)oxy]pyridin-3-yl}-N-ethyl-N-methylimido-formamide, (1.089) hexaconazole, (1.090) penconazole, (1.091) fenbuconazole.

2) Inhibitors of the respiratory chain at complex I or II, for example (2.001) benzovindiflupyr, (2.002) bixafen, (2.003) boscalid, (2.004) carboxin, (2.005) fluopyram, (2.006) flutolanil, (2.007) fluxapyroxad, (2.008) furametpyr, (2.009) Isofetamid, (2.010) isopyrazam (anti-epimeric enantiomer 1R,4S,9S), (2.011) isopyrazam (anti-epimeric enantiomer 1S,4R,9R), (2.012) isopyrazam (anti-epimeric racemate 1RS,4SR,9SR), (2.013) isopyrazam (mixture of syn-epimeric racemate 1RS,4SR,9RS and anti-epimeric racemate 1RS,4SR,9SR), (2.014) isopyrazam (syn-epimeric enantiomer 1R,4S,9R), (2.015) isopyrazam (syn-epimeric enantiomer 1S,4R,9S), (2.016) isopyrazam (syn-epimeric racemate 1RS,4SR,9RS), (2.017) penflufen, (2.018) penthiopyrad, (2.019) pydiflumetofen, (2.020) Pyraziflumid, (2.021) sedaxane, (2.022) 1,3-dimethyl-N-(1,1,3-trimethyl-2,3-dihydro-1H-inden-4-yl)-1H-pyrazole-4-carboxamide, (2.023) 1,3-dimethyl-N-[(3R)-1,1,3-trimethyl-2,3-dihydro-1H-inden-4-yl]-1H-pyrazole-4-carboxamide, (2.024) 1,3-dimethyl-N-[(3S)-1,1,3-trimethyl-2,3-dihydro-1H-inden-4-yl]-1H-pyrazole-4-carboxamide, (2.025) 1-methyl-3-(trifluoromethyl)-N-[2′-(trifluoromethyl)biphenyl-2-yl]-1H-pyrazole-4-carboxamide, (2.026) 2-fluoro-6-(trifluoromethyl)-N-(1,1,3-trimethyl-2,3-dihydro-1H-inden-4-yl)benzamide, (2.027) 3-(difluoromethyl)-1-methyl-N-(1,1,3-trimethyl-2,3-dihydro-1H-inden-4-yl)-1H-pyrazole-4-carboxamide, (2.028) inpyrfluxam, (2.029) 3-(difluoromethyl)-1-methyl-N-[(3S)-1,1,3-trimethyl-2,3-dihydro-1H-inden-4-yl]-1H-pyrazole-4-carboxamide, (2.030) fluindapyr, (2.031) 3-(difluoromethyl)-N-[(3R)-7-fluoro-1,1,3-trimethyl-2,3-dihydro-1H-inden-4-yl]-1-methyl-1H-pyrazole-4-carboxamide, (2.032) 3-(difluoromethyl)-N-[(3S)-7-fluoro-1,1,3-trimethyl-2,3-dihydro-1H-inden-4-yl]-1-methyl-1H-pyrazole-4-carboxamide, (2.033) 5,8-difluoro-N-[2-(2-fluoro-4-{[4-(trifluoromethyl)-pyridin-2-yl]oxy}phenyl)ethyl]quinazolin-4-amine, (2.034) N-(2-cyclopentyl-5-fluorobenzyl)-N-cyclopropyl-3-(difluoromethyl)-5-fluoro-1-methyl-1H-pyrazole-4-carboxamide, (2.035) N-(2-tert-butyl-5-methylbenzyl)-N-cyclopropyl-3-(difluoromethyl)-5-fluoro-1-methyl-1H-pyrazole-4-carboxamide, (2.036) N-(2-tert-butylbenzyl)-N-cyclopropyl-3-(difluoromethyl)-5-fluoro-1-methyl-1H-pyrazole-4-carboxamide, (2.037) N-(5-chloro-2-ethylbenzyl)-N-cyclopropyl-3-(difluoromethyl)-5-fluoro-1-methyl-1H-pyrazole-4-carboxamide, (2.038) isoflucypram, (2.039) N-[(1R,4S)-9-(dichloromethylene)-1,2,3,4-tetrahydro-1,4-methanonaphthalen-5-yl]-3-(difluoromethyl)-1-methyl-1H-pyrazole-4-carboxamide, (2.040) N-[(1S,4R)-9-(dichloromethylene)-1,2,3,4-tetrahydro-1,4-methanonaphthalen-5-yl]-3-(difluoromethyl)-1-methyl-1H-pyrazole-4-carboxamide, (2.041) N-[1-(2,4-dichlorophenyl)-1-methoxypropan-2-yl]-3-(difluoromethyl)-1-methyl-1H-pyrazole-4-carboxamide, (2.042) N-[2-chloro-6-(trifluoromethyl)benzyl]-N-cyclopropyl-3-(difluoromethyl)-5-fluoro-1-methyl-1H-pyrazole-4-carboxamide, (2.043) N-[3-chloro-2-fluoro-6-(trifluoromethyl)benzyl]-N-cyclopropyl-3-(difluoromethyl)-5-fluoro-1-methyl-1H-pyrazole-4-carboxamide, (2.044) N-[5-chloro-2-(trifluoromethyl)benzyl]-N-cyclopropyl-3-(difluoromethyl)-5-fluoro-1-methyl-1H-pyrazole-4-carboxamide, (2.045) N-cyclopropyl-3-(difluoromethyl)-5-fluoro-1-methyl-N-[5-methyl-2-(trifluoromethyl)benzyl]-1H-pyrazole-4-carboxamide, (2.046) N-cyclopropyl-3-(difluoromethyl)-5-fluoro-N-(2-fluoro-6-isopropylbenzyl)-1-methyl-1H-pyrazole-4-carboxamide, (2.047) N-cyclopropyl-3-(difluoromethyl)-5-fluoro-N-(2-isopropyl-5-methylbenzyl)-1-methyl-1H-pyrazole-4-carboxamide, (2.048) N-cyclopropyl-3-(difluoromethyl)-5-fluoro-N-(2-isopropylbenzyl)-1-methyl-1H-pyrazole-4-carbothioamide, (2.049) N-cyclopropyl-3-(difluoromethyl)-5-fluoro-N-(2-isopropylbenzyl)-1-methyl-1H-pyrazole-4-carboxamide, (2.050) N-cyclopropyl-3-(difluoromethyl)-5-fluoro-N-(5-fluoro-2-isopropylbenzyl)-1-methyl-1H-pyrazole-4-carboxamide, (2.051) N-cyclopropyl-3-(difluoromethyl)-N-(2-ethyl-4,5-dimethylbenzyl)-5-fluoro-1-methyl-1H-pyrazole-4-carboxamide, (2.052) N-cyclopropyl-3-(difluoromethyl)-N-(2-ethyl-5-fluorobenzyl)-5-fluoro-1-methyl-1H-pyrazole-4-carboxamide, (2.053) N-cyclopropyl-3-(difluoromethyl)-N-(2-ethyl-5-methylbenzyl)-5-fluoro-1-methyl-1H-pyrazole-4-carboxamide, (2.054) N-cyclopropyl-N-(2-cyclopropyl-5-fluorobenzyl)-3-(difluoromethyl)-5-fluoro-1-methyl-1H-pyrazole-4-carboxamide, (2.055) N-cyclopropyl-N-(2-cyclopropyl-5-methylbenzyl)-3-(difluoromethyl)-5-fluoro-1-methyl-1H-pyrazole-4-carboxamide, (2.056) N-cyclopropyl-N-(2-cyclopropylbenzyl)-3-(difluoromethyl)-5-fluoro-1-methyl-1H-pyrazole-4-carboxamide, (2.057) pyrapropoyne, (2.058) N-[rac-(1S,2S)-2-(2,4-dichlorophenyl)cyclobutyl]-2-(trifluoromethyl)-nicotinamide, (2.059) N-[(1S,2S)-2-(2,4-dichlorophenyl)cyclobutyl]-2-(trifluoromethyl)nicotinamide.

3) Inhibitors of the respiratory chain at complex III, for example (3.001) ametoctradin, (3.002) amisulbrom, (3.003) azoxystrobin, (3.004) coumethoxystrobin, (3.005) coumoxystrobin, (3.006) cyazofamid, (3.007) dimoxystrobin, (3.008) enoxastrobin, (3.009) famoxadone, (3.010) fenamidone, (3.011) flufenoxystrobin, (3.012) fluoxastrobin, (3.013) kresoxim-methyl, (3.014) metominostrobin, (3.015) orysastrobin, (3.016) picoxystrobin, (3.017) pyraclostrobin, (3.018) pyrametostrobin, (3.019) pyraoxystrobin, (3.020) trifloxystrobin, (3.021) (2E)-2-{2-[({[(1E)-1-(3-{[(E)-1-fluoro-2-phenylvinyl]oxy}phenyl)ethylidene]amino}oxy)methyl]phenyl}-2-(methoxyimino)-N-methylacetamide, (3.022) (2E,3Z)-5-{[1-(4-chlorophenyl)-1H-pyrazol-3-yl]oxy}-2-(methoxyimino)-N,3-dimethylpent-3-enamide, (3.023) (2R)-2-{2-[(2,5-dimethylphenoxy)methyl]phenyl}-2-methoxy-N-methylacetamide, (3.024) (2S)-2-{2-[(2,5-dimethylphenoxy)methyl]phenyl}-2-methoxy-N-methylacetamide, (3.025) fenpicoxamid, (3.026) mandestrobin, (3.027) N-(3-ethyl-3,5,5-trimethylcyclohexyl)-3-formamido-2-hydroxybenzamide, (3.028) (2E,3Z)-5-{[1-(4-chloro-2-fluorophenyl)-1H-pyrazol-3-yl]oxy}-2-(methoxyimino)-N,3-dimethylpent-3-enamide, (3.029) methyl {5-[3-(2,4-dimethylphenyl)-1H-pyrazol-1-yl]-2-methylbenzyl}carbamate, (3.030) metyltetraprole, (3.031) florylpicoxamid.

4) Inhibitors of the mitosis and cell division, for example (4.001) carbendazim, (4.002) diethofencarb, (4.003) ethaboxam, (4.004) fluopicolide, (4.005) pencycuron, (4.006) thiabendazole, (4.007) thiophanate-methyl, (4.008) zoxamide, (4.009) pyridachlometyl, (4.010) 3-chloro-5-(4-chlorophenyl)-4-(2,6-difluorophenyl)-6-methylpyridazine, (4.011) 3-chloro-5-(6-chloropyridin-3-yl)-6-methyl-4-(2,4,6-trifluorophenyl)pyridazine, (4.012) 4-(2-bromo-4-fluorophenyl)-N-(2,6-difluorophenyl)-1,3-dimethyl-1H-pyrazol-5-amine, (4.013) 4-(2-bromo-4-fluorophenyl)-N-(2-bromo-6-fluorophenyl)-1,3-dimethyl-1H-pyrazol-5-amine, (4.014) 4-(2-bromo-4-fluorophenyl)-N-(2-bromophenyl)-1,3-dimethyl-1H-pyrazol-5-amine, (4.015) 4-(2-bromo-4-fluorophenyl)-N-(2-chloro-6-fluorophenyl)-1,3-dimethyl-1H-pyrazol-5-amine, (4.016) 4-(2-bromo-4-fluorophenyl)-N-(2-chlorophenyl)-1,3-dimethyl-1H-pyrazol-5-amine, (4.017) 4-(2-bromo-4-fluorophenyl)-N-(2-fluorophenyl)-1,3-dimethyl-1H-pyrazol-5-amine, (4.018) 4-(2-chloro-4-fluorophenyl)-N-(2,6-difluorophenyl)-1,3-dimethyl-1H-pyrazol-5-amine, (4.019) 4-(2-chloro-4-fluorophenyl)-N-(2-chloro-6-fluorophenyl)-1,3-dimethyl-1H-pyrazol-5-amine, (4.020) 4-(2-chloro-4-fluorophenyl)-N-(2-chlorophenyl)-1,3-dimethyl-1H-pyrazol-5-amine, (4.021) 4-(2-chloro-4-fluorophenyl)-N-(2-fluorophenyl)-1,3-dimethyl-1H-pyrazol-5-amine, (4.022) 4-(4-chlorophenyl)-5-(2,6-difluorophenyl)-3,6-dimethylpyridazine, (4.023) N-(2-bromo-6-fluorophenyl)-4-(2-chloro-4-fluorophenyl)-1,3-dimethyl-1H-pyrazol-5-amine, (4.024) N-(2-bromophenyl)-4-(2-chloro-4-fluorophenyl)-1,3-dimethyl-1H-pyrazol-5-amine, (4.025) N-(4-chloro-2,6-difluorophenyl)-4-(2-chloro-4-fluorophenyl)-1,3-dimethyl-1H-pyrazol-5-amine, (4.026) fluopimomide.

5) Compounds capable to have a multisite action, for example (5.001) bordeaux mixture, (5.002) captafol, (5.003) captan, (5.004) chlorothalonil, (5.005) copper hydroxide, (5.006) copper naphthenate, (5.007) copper oxide, (5.008) copper oxychloride, (5.009) copper(2+) sulfate, (5.010) dithianon, (5.011) dodine, (5.012) folpet, (5.013) mancozeb, (5.014) maneb, (5.015) metiram, (5.016) metiram zinc, (5.017) oxine-copper, (5.018) propineb, (5.019) sulfur and sulfur preparations including calcium polysulfide, (5.020) thiram, (5.021) zineb, (5.022) ziram, (5.023) 6-ethyl-5,7-dioxo-6,7-dihydro-5H-pyrrolo[3′,4′:5,6][1,4]dithiino[2,3-c][1,2]thiazole-3-carbonitrile.

6) Compounds capable to induce a host defence, for example (6.001) acibenzolar-S-methyl, (6.002) isotianil, (6.003) probenazole, (6.004) tiadinil.

7) Inhibitors of the amino acid and/or protein biosynthesis, for example (7.001) cyprodinil, (7.002) kasugamycin, (7.003) kasugamycin hydrochloride hydrate, (7.004) oxytetracycline, (7.005) pyrimethanil, (7.006) 3-(5-fluoro-3,3,4,4-tetramethyl-3,4-dihydroisoquinolin-1-yl)quinoline.

8) Inhibitors of the ATP production, for example (8.001) silthiofam.

9) Inhibitors of the cell wall synthesis, for example (9.001) benthiavalicarb, (9.002) dimethomorph, (9.003) flumorph, (9.004) iprovalicarb, (9.005) mandipropamid, (9.006) pyrimorph, (9.007) valifenalate, (9.008) (2E)-3-(4-tert-butylphenyl)-3-(2-chloropyridin-4-yl)-1-(morpholin-4-yl)prop-2-en-1-one, (9.009) (2Z)-3-(4-tert-butylphenyl)-3-(2-chloropyridin-4-yl)-1-(morpholin-4-yl)prop-2-en-1-one.

10) Inhibitors of the lipid and membrane synthesis, for example (10.001) propamocarb, (10.002) propamocarb hydrochloride, (10.003) tolclofos-methyl.

11) Inhibitors of the melanin biosynthesis, for example (11.001) tricyclazole, (11.002) tolprocarb.

12) Inhibitors of the nucleic acid synthesis, for example (12.001) benalaxyl, (12.002) benalaxyl-M (kiralaxyl), (12.003) metalaxyl, (12.004) metalaxyl-M (mefenoxam).

13) Inhibitors of the signal transduction, for example (13.001) fludioxonil, (13.002) iprodione, (13.003) procymidone, (13.004) proquinazid, (13.005) quinoxyfen, (13.006) vinclozolin.

14) Compounds capable to act as an uncoupler, for example (14.001) fluazinam, (14.002) meptyldinocap.

15) Further fungicides selected from the group consisting of (15.001) abscisic acid, (15.002) benthiazole, (15.003) bethoxazin, (15.004) capsimycin, (15.005) carvone, (15.006) chinomethionat, (15.007) cufraneb, (15.008) cyflufenamid, (15.009) cymoxanil, (15.010) cyprosulfamide, (15.011) flutianil, (15.012) fosetyl-aluminium, (15.013) fosetyl-calcium, (15.014) fosetyl-sodium, (15.015) methyl isothiocyanate, (15.016) metrafenone, (15.017) mildiomycin, (15.018) natamycin, (15.019) nickel dimethyldithiocarbamate, (15.020) nitrothal-isopropyl, (15.021) oxamocarb, (15.022) oxathiapiprolin, (15.023) oxyfenthiin, (15.024) pentachlorophenol and salts, (15.025) phosphorous acid and its salts, (15.026) propamocarb-fosetylate, (15.027) pyriofenone (chlazafenone), (15.028) tebufloquin, (15.029) tecloftalam, (15.030) tolnifanide, (15.031) 1-(4-{4-[(5R)-5-(2,6-difluorophenyl)-4,5-dihydro-1,2-oxazol-3-yl]-1,3-thiazol-2-yl}piperidin-1-yl)-2-[5-methyl-3-(trifluoromethyl)-1H-pyrazol-1-yl]ethanone, (15.032) 1-(4-{4-[(5S)-5-(2,6-difluorophenyl)-4,5-dihydro-1,2-oxazol-3-yl]-1,3-thiazol-2-yl}piperidin-1-yl)-2-[5-methyl-3-(trifluoromethyl)-1H-pyrazol-1-yl]ethanone, (15.033) 2-(6-benzylpyridin-2-yl)quinazoline, (15.034) dipymetitrone, (15.035) 2-[3,5-bis(difluoromethyl)-1H-pyrazol-1-yl]-1-[4-(4-{5-[2-(prop-2-yn-1-yloxy)phenyl]-4,5-dihydro-1,2-oxazol-3-yl}-1,3-thiazol-2-yl)piperidin-1-yl]ethanone, (15.036) 2-[3,5-bis(difluoromethyl)-1H-pyrazol-1-yl]-1-[4-(4-{5-[2-chloro-6-(prop-2-yn-1-yloxy)phenyl]-4,5-dihydro-1,2-oxazol-3-yl}-1,3-thiazol-2-yl)piperidin-1-yl]ethanone, (15.037) 2-[3,5-bis(difluoromethyl)-1H-pyrazol-1-yl]-1-[4-(4-{5-[2-fluoro-6-(prop-2-yn-1-yloxy)-phenyl]-4,5-dihydro-1,2-oxazol-3-yl}-1,3-thiazol-2-yl)piperidin-1-yl]ethanone, (15.038) 2-[6-(3-fluoro-4-methoxyphenyl)-5-methylpyridin-2-yl]quinazoline, (15.039) 2-{(5R)-3-[2-(1-{[3,5-bis(difluoro-methyl)-1H-pyrazol-1-yl]acetyl}piperidin-4-yl)-1,3-thiazol-4-yl]-4,5-dihydro-1,2-oxazol-5-yl}-3-chlorophenyl methanesulfonate, (15.040) 2-{(5S)-3-[2-(1-{[3,5-bis(difluoromethyl)-1H-pyrazol-1-yl]acetyl}piperidin-4-yl)-1,3-thiazol-4-yl]-4,5-dihydro-1,2-oxazol-5-yl}-3-chlorophenyl methanesulfonate, (15.041) ipflufenoquin, (15.042) 2-{2-fluoro-6-[(8-fluoro-2-methylquinolin-3-yl)oxy]phenyl}propan-2-ol, (15.043) fluoxapiprolin, (15.044) 2-{3-[2-(1-{[3,5-bis(difluoromethyl)-1H-pyrazol-1-yl]acetyl}piperidin-4-yl)-1,3-thiazol-4-yl]-4,5-dihydro-1,2-oxazol-5-yl}phenyl methanesulfonate, (15.045) 2-phenylphenol and salts, (15.046) 3-(4,4,5-trifluoro-3,3-dimethyl-3,4-dihydroisoquinolin-1-yl)quinoline, (15.047) quinofumelin, (15.048) 4-amino-5-fluoropyrimidin-2-ol (tautomeric form: 4-amino-5-fluoropyrimidin-2(1H)-one), (15.049) 4-oxo-4-[(2-phenylethyl)amino]butanoic acid, (15.050) 5-amino-1,3,4-thiadiazole-2-thiol, (15.051) 5-chloro-N′-phenyl-N′-(prop-2-yn-1-yl)thiophene-2-sulfonohydrazide, (15.052) 5-fluoro-2-[(4-fluorobenzyl)oxy]-pyrimidin-4-amine, (15.053) 5-fluoro-2-[(4-methylbenzyl)oxy]pyrimidin-4-amine, (15.054) 9-fluoro-2,2-dimethyl-5-(quinolin-3-yl)-2,3-dihydro-1,4-benzoxazepine, (15.055) but-3-yn-1-yl {6-[({[(Z)-(1-methyl-1H-tetrazol-5-yl)(phenyl)methylene]amino}oxy)methyl]pyridin-2-yl}carbamate, (15.056) ethyl (2Z)-3-amino-2-cyano-3-phenylacrylate, (15.057) phenazine-1-carboxylic acid, (15.058) propyl 3,4,5-trihydroxybenzoate, (15.059) quinolin-8-ol, (15.060) quinolin-8-ol sulfate (2:1), (15.061) tert-butyl {6-[({[(1-methyl-1H-tetrazol-5-yl)(phenyl)methylene]amino}oxy)methyl]pyridin-2-yl}carbamate, (15.062) 5-fluoro-4-imino-3-methyl-1-[(4-methylphenyl)sulfonyl]-3,4-dihydropyrimidin-2(1H)-one, (15.063) aminopyrifen, (15.064) (N′-[2-chloro-4-(2-fluorophenoxy)-5-methylphenyl]-N-ethyl-N-methylimido-formamide), (15.065) (N′-(2-chloro-5-methyl-4-phenoxyphenyl)-N-ethyl-N-methylimidoformamide), (15.066) (2-{2-[(7,8-difluoro-2-methylquinolin-3-yl)oxy]-6-fluorophenyl}propan-2-ol), (15.067) (5-bromo-1-(5,6-dimethylpyridin-3-yl)-3,3-dimethyl-3,4-dihydroisoquinoline), (15.068) (3-(4,4-difluoro-5,5-dimethyl-4,5-dihydrothieno[2,3-c]pyridin-7-yl)quinoline), (15.069) (1-(4,5-dimethyl-1H-benzimidazol-1-yl)-4,4-difluoro-3,3-dimethyl-3,4-dihydroisoquinoline), (15.070) 8-fluoro-3-(5-fluoro-3,3-dimethyl-3,4-dihydroisoquinolin-1-yl)quinolone, (15.071) 8-fluoro-3-(5-fluoro-3,3,4,4-tetramethyl-3,4-dihydroisoquinolin-1-yl)quinolone, (15.072) 3-(4,4-difluoro-3,3-dimethyl-3,4-dihydroisoquinolin-1-yl)-8-fluoroquinoline, (15.073) (N-methyl-N-phenyl-4-[5-(trifluoromethyl)-1,2,4-oxadiazol-3-yl]benzamide), (15.074) methyl {4-[5-(trifluoromethyl)-1,2,4-oxadiazol-3-yl]phenyl}carbamate, (15.075) (N-{4-[5-(trifluoromethyl)-1,2,4-oxadiazol-3-yl]benzyl}cyclopropanecarboxamide), (15.076) N-methyl-4-(5-(trifluoromethyl)-1,2,4-oxadiazol-3-yl]benzamide, (15.077) N-[(E)-methoxyimino-methyl]-4-[5-(trifluoromethyl)-1,2,4-oxadiazol-3-yl]benzamide, (15.078) N-[(Z)-methoxyiminomethyl]-4-[5-(trifluoromethyl)-1,2,4-oxadiazol-3-yl]benzamide, (15.079) N-[4-[5-(trifluoromethyl)-1,2,4-oxadiazol-3-yl]phenyl]cyclopropanecarboxamide, (15.080) N-(2-fluorophenyl)-4-[5-(trifluoromethyl)-1,2,4-oxadiazol-3-yl]benzamide, (15.081) 2,2-difluoro-N-methyl-2-[4-[5-(trifluoromethyl)-1,2,4-oxadiazol-3-yl]phenyl]acetamide, (15.082) N-allyl-N-[[4-[5-(trifluoromethyl)-1,2,4-oxadiazol-3-yl)phenyl]methyl]acetamide, (15.083) N-[(E)-N-methoxy-C-methyl-carbonimidoyl]-4-(5-(trifluoro-methyl)-1,2,4-oxadiazol-3-yl]benzamide, (15.084) N-[(Z)—N-methoxy-C-methyl-carbonimidoyl]-4-[5-(trifluoromethyl)-1,2,4-oxadiazol-3-yl]benzamide, (15.085) N-allyl-N-[[4-[5-(trifluoromethyl)-1,2,4-oxadiazol-3-yl]phenyl]methyl]propanamide, (15.086) 4,4-dimethyl-1-[[4-[5-(trifluoromethyl)-1,2,4-oxadiazol-3-yl]phenyl]methyl]pyrrolidin-2-one, (15.087) N-methyl-4-[5-(trifluoromethyl)-1,2,4-oxadiazol-3-yl]benzenecarbothioamide, (15.088) 5-methyl-1-[[4-[5-(trifluoromethyl)-1,2,4-oxadiazol-3-yl]phenyl]methyl]pyrrolidin-2-one, (15.089) N-((2,3-difluoro-4-[5-(trifluoromethyl)-1,2,4-oxadiazol-3-yl]phenyl]methyl]-3,3,3-trifluoro-propanamide, (15.090) 1-methoxy-1-methyl-3-[[4-[5-(trifluoro-methyl}-1,2,4-oxadiazol-3-yl]phenyl]methyl]urea, (15.091) 1,1-diethyl-3-[[4-[5-(trifluoromethyl}-1,2,4-oxadiazol-3-yl]phenyl]methyl]urea, (15.092) N-[[4-[5-(trifluoromethyl)-1,2,4-oxadiazol-3-yl]phen-yl]methyl]propanamide, (15.093) N-methoxy-N-[[4-[5-(trifluoromethyl)-1,2,4-oxadiazol-3-yl]phenyl]-methyl]cyclopropanecarboxamide, (15.094) 1-methoxy-3-methyl-1-[[4-[5-(trifluoromethyl)-1,2,4-oxadiazol-3-yl]phenyl]methyl]urea, (15.095) N-methoxy-N-[[4-[5-(trifluoromethyl)-1,2,4-oxadiazol-3-yl]phenyl]methyl)cyclopropanecarboxamide, (15.096) N,2-dimethoxy-N-[[4-[5-(trifluoromethyl}-1,2,4-oxadiazol-3-yl]phenyl]methyl]propanamide, (15.097) N-ethyl-2-methyl-N-[[4-[5-(trifluoromethyl)-1,2,4-oxadiazol-3-yl)phenyl]methyl]propanamide, (15.098) 1-methoxy-3-methyl-1-[[4-[5-(trifluoro-methyl)-1,2,4-oxadiazol-3-yl]phenyl]methyl]urea, (15.099) 1,3-dimethoxy-1-[[4-[5-(trifluoromethyl)-1,2,4-oxadiazol-3-yl]phenyl]methyl]urea, (15.100) 3-ethyl-1-methoxy-1-[[4-[5-(trifluoromethyl)-1,2,4-oxadiazol-3-yl]phenyl]methyl]urea, (15.101) 1-[[4-[5-(trifluoromethyl)-1,2,4-oxadiazol-3-yl]phenyl]-methyl]piperidin-2-one, (15.102) 4,4-dimethyl-2-[[4-[5-(trifluoromethyl)-1,2,4-oxadiazol-3-yl]phenyl]-methyl]isooxazolidin-3-one, (15.103) 5,5-dimethyl-2-[[4-[5-(trifluoromethyl)-1,2,4-oxadiazol-3-yl]phenyl]methyl]isoxazolidin-3-one, (15.104) 3,3-dimethyl-1-[[4-[5-(trifluoromethyl)-1,2,4-oxadiazol-3-yl]phenyl]methyl]piperidin-2-one, (15.105) 1-[[3-fluoro-4-(5-(trifluoromethyl)-1,2,4-oxadiazol-3-yl]-phenyl]methyl]azepan-2-one, (15.106) 4,4-dimethyl-2-[[4-(5-(trifluoromethyl)-1,2,4-oxadiazol-3-yl]-phenyl]methyl]isoxazolidin-3-one, (15.107) 5,5-dimethyl-2-[[4-[5-(trifluoromethyl)-1,2,4-oxadiazol-3-yl]phenyl]methyl]isoxazolidin-3-one, (15.108) ethyl 1-{4-[5-(trifluoromethyl)-1,2,4-oxadiazol-3-yl]benzyl}-1H-pyrazole-4-carboxylate, (15.109) N,N-dimethyl-1-{4-[5-(trifluoromethyl)-1,2,4-oxadiazol-3-yl]benzyl}-1H-1,2,4-triazol-3-amine, (15.110) N-{2,3-difluoro-4-[5-(trifluoromethyl)-1,2,4-oxadiazol-3-yl]benzyl}butanamide, (15.111) N-(1-methylcyclopropyl)-4-[5-(trifluoromethyl)-1,2,4-oxadiazol-3-yl]benzamide, (15.112) N-(2,4-difluorophenyl)-4-[5-(trifluoromethyl)-1,2,4-oxadiazol-3-yl]benzamide, (15.113) 1-(5,6-dimethylpyridin-3-yl)-4,4-difluoro-3,3-dimethyl-3,4-dihydroisoquinoline, (15.114) 1-(6-(difluoromethyl)-5-methyl-pyridin-3-yl)-4,4-difluoro-3,3-dimethyl-3,4-dihydro-isoquinoline, (15.115) 1-(5-(fluoromethyl)-6-methyl-pyridin-3-yl)-4,4-difluoro-3,3-dimethyl-3,4-dihydroisoquinoline, (15.116) 1-(6-(difluoromethyl)-5-methoxy-pyridin-3-yl)-4,4-difluoro-3,3-dimethyl-3,4-dihydroisoquinoline, (15.117) 4-[5-(trifluoromethyl)-1,2,4-oxadiazol-3-yl]phenyl dimethyl-carbamate, (15.118) N-{4-[5-(trifluoromethyl)-1,2,4-oxadiazol-3-yl]phenyl}propanamide, (15.119) 3-[2-(1-{[5-methyl-3-(trifluoromethyl)-1H-pyrazol-1-yl]acetyl}piperidin-4-yl)-1,3-thiazol-4-yl]-1,5-dihydro-2,4-benzodioxepin-6-yl methanesulfonate, (15.120) 9-fluoro-3-[2-(1-{[5-methyl-3-(trifluoromethyl)-1H-pyrazol-1-yl]acetyl}piperidin-4-yl)-1,3-thiazol-4-yl]-1,5-dihydro-2,4-benzodioxepin-6-yl methanesulfonate, (15.121) 3-[2-(1-{[3,5-bis(difluoromethyl)-1H-pyrazol-1-yl]acetyl}piperidin-4-yl)-1,3-thiazol-4-yl]-1,5-dihydro-2,4-benzodioxepin-6-yl methanesulfonate, (15.122) 3-[2-(1-{[3,5-bis(difluoromethyl)-1H-pyrazol-1-yl]acetyl}piperidin-4-yl)-1,3-thiazol-4-yl]-9-fluoro-1,5-dihydro-2,4-benzodioxepin-6-yl methanesulfonate, (15.123) 1-(6,7-dimethylpyrazolo[1,5-a]pyridin-3-yl)-4,4-difluoro-3,3-dimethyl-3,4-dihydroisoquinoline, (15.124) 8-fluoro-N-(4,4,4-trifluoro-2-methyl-1-phenylbutan-2-yl)quinoline-3-carboxamide, (15.125) 8-fluoro-N-[(2S)-4,4,4-trifluoro-2-methyl-1-phenylbutan-2-yl]quinoline-3-carboxamide, (15.126) N-(2,4-dimethyl-1-phenylpentan-2-yl)-8-fluoroquinoline-3-carboxamide and (15.127) N-[(2S)-2,4-dimethyl-1-phenylpentan-2-yl]-8-fluoroquinoline-3-carboxamide.

Examples of insecticides a) according to the invention are:

(1) Acetylcholinesterase(AChE)-inhibitors, e.g. Carbamates Alanycarb, Aldicarb, Bendiocarb, Benfuracarb, Butocarboxim, Butoxycarboxim, Carbaryl, Carbofuran, Carbosulfan, Ethiofencarb, Fenobucarb, Formetanate, Furathiocarb, Isoprocarb, Methiocarb, Methomyl, Metolcarb, Oxamyl, Pirimicarb, Propoxur, Thiodicarb, Thiofanox, Triazamate, Trimethacarb, XMC andan Xylylcarb, or organophosphates, e.g. Acephat, Azamethiphos, Azinphos-ethyl, Azinphos-methyl, Cadusafos, Chlorethoxyfos, Chlorfenvinphos, Chlormephos, Chlorpyrifos-methyl, Coumaphos, Cyanophos, Demeton-S-methyl, Diazinon, Dichlorvos/DDVP, Dicrotophos, Dimethoat, Dimethylvinphos, Disulfoton, EPN, Ethion, Ethoprophos, Famphur, Fenamiphos, Fenitrothion, Fenthion, Fosthiazat, Heptenophos, Imicyafos, Isofenphos, Isopropyl-O-(methoxyaminothio-phosphoryl)salicylat, Isoxathion, Malathion, Mecarbam, Methamidophos, Methidathion, Mevinphos, Monocrotophos, Naled, Omethoate, Oxydemeton-methyl, Parathion-methyl, Phenthoat, Phorat, Phosalon, Phosmet, Phosphamidon, Phoxim, Pirimiphos-methyl, Profenofos, Propetamphos, Prothiofos, Pyraclofos, Pyridaphenthion, Quinalphos, Sulfotep, Tebupirimfos, Temephos, Terbufos, Tetrachlorvinphos, Thiometon, Triazophos, Triclorfon andand Vamidothion.

(2) GABA-gated chloride channel antagonists, preferably Cyclodien-organochlorine selected from the group of Chlordan and Endosulfan, or Phenylpyrazole (Fiprole) selected from Ethiprol and Fipronil.

(3) Sodium channel modulators/voltage-dependent sodium channel blockers, for example pyrethroids, e.g. Acrinathrin, Allethrin, d-cis-trans Allethrin, d-trans Allethrin, Bifenthrin, Bioallethrin, Bioallethrin S-cyclopentenyl isomer, Bioresmethrin, Cycloprothrin, Cyfluthrin, beta-Cyfluthrin, Cyhalothrin, lambda-Cyhalothrin, gamma-Cyhalothrin, Cypermethrin, alpha-Cypermethrin, beta-Cypermethrin, theta-Cypermethrin, zeta-Cypermethrin, Cyphenothrin [(1R)-trans isomers], Deltamethrin, Empenthrin [(EZ)-(1R) isomers), Esfenvalerate, Etofenprox, Fenpropathrin, Fenvalerate, Flucythrinate, Flumethrin, tau-Fluvalinate, Halfenprox, Imiprothrin, Kadethrin, Momfluorothrin, Permethrin, Phenothrin [(1R)-trans isomer), Prallethrin, Pyrethrine (pyrethrum), Resmethrin, Silafluofen, Tefluthrin, Tetramethrin, Tetramethrin [(1R) isomers)], Tralomethrin and Transfluthrin or DDT or Methoxychlor.

(4) Nicotinic acetylcholine receptor (nAChR) competitive activators, preferably Neonicotinoids selected from Acetamiprid, Clothianidin, Dinotefuran, Imidacloprid, Nitenpyram, Thiacloprid and Thiamethoxam, or Nicotin, or Sulfoximine selected from Sulfoxaflor, or Butenolide selected from Flupyradifurone, or Mesoionics selected from Triflumezopyrim.

(5) Nicotinic acetylcholine receptor (nAChR) allosteric activators, preferably Spinosynes selected from Spinetoram and Spinosad.

(6) Allosteric modulators of the glutamate-dependent chloride channel (GluCl), preferably Avermectine/Milbemycine selected from Abamectin, Emamectin-benzoate, Lepimectin and Milbemectin.

(7) Juvenile hormone mimetics, preferably Juvenile hormone-analogs selected from Hydropren, Kinopren and Methopren, or Fenoxycarb or Pyriproxyfen.

(8) Various non-specific (multi-site) inhibitors, preferably Alkylhalogenides selected from Methylbromide and other Alkylhalogenides, or Chloropicrin or Sulfurylfluorid or Borax or Tartar emetic or Methylisocyanate generators selected from Diazomet and Metam.

(9) TRPV channel modulators of chordotonal organs selected from Pymetrozin and Pyrifluquinazon.

(10) Mite growth inhibitors selected from Clofentezin, Hexythiazox, Diflovidazin and Etoxazol.

(11) Microbial disruptors of the insect intestinal membrane selected from Bacillus thuringiensis Subspecies israelensis, Bacillus sphaericus, Bacillus thuringiensis Subspecies aizawai, Bacillus thuringiensis Subspecies kurstaki, Bacillus thuringiensis subspecies tenebrionis and B.t.-plant proteins selected from Cry1Ab, Cry1Ac, Cry1Fa, Cry1A.105, Cry2Ab, VIP3A, mCry3A, Cry3Ab, Cry3Bb and Cry34Ab1/35Ab1.

(12) Mitochondrial ATP synthase inhibitors, preferably ATP-disruptors selected from Diafenthiuron, or Organo-tin-compounds selected from Azocyclotin, Cyhexatin and Fenbutatin-oxide, or Propargit or Tetradifon.

(13) Decoupler of oxidative phosphorylation by disturbance of the proton gradient selected from Chlorfenapyr, DNOC and Sulfluramid.

(14) Nicotinic acetylcholine receptor channel blocker selected from Bensultap, Cartap-hydrochlorid, Thiocyclam and Thiosultap-Sodium.

(15) Inhibitors of chitin biosynthesis, Typ 0, selected from Bistrifluron, Chlorfluazuron, Diflubenzuron, Flucycloxuron, Flufenoxuron, Hexaflumuron, Lufenuron, Novaluron, Noviflumuron, Teflubenzuron and Triflumuron.

(16) Inhibitors of chitin biosynthesis, Typ 1 selected from Buprofezin.

(17) Molting disruptor (especially dipteras, i.e. two-winged insects) selected from Cyromazin.

(18) Ecdyson receptor agonists selected from Chromafenozid, Halofenozid, Methoxyfenozid and Tebufenozid.

(19) Octopamin-receptor-agonists selected from Amitraz.

(20) Mitochondrial complex III electron transport inhibitors selected from Hydramethylnon, Acequinocyl and Fluacrypyrim.

(21) Mitochondrial complex I electron transport inhibitors, preferably so-called METI-acaricides selected from Fenazaquin, Fenpyroximat, Pyrimidifen, Pyridaben, Tebufenpyrad and Tolfenpyrad, or Rotenon (Derris).

(22) Blocker of the voltage-dependent sodium channel selected from Indoxacarb and Metaflumizone.

(23) Inhibitors of acetyl-CoA carboxylase, preferably tetronic and tetramic acid derivatives selected from Spirodiclofen, Spiromesifen, Spirotetramat and Spidoxamate (IUPAC Name: 11-(4-chloro-2,6-xylyl)-12-hydroxy-1,4-dioxa-9-azadispiro[4.2.4.2]tetradec-11-en-10-one).

(24) Mitochondrial complex IV electron transport inhibitors, preferably Phosphines selected from Aluminiumphosphid, Calciumphosphid, Phosphin and Zinkphosphid, or Cyanides selected from Calciumcyanid, Potassiumcyanid and Sodiumcyanid.

(25) Mitochondrial complex II electron transport inhibitors, preferablybeta-Ketonitrilderivate selected from Cyenopyrafen and Cyflumetofen, or Carboxanilide selected from Pyflubumid.

(28) Ryanodinreceptor-modulators, preferably Diamide selected from Chlorantraniliprol, Cyantraniliprol and Flubendiamid.

(29) Modulators of chordotonal organs (with undefined target structure) selected from Flonicamid.

(30) other active ingredients selected from Acynonapyr, Afidopyropen, Afoxolaner, Azadirachtin, Benclothiaz, Benzoximat, Benzpyrimoxan, Bifenazat, Broflanilid, Bromopropylat, Chinomethionat, Chloroprallethrin, Cryolit, Cyclaniliprol, Cycloxaprid, Cyhalodiamid, Dicloromezotiaz, Dicofol, Dimpropyridaz, epsilon-Metofluthrin, epsilon-Momfluthrin, Flometoquin, Fluazaindolizin, Fluensulfon, Flufenerim, Flufenoxystrobin, Flufiprol, Fluhexafon, Fluopyram, Flupyrimin, Fluralaner, Fluxametamid, Fufenozid, Guadipyr, Heptafluthrin, Imidaclothiz, Iprodione, Isocycloseram, kappa-Bifenthrin, kappa-Tefluthrin, Lotilaner, Meperfluthrin, Oxazosulfyl, Paichongding, Pyridalyl, Pyrifluquinazon, Pyriminostrobin, Spirobudiclofen, Spiropidion, Tetramethylfluthrin, Tetraniliprol, Tetrachlorantraniliprol, Tigolaner, Tioxazafen, Thiofluoximat and Iodmethan; products from Bacillus firmus (I-1582, BioNeem, Votivo), as well as following compounds: 1-{2-Fluor-4-methyl-5-[(2,2,2-trifluorethyl)sulfinyl]phenyl}-3-(trifluormethyl)-1H-1,2,4-triazol-5-amin (known from WO2006/043635) (CAS 885026-50-6), {1′-[(2E)-3-(4-Chlorphenyl)prop-2-en-1-yl]-5-fluorspiro[indol-3,4′-piperidin]-1(2H)-yl}(2-chlorpyridin-4-yl)methanon (known from WO2003/106457) (CAS 637360-23-7), 2-Chlor-N-[2-{1-[(2E)-3-(4-chlorphenyl)prop-2-en-1-yl]piperidin-4-yl}-4-(trifluormethyl)phenyl]isonicotinamid (known from WO2006/003494) (CAS 872999-66-1), 3-(4-Chlor-2,6-dimethylphenyl)-4-hydroxy-8-methoxy-1,8-diazaspiro[4.5]dec-3-en-2-on (known from WO 2010052161) (CAS 1225292-17-0), 3-(4-Chlor-2, 6-dimethylphenyl)-8-methoxy-2-oxo-1,8-diazaspiro[4.5]dec-3-en-4-yl-ethylcarbonat (known from EP 2647626) (CAS-1440516-42-6), 4-(But-2-in-1-yloxy)-6-(3,5-dimethylpiperidin-1-yl)-5-fluoropyrimidin (known from WO2004/099160) (CAS 792914-58-0), PF1364 (known from JP2010/018586) (CAS-Reg.No.

1204776-60-2), (3E)-3-[1-[(6-Chlor-3-pyridyl)methyl]-2-pyridyliden]-1,1,1-trifluorpropan-2-on (known from WO2013/144213) (CAS 1461743-15-6), N-[3-(Benzylcarbamoyl)-4-chlorphenyl]-1-methyl-3-(pentafluorethyl)-4-(trifluormethyl)-1H-pyrazol-5-carboxamid (known from WO2010/051926) (CAS 1226889-14-0), 5-Brom-4-chlor-N-[4-chlor-2-methyl-6-(methylcarbamoyl)phenyl]-2-(3-chlor-2-pyridyl)pyrazol-3-carboxamid (known from CN103232431) (CAS 1449220-44-3), 4-[5-(3,5-Dichlorphenyl)-4,5-dihydro-5-(trifluormethyl)-3-isoxazolyl]-2-methyl-N-(cis-1-oxido-3-thietanyl)benzamid, 4-[5-(3,5-Dichlorphenyl)-4,5-dihydro-5-(trifluormethyl)-3-isoxazolyl]-2-methyl-N-(trans-1-oxido-3-thietanyl)benzamid and 4-[(5S)-5-(3,5-Dichlorphenyl)-4,5-dihydro-5-(trifluormethyl)-3-isoxazolyl]-2-methyl-N-(cis-1-oxido-3-thietanyl)benzamid (known from WO 2013/050317 A1) (CAS 1332628-83-7), N-[3-Chlor-1-(3-pyridinyl)-1H-pyrazol-4-yl]-N-ethyl-3-[(3,3,3-trifluorpropyl)sulfinyl]propanamid, (+)-N-[3-Chlor-1-(3-pyridinyl)-1H-pyrazol-4-yl]-N-ethyl-3-[(3,3,3-trifluorpropyl)sulfinyl]propanamid and (−)-N-[3-Chlor-1-(3-pyridinyl)-1H-pyrazol-4-yl]-N-ethyl-3-[(3,3,3-trifluorpropyl)sulfinyl]propanamid (known from WO 2013/162715 A2, WO 2013/162716 A2, US 2014/0213448 A1) (CAS 1477923-37-7), 5-[[(2E)-3-Chlor-2-propen-1-yl]amino]-1-[2,6-dichlor-4-(trifluormethyl)phenyl]-4-[(trifluormethyl)sulfinyl]-1H-pyrazol-3-carbonitrile (known from CN 101337937 A) (CAS 1105672-77-2), 3-Brom-N-[4-chlor-2-methyl-6-[(methylamino)thioxomethyl]phenyl]-1-(3-chlor-2-pyridinyl)-1H-pyrazol-5-carboxamid, (Liudaibenjiaxuanan, known from CN 103109816 A) (CAS 1232543-85-9); N-[4-Chlor-2-[[(1,1-dimethylethyl)amino]carbonyl]-6-methylphenyl]-1-(3-chlor-2-pyridinyl)-3-(fluormethoxy)-1H-pyrazol-5-carboxamid (known from WO 2012/034403 A1) (CAS 1268277-22-0), N-[2-(5-Amino-1,3,4-thiadiazol-2-yl)-4-chlor-6-methylphenyl]-3-brom-1-(3-chlor-2-pyridinyl)-1H-pyrazol-5-carboxamid (known from WO 2011/085575 A1) (CAS 1233882-22-8), 4-[3-[2,6-Dichlor-4-[(3,3-dichlor-2-propen-1-yl)oxy]phenoxy]propoxy]-2-methoxy-6-(trifluormethyl)pyrimidin (known from CN 101337940 A) (CAS 1108184-52-6); (2E)- and 2(Z)-2-[2-(4-Cyanophenyl)-1-[3-(trifluormethyl)phenyl]ethyliden]-N-[4-(difluormethoxy)phenyl]hydrazincarboxamid (known from CN 101715774 A) (CAS 1232543-85-9); Cyclopropancarbonsaure-3-(2,2-dichlorethenyl)-2,2-dimethyl-4-(1H-benzimidazol-2-yl)phenylester (known from CN 103524422 A) (CAS 1542271-46-4); (4aS)-7-Chlor-2,5-dihydro-2-[[(methoxycarbonyl)[4-[(trifluormethyl)thio]phenyl]amino]carbonyl]indeno[1,2-e][1,3,4]oxadiazin-4a(3H)-carbonsauremethylester (known from CN 102391261 A) (CAS 1370358-69-2); 6-Desoxy-3-O-ethyl-2,4-di-O-methyl-1-[N-[4-[1-[4-(1,1,2,2,2-pentafluorethoxy)phenyl]-1H-1,2,4-triazol-3-yl]phenyl]carbamat]-α-L-mannopyranose (known from US 2014/0275503 A1) (CAS 1181213-14-8); 8-(2-Cyclopropylmethoxy-4-trifluormethylphenoxy)-3-(6-trifluormethylpyridazin-3-yl)-3-azabicyclo[3.2.1]octan (CAS 1253850-56-4), (8-anti)-8-(2-Cyclopropylmethoxy-4-trifluormethylphenoxy)-3-(6-trifluormethylpyridazin-3-yl)-3-azabicyclo[3.2.1]octan (CAS 933798-27-7), (8-syn)-8-(2-Cyclopropylmethoxy-4-trifluormethylphenoxy)-3-(6-trifluormethylpyridazin-3-yl)-3-azabicyclo[3.2.1]octan (known from WO 2007040280 A1, WO 2007040282 A1) (CAS 934001-66-8), N-[3-Chlor-1-(3-pyridinyl)-1H-pyrazol-4-yl]-N-ethyl-3-[(3,3,3-trifluorpropyl)thio]-propanamid (known from WO 2015/058021 A1, WO 2015/058028 A1) (CAS 1477919-27-9) and N-[4-(Aminothioxomethyl)-2-methyl-6-[(methylamino)carbonyl]phenyl]-3-bromo-1-(3-chloro-2-pyridinyl) 1H-pyrazol-5-carboxamid (known from CN 103265527 A) (CAS 1452877-50-7), 5-(1,3-Dioxan-2-yl)-4-[[4-(trifluormethyl)phenyl]methoxy]-pyrimidin (known from WO 2013/115391 A1) (CAS 1449021-97-9), 3-(4-Chlor-2,6-dimethylphenyl)-8-methoxy-1-methyl-1,8-diazaspiro[4.5]decane-2,4-dion (known from WO 2014/187846 A1) (CAS 1638765-58-8), 3-(4-Chlor-2,6-dimethylphenyl)-8-methoxy-1-methyl-2-oxo-1,8-diazaspiro[4.5]dec-3-en-4-yl-carbonsaureethylester (known from WO 2010/066780 A1, WO 2011151146 A1) (CAS 1229023-00-0), 4-[(5S)-5-(3,5-Dichlor-4-fluorophenyl)-4,5-dihydro-5-(trifluoromethyl)-3-isoxazolyl]-N-[(4R)-2-ethyl-3-oxo-4-isoxazolidinyl]-2-methyl-benzamid (known from WO 2011/067272, WO2013/050302) (CAS 1309959-62-3).

Examples of herbicides a) according to the invention are:

Acetochlor, acifluorfen, acifluorfen-sodium, aclonifen, alachlor, allidochlor, alloxydim, alloxydim-sodium, ametryn, amicarbazone, amidochlor, amidosulfuron, 4-amino-3-chloro-5-fluoro-6-(7-fluoro-1H-indol-6-yl)pyridine-2-carboxylic acid, aminocyclopyrachlor, aminocyclopyrachlor-potassium, aminocyclopyrachlor-methyl, aminopyralid, amitrole, ammoniumsulfamate, anilofos, asulam, atrazine, azafenidin, azimsulfuron, beflubutamid, benazolin, benazolin-ethyl, benfluralin, benfuresate, bensulfuron, bensulfuron-methyl, bensulide, bentazone, benzobicyclon, benzofenap, bicyclopyron, bifenox, bilanafos, bilanafos-sodium, bispyribac, bispyribac-sodium, bixlozone, bromacil, bromobutide, bromofenoxim, bromoxynil, bromoxynil-butyrate, -potassium, -heptanoate, and -octanoate, busoxinone, butachlor, butafenacil, butamifos, butenachlor, butralin, butroxydim, butylate, cafenstrole, carbetamide, carfentrazone, carfentrazone-ethyl, chloramben, chlorbromuron, 1-{2-chloro-3-[(3-cyclopropyl-5-hydroxy-1-methyl-1H-pyrazol-4-yl)carbonyl]-6-(trifluormethyl)phenyl}piperidin-2-on, 4-{2-chloro-3-[(3,5-dimethyl-1H-pyrazol-1-yl)methyl]-4-(methylsulfonyl)benzoyl}-1,3-dimethyl-1H-pyrazol-5-yl-1,3-dimethyl-1H-pyrazol-4-carboxylat, chlorfenac, chlorfenac-sodium, chlorfenprop, chlorflurenol, chlorflurenol-methyl, chloridazon, chlorimuron, chlorimuron-ethyl, 2-[2-chloro-4-(methylsulfonyl)-3-(morpholin-4-ylmethyl)benzoyl]-3-hydroxycyclohex-2-en-1-on, 4-{2-chloro-4-(methylsulfonyl)-3-[(2,2,2-trifluorethoxy)methyl]benzoyl}-1-ethyl-1H-pyrazol-5-yl-1,3-dimethyl-1H-pyrazol-4-carboxylat, chlorophthalim, chlorotoluron, chlorthal-dimethyl, 3-[5-chloro-4-(trifluormethyl)pyridine-2-yl]-4-hydroxy-1-methylimidazolidine-2-on, chlorsulfuron, cinidon, cinidon-ethyl, cinmethylin, cinosulfuron, clacyfos, clethodim, clodinafop, clodinafop-propargyl, clomazone, clomeprop, clopyralid, cloransulam, cloransulam-methyl, cumyluron, cyanamide, cyanazine, cycloate, cyclopyranil, cyclopyrimorate, cyclosulfamuron, cycloxydim, cyhalofop, cyhalofop-butyl, cyprazine, 2,4-D, 2,4-D-butotyl, -butyl, -dimethylammonium, -diolamin, -ethyl, -2-ethylhexyl, -isobutyl, -isooctyl, -isopropylammonium, -potassium, -triisopropanolammonium, and -trolamine, 2,4-DB, 2,4-DB-butyl, -dimethylammonium, -isooctyl, -potassium, and -sodium, daimuron (dymron), dalapon, dazomet, n-decanol, desmedipham, detosyl-pyrazolate (DTP), dicamba, dichlobenil, dichlorprop, dichlorprop-P, diclofop, diclofop-methyl, diclofop-P-methyl, diclosulam, difenzoquat, diflufenican, diflufenzopyr, diflufenzopyr-sodium, dimefuron, dimepiperate, dimethachlor, dimethametryn, dimethenamid, dimethenamid-P, 3-(2,6-dimethylphenyl)-6-[(2-hydroxy-6-oxocyclohex-1-en-1-yl)carbonyl]-1-methylchinazolin-2,4(1H,3H)-dion, 1,3-dimethyl-4-[2-(methylsulfonyl)-4-(trifluormethyl)benzoyl]-1H-pyrazol-5-yl-1,3-dimethyl-1H-pyrazol-4-carboxylat, dimetrasulfuron, dinitramine, dinoterb, diphenamid, diquat, diquat-dibromid, dithiopyr, diuron, DMPA, DNOC, endothal, EPTC, esprocarb, ethalfluralin, ethametsulfuron, ethametsulfuron-methyl, ethiozin, ethofumesate, ethoxyfen, ethoxyfen-ethyl, ethoxysulfuron, etobenzanid, ethyl-[(3-{2-chloro-4-fluoro-5-[3-methyl-2,6-dioxo-4-(trifluormethyl)-3,6-dihydropyrimidin-1(2H)-yl]phenoxy}pyridin-2-yl)oxy]acetat, F-9960, F-5231, i.e. N-{2-chloro-4-fluoro-5-[4-(3-fluoropropyl)-5-oxo-4,5-dihydro-1H-tetrazol-1-yl]phenyl}ethanesulfonamide, F-7967, i. e. 3-[7-chloro-5-fluoro-2-(trifluoromethyl)-1H-benzimidazol-4-yl]-1-methyl-6-(trifluoromethyl)pyrimidine-2,4(1H,3H)-dione, fenoxaprop, fenoxaprop-P, fenoxaprop-ethyl, fenoxaprop-P-ethyl, fenoxasulfone, fenquinotrione, fentrazamide, flamprop, flamprop-M-isopropyl, flamprop-M-methyl, flazasulfuron, florasulam, fluazifop, fluazifop-P, fluazifop-butyl, fluazifop-P-butyl, flucarbazone, flucarbazone-sodium, flucetosulfuron, fluchloralin, flufenacet, flufenpyr, flufenpyr-ethyl, flumetsulam, flumiclorac, flumiclorac-pentyl, flumioxazin, fluometuron, flurenol, flurenol-butyl, -dimethylammonium and -methyl, fluoroglycofen, fluoroglycofen-ethyl, flupropanate, flupyrsulfuron, flupyrsulfuron-methyl-sodium, fluridone, fluro-chloridone, fluroxypyr, fluroxypyr-meptyl, flurtamone, fluthiacet, fluthiacet-methyl, fomesafen, fomesafen-sodium, foramsulfuron, fosamine, glufosinate, glufosinate-ammonium, glufosinate-P-sodium, glufosinate-P-ammonium, glufosinate-P-sodium, glyphosate, glyphosate-ammonium, -isopropylammonium, -diammonium, -dimethylammonium, -potassium, -sodium, and -trimesium, H-9201, i.e. O-(2,4-dimethyl-6-nitrophenyl)O-ethyl isopropylphosphoramidothioate, halauxifen, halauxifen-methyl,halosafen, halosulfuron, halosulfuron-methyl, haloxyfop, haloxyfop-P, haloxyfop-ethoxyethyl, haloxyfop-P-ethoxyethyl, haloxyfop-methyl, haloxyfop-P-methyl, hexazinone, HW-02, i.e. 1-(dimethoxyphosphoryl) ethyl-(2,4-dichlorophenoxy)acetate, 4-hydroxy-1-methoxy-5-methyl-3-[4-(trifluormethyl)pyridine-2-yl]imidazolidine-2-on, 4-hydroxy-1-methyl-3-[4-(trifluormethyl)pyridine-2-yl]imidazolidine-2-on, (5-hydroxy-1-methyl-1H-pyrazol-4-yl)(3,3,4-trimethyl-1,1-dioxido-2,3-dihydro-1-benzothiophen-5-yl)methanon, 6-[(2-hydroxy-6-oxocyclohex-1-en-1-yl)carbonyl]-1,5-dimethyl-3-(2-methylphenyl)chinazolin-2,4(1H,3H)-dion, imazamethabenz, imazamethabenz-methyl, imazamox, imazamox-ammonium, imazapic, imazapic-ammonium, imazapyr, imazapyr-isopropylammonium, imazaquin, imazaquin-ammonium, imazethapyr, imazethapyr-immonium, imazosulfuron, indanofan, indaziflam, iodosulfuron, iodosulfuron-methyl-sodium, ioxynil, ioxynil-octanoate, -potassium and -sodium, ipfencarbazone, isoproturon, isouron, isoxaben, isoxaflutole, karbutilate, KUH-043, i.e. 3-({[5-(difluoromethyl)-1-methyl-3-(trifluoromethyl)-1H-pyrazol-4-yl]methyl}sulfonyl)-5,5-dimethyl-4,5-dihydro-1,2-oxazole, keto-spiradox, lactofen, lenacil, linuron, MCPA, MCPA-butotyl, -dimethylammonium, -2-ethylhexyl, -isopropylammonium, -potassium, and -sodium, MCPB, MCPB-methyl, -ethy,l and -sodium, mecoprop, mecoprop-sodium, and -butotyl, mecoprop-P, mecoprop-P-butotyl, -dimethylammonium, -2-ethylhexyl, and -potassium, mefenacet, mefluidide, mesosulfuron, mesosulfuron-methyl, mesotrione, methabenzthiazuron, metam, metamifop, metamitron, metazachlor, metazosulfuron, methabenzthiazuron, methiopyrsulfuron, methiozolin, 2-({2-[(2-methoxyethoxy)methyl]-6-(trifluormethyl)pyridin-3-yl}carbonyl)cyclohexan-1,3-dion, methyl isothiocyanate, 1-methyl-4-[(3,3,4-trimethyl-1,1-dioxido-2,3-dihydro-1-benzothiophen-5-yl)carbonyl]-1H-pyrazol-5-ylpropan-1-sulfonat, metobromuron, metolachlor, S-metolachlor, metosulam, metoxuron, metribuzin, metsulfuron, metsulfuron-methyl, molinat, monolinuron, monosulfuron, monosulfuron-ester, MT-5950, i.e. N-(3-chloro-4-isopropylphenyl)-2-methylpentan amide, NGGC-011, napropamide, NC-310, i.e. [5-(benzyloxy)-1-methyl-1H-pyrazol-4-yl](2,4-dichlorophenyl)-methanone, neburon, nicosulfuron, nonanoic acid (pelargonic acid), norflurazon, oleic acid (fatty acids), orbencarb, orthosulfamuron, oryzalin, oxadiargyl, oxadiazon, oxasulfuron, oxaziclomefon, oxyfluorfen, paraquat, paraquat dichloride, pebulate, pendimethalin, penoxsulam, pentachlorphenol, pentoxazone, pethoxamid, petroleum oils, phenmedipham, picloram, picolinafen, pinoxaden, piperophos, pretilachlor, primisulfuron, primisulfuron-methyl, prodiamine, profoxydim, prometon, prometryn, propachlor, propanil, propaquizafop, propazine, propham, propisochlor, propoxy-carbazone, propoxycarbazone-sodium, propyrisulfuron, propyzamide, prosulfocarb, prosulfuron, pyraclonil, pyraflufen, pyraflufen-ethyl, pyrasulfotole, pyrazolynate (pyrazolate), pyrazosulfuron, pyrazosulfuron-ethyl, pyrazoxyfen, pyribambenz, pyribambenz-isopropyl, pyribambenz-propyl, pyribenzoxim, pyributicarb, pyridafol, pyridate, pyriftalid, pyriminobac, pyriminobac-methyl, pyrimi-sulfan, pyrithiobac, pyrithiobac-sodium, pyroxasulfone, pyroxsulam, quinclorac, quinmerac, quino-clamine, quizalofop, quizalofop-ethyl, quizalofop-P, quizalofop-P-ethyl, quizalofop-P-tefuryl, QYM-201, QYR-301, rimsulfuron, saflufenacil, sethoxydim, siduron, simazine, simetryn, SL-261, sulcotrion, sulfentrazone, sulfometuron, sulfometuron-methyl, sulfosulfuron, SYN-523, SYP-249, i.e. 1-ethoxy-3-methyl-1-oxobut-3-en-2-yl 5-[2-chloro-4-(trifluoromethyl)phenoxy]-2-nitrobenzoate, SYP-300, i.e. 1-[7-fluoro-3-oxo-4-(prop-2-yn-1-yl)-3,4-dihydro-2H-1,4-benzoxazin-6-yl]-3-propyl-2-thioxoimidazolidine-4,5-dione, 2,3,6-TBA, TCA (trichloroacetic acid), TCA-sodium, tebuthiuron, tefuryltrione, tembotrione, tepraloxydim, terbacil, terbucarb, terbumeton, terbuthylazin, terbutryn, tetflupyrolimet, thenylchlor, thiazopyr, thiencarbazone, thiencarbazone-methyl, thifensulfuron, thifensulfuron-methyl, thiobencarb, tiafenacil, tolpyralate, topramezone, tralkoxydim, triafamone, tri-allate, triasulfuron, triaziflam, tribenuron, tribenuron-methyl, triclopyr, trietazine, trifloxysulfuron, trifloxysulfuron-sodium, trifludimoxazin, trifluralin, triflusulfuron, triflusulfuron-methyl, tritosulfuron, urea sulfate, vernolate, ZJ-0862, i.e. 3,4-dichloro-N-{2-[(4,6-dimethoxypyrimidin-2-yl)oxy]benzyl}aniline, Methyl(2R*,4R*)-4-[[(5S)-3-(3,5-difluorophenyl)-5-vinyl-4H-isoxazole-5-carbonyl]amino]tetrahydrofuran-2-carboxylate.

The at least one active ingredient a) is preferably selected from the group comprising fungicides selected from the group comprising classes as described here above (1) Inhibitors of the respiratory chain at complex, in particular azoles, (2) Inhibitors of the respiratory chain at complex I or II, (3) Inhibitors of the respiratory chain at complex, (4) Inhibitors of the mitosis and cell division, (6) Compounds capable to induce a host defence, (10) Inhibitors of the lipid and membrane synthesis, and (15).

Further preferred, the at least one active ingredient a) as fungicide is selected from the group comprising Trifloxystrobin, Bixafen, Prothioconazole, Inpyrfluxam, Isoflucypram and Fluoxapiprolin.

The at least one insecticide is preferably selected from the group comprising insecticides selected from the group comprising classes as described here above (2 GABA-gated chloride channel antagonists, (3) Sodium channel modulators/voltage-dependent sodium channel blockers (4) (4) Nicotinic acetylcholine receptor (nAChR) competitive activators, (23) Inhibitors of acetyl-CoA carboxylase, (28) Ryanodinreceptor-modulators, (30) other active ingredients.

Also further preferred, the at least one active ingredient a) as insecticide is selected from the group comprising Spirotetramat, Deltamethrine and Ethiprole.

Lastly further preferred, the at least one active ingredient a) as herbicide is selected from the group comprising Triafamone, Tembotrione and Ethofumesat, preferably in combination with safeners.

Even more preferred, the at least one active ingredient is selected from the group comprising trifloxystrobin, bixafen, prothioconazole, inpyrfluxam, isoflucypram, fluoxapiprolin, spirotetramat, ethiprole, deltamethrin, triafamone, tembotrione and ethofumesat.

All named active ingredients as described here above can be present in the form of the free compound or, if their functional groups enable this, an agrochemically active salt thereof.

Furthermore, mesomeric forms as well as stereoisomeres or enantiomeres, where applicable, shall be enclosed, as these modifications are well known to the skilled artisan, as well as polymorphic modifications.

If not otherwise specified, in the present invention solid, agrochemical active compounds a) are to be understood as meaning all substances customary for plant treatment, whose melting point is above 20° C.

### Polymer-Based Drift Reducing Additive b)

Suitable drift reducing polymers are poly(ethylene oxides), wherein the polymer has an average molecular weight preferably from 0.5 to 14 million g/mol, more preferred from 0.75 to 10 million g/mol, and most preferred from 1 to 8 million g/mol, and hydroxypropyl guar (HP guar).

In one embodiment the polymer-based drift reducing additive is poly(ethylene oxide) (PEO), wherein even further preferred the formulation shows with a PEO a Polymer Concentration Factor (PCF) value between 0.5 and 12, more preferably between 1 and 10, even more preferably between 2 and 9.

The Polymer Concentration Factor (PCF) for the PEO polymer content in the formulation is defined where C is the drift reducing polymer (b) concentration in the formulation (g/1), M is the molar mass of the drift reducing polymer (b) (g/mol/1×10⁶), a has a value of 1.4 and D is the formulation dose rate per ha (l/ha). The PCF value is calculated from the following equation:

$$P C F = C \times {M}^{a} \times D$$

In another embodiment the polymer-based drift reducing additive is HP guar.

### Oil-Based Drift Reducing Additive c)

Suitable drift reducing oils are vegetable oils and vegetable oil esters and diesters (including esters with glycerine and propylene glycol).

Particularly preferred are methyl, ethyl, isopropyl, isobutyl, butyl, hexyl and ethylhexyl esters.

More preferred the vegetable oils and esters are selected from the group consisting of methyl oleate, methyl palmitate, rape seed oil methyl ester, isopropyl myristate, isopropyl palmitate, ethylhexyl palmitate, ethylhexyl oleate, mixture of ethylhexyl myristate/laurate, ethylhexyl laurate, mixture of ethylhexyl caprylate/caprate, diisopropyl adipate, coconut oil propyleneglycol diester, sunflower oil, rapeseed oil, corn oil, soybean oil, rice bran oil, olive oil, peanut oil, mixed caprylic and capric triglycerides, and mixed decanoyl and octanoyl glycerides.

Especially preferred are rapeseed oil, rapeseed oil methyl ester, corn oil, ethylhexyl palmitate, isopropyl palmitate or sunflower oil.

Also suitable as drift reducing agent are mineral oils.

### Spreading Agents and Uptake Promoting Additives d):

Some compounds suitable as spreading agents might due to their chemical nature also act as uptake promoting additives and also the other way round. Therefore those compounds are summarized under compound d).

Spreading agents are compounds enhancing the spreading of the tank mix additive or agrochemical formulations containing the tank mix additive on plant parts, especially on leaves.

Suitable spreading agents are selected from the group comprising mono- and diesters of sulfosuccinate metal salts with branched or linear alcohols comprising 1-10 carbon atoms, in particular alkali metal salts, more particular sodium salts, and most particular sodium dioctylsulfosuccinate; as well as organosilicone alkoxylates such as organomodified polysiloxanes/trisiloxane alkoxylates, preferably polyalkyleneoxide modified heptamethyltrisiloxane, wherein the alkylenoxide is preferably selected from ethylenoxide (EO) or propylenoxide (PO), in particular from those with the following CAS No. 27306-78-1 (Poly(oxy-1,2-ethanediyl),.alpha.-methyl-.omega.-[3-[1,3,3,3-tetramethyl-1-[(trimethylsilyl)oxy]disiloxanyl]propoxy]), 67674-67-3 (Poly(oxy-1,2-ethanediyl), alpha.-[3-[1,3,3,3-tetramethyl-1-[(trimethylsilyl)oxy]disiloxanyl]propyl]-.omega.-hydroxy), 134180-76-0 (Oxirane, methyl-, polymer with oxirane, mono3-1,3,3,3-tetramethyl-1-(trimethylsilyl)oxydisiloxanylpropyl ether), e.g., Silwet® L77, Silwet® 408, Silwet® 806, BreakThru® S240, BreakThru® S278.

Other suitable spreading agents are ethoxylated diacetylene-diols with 1 to 6 ethylenoxide (EO) units, e.g. Surfynol® 420 and 440;
as well as alcohol alkoxylates, preferably selected from the group comprising ethoxylated alcohols or propoxy-ethoxylated alcohols, more preferably comprising 6-22 carbon atoms and an average of 5-40 ethylenoxide (EO) and/or propylenoxide (PO) units, in particular Genapol® EP 0244, Genapol® EP 2584 or Synergen® W06 or 1-hexanol, 3,5,5-trimethyl-, ethoxylated, propoxylated (CAS-No 204336-40-3), e.g. Break-Thru® Vibrant;
and further alkylpolysaccharides, e.g. Agnique® PG8107, PG8105 of BASF; Atplus® 438, AL-2559, AL-2575 of Croda.

The term “alcohols” within this context refers to alcohols that can be branched or linear, saturated or unsaturated, with 6-22 carbon atoms and optionally carry additional substituents, such as OH groups.

Preferably the spreading agent is selected from the group comprising mono- and diesters of sulfosuccinate metal salts with branched or linear alcohols comprising 1-10 carbon atoms, organomodified polysiloxanes/trisiloxane alkoxylates, ethoxylated diacetylene-diols with 1 to 6 ethylenoxide (EO) units, alcohol alkoxylates comprising 6-22 carbon atoms or alkylpolysaccharides; more preferably from sodium dioctylsulfosuccinate, polyalkyleneoxide modified heptamethyltrisiloxanes, ethoxylated diacetylene-diols with 1 to 6 EO units or ethoxylated alcohols or propoxy-ethoxylated alcohols, with 6-22 carbon atoms and an average of 5-40 ethylenoxide (EO) and/or propylenoxide (PO) units;
and in particular from the group comprising sodium dioctylsulfosuccinate, polyalkyleneoxide modified heptamethyltrisiloxane and ethoxylated diacetylene-diols with 1 to 6 ethylene oxide units.

In one further preferred embodiment of the invention the spreading agent c) is selected from the group comprising polyalkyleneoxide modified heptamethyltrisiloxanes, dioctylsulfosuccinate, alcohol ethoxylates and ethoxylated diacetylene-diols with 1 to 6 EO, more preferably from the group comprising polyalkyleneoxide modified heptamethyltrisiloxanes, dioctylsulfosuccinate and ethoxylated diacetylene-diols with 1 to 6 EO.

Uptake promoting additives are compounds enhancing the uptake of the tank mix additive or agrochemical formulations containing the tank mix additive into plants or plant parts, especially into leaves.

Suitable uptake promoting additives are alcohol alkoxylates, preferably selected from the group comprising ethoxylated alcohols or propoxy-ethoxylated alcohols, more preferably comprising 6-22 carbon atoms and an average of 5-40 ethylenoxide (EO) and/or propylenoxide (PO) units;
ethoxylated carboxylic acids or propoxy-ethoxylated carboxylic acids, preferably comprising 6-22 carbon atoms and an average of 5-40 ethylenoxide (EO) and/or propylenoxide (PO) units;
or ethoxylated mono-, di- or triesters of glycerine comprising fatty acids with 8-18 carbon atoms and an average of 5-60, preferably 5-40 EO units.

Said ethoxylated or propoxy-ethoxylated alcohols or carboxylic acids are optionally further modified by addition of a methyl radical to the remaining alcohol functionality (cf. “Me end-capped”).

Further suitable uptake promoting additives are selected from alkoxylated sorbitan fatty acid esters comprising fatty acids with 8-18 carbon atoms and an average of 10-50 ethylene oxide and propylene oxide units;
or ethoxylated coconut alcohols comprising 2-20 EO units;
or castor oil ethoxylates comprising an average of 5-40 EO units.

The term “alcohols” within this context refers to alcohols that can be branched or linear, saturated or unsaturated, with 6-22 carbon atoms and optionally carry additional substituents, such as OH groups.

The term “carboxylic acids” within this context refers to carboxylic acids that can be branched or linear, saturated or unsaturated, with 6-22 carbon atoms and optionally carry additional substituents, such as OH groups.

Preferably the uptake promoting additive according to d) is selected from the group comprising alcohol alkoxylates comprising 6-22 carbon atoms, ethoxylated carboxylic acids or propoxy-ethoxylated carboxylic acids comprising 6-22 carbon atoms, ethoxylated mono-, di- or triesters of glycerine comprising fatty acids with 8-18 carbon atoms and an average of 5-60 EO units, alkoxylated sorbitan fatty acid esters comprising fatty acids with 8-18 carbon atoms and an average of 10-50 ethylene oxide and propylene oxide units, ethoxylated coconut alcohols comprising 2-20 EO units or castor oil ethoxylates comprising an average of 5-40 EO units;
more preferably from ethoxylated alcohols or propoxy-ethoxylated alcohols comprising 6-22 carbon atoms and an average of 5-40 ethylenoxide (EO) and/or propylenoxide (PO) units, ethoxylated carboxylic acids or propoxy-ethoxylated carboxylic acids comprising 6-22 carbon atoms and an average of 5-40 ethylenoxide (EO) and/or propylenoxide (PO) units, ethoxylated mono-, di- or triesters of glycerine comprising fatty acids with 8-18 carbon atoms and an average of 5-60 EO units or alkoxylated sorbitan fatty acid esters comprising fatty acids with 8-18 carbon atoms and an average of 10-50 ethylene oxide and propylene oxide units, ethoxylated coconut alcohols comprising 2-20 EO units or castor oil ethoxylates comprising an average of 5-40 EO units;
and in particular from the group of ethoxylated alcohols or propoxy-ethoxylated alcohols comprising 6-22 carbon atoms and an average of 5-40 ethylenoxide (EO) and/or propylenoxide (PO) units, ethoxylated carboxylic acids or propoxy-ethoxylated carboxylic acids comprising 6-22 carbon atoms and an average of 5-40 ethylenoxide (EO) and/or propylenoxide (PO) units, ethoxylated mono-, di- or triesters of glycerine comprising fatty acids with 8-18 carbon atoms and an average of 5-60 ethyleneoxide units, alkoxylated sorbitan fatty acid esters comprising fatty acids with 8-18 carbon atoms and an average of 10-50 ethylene oxide and propylene oxide units.

In one further preferred embodiment of the invention the uptake enhancer c) is selected from the group comprising ethoxylated alcohols, propoxy-ethoxylated alcohols, ethoxylated carboxylic acids, propoxy-ethoxylated carboxylic acids, or ethoxylated mono-, di- or triesters of glycerine comprising fatty acids with 8-18 carbon atoms and an average of 5-40 EO units, alkoxylated sorbitan fatty acid esters comprising fatty acids with 8-18 carbon atoms and an average of 10-50 EO and PO units.

Suitable components d) by way of example are:
ethoxylated linear and/or branched fatty alcohols (e.g. Genapol® X-type of Clariant) with 2-20 EO units;
methyl end-capped, ethoxylated linear and/or branched fatty alcohols (e.g. Genapol® XM-type of Clariant) comprising 2-20 EO units;
ethoxylated coconut alcohols (e.g. Genapol® C-types of Clariant) comprising 2-20 EO units;
ethoxylated C12/15 alcohols (e.g. Synperonic® A-types of Croda) comprising 2-20 EO units;
propoxy-ethoxylated alcohols, branched or linear, e.g. Antarox® B/848 of Solvay, Atlas® G5000 of Croda, Lucramul® HOT 5902 of Levaco;
propoxy-ethoxylated fatty acids, Me end-capped, e.g. Leofat® 0C0503M of Lion;
alkyl ether citrate surfactants (e.g. Adsee CE range, Akzo Nobel);
alkylpolysaccharides (e.g. Agnique® PG8107, PG8105 of BASF; Atplus® 438, AL-2559, AL-2575 of Croda);
ethoxylated mono- or diesters of glycerine comprising fatty acids with 8-18 carbon atoms and an average of 10-60, preferably 10-40 EO units (e.g. Crovol® product range of Croda);
castor oil ethoxylates comprising an average of 5-40 EO units (e.g. Berol® range of Nouryon, Emulsogen® EL range of Clariant);
ethoxylated oleic acid (e.g. Alkamuls© A and AP) comprising 2-20 EO units;
alkoxylated sorbitan fatty acid esters comprising fatty acids with 8-18 carbon atoms and an average of 10-50 EO and/or PO units (e.g. Arlatone® T, Tween range).

### Other Formulants e):

Other formulants e) in the context of the present invention are further additives that are usually used in agrochemical formulations, which are not already covered by components a) to d).

Preferably the other formulants are one or more substances selected from rain-fast additives, surfactants, rheological modifiers, antifoam substances, antifreeze agents, preservatives, biocides, colourants, pH adjusters, buffers, stabilisers, antioxidants, inert filling materials, humectants, crystal growth inhibitors or micronutrients.

More preferably the other formulants e) comprise at least one non-ionic surfactant and/or ionic surfactant, one rheological modifier, one antifoam substance and at least one antifreeze agent.

### e1) Rain-Fast Additives:

Suitable rain-fast additives are acrylic based emulsion polymers or polymer dispersions and styrene based emulsion polymers or polymer dispersions d) are aqueous polymer dispersions with a Tg in the range from −100° C. to 30° C., preferably between −60° C. and 20° C., more preferably between −50° C. and 10° C., most preferably between −45° C. and 5° C., for example Acronal V215, Acronal 3612, Licomer ADH 205 and Atplus FA. Particularly preferred are Licomer ADH205, and Atplus FA.

Preferably, the polymer is selected from the group consisting of acrylic polymers, styrene polymers, vinyl polymers and derivatives thereof, polyolefins, polyurethanes and natural polymers and derivatives thereof.

More preferably, the polymer is selected from the group consisting of acrylic polymers, styrene butadiene copolymers, styrene-maleic anhydride copolymers, polyvinyl alcohol, polyvinyl acetate, partially hydrolysed polyvinyl acetate, methyl vinyl ether-maleic anhydride copolymers, carboxy-modified polyvinyl alcohol, acetoacetyl-modified polyvinyl alcohol, diacetone-modified polyvinyl alcohol and silicon-modified polyvinyl alcohol, isopropylene-maleic anhydride copolymer, polyurethane, cellulose, gelatine, caesin, oxidised starch, starch-vinyl acetate graft copolymers, hydroxyethyl cellulose, methyl cellulose, ethyl cellulose, carboxymethyl cellulose and acetyl cellulose.

Most preferably the polymer is selected from copolymers of an acrylate and a styrene, wherein. Said acrylate selected from the list comprising 2-ethyl-hexyl acrylate, butyl acrylate, sec-butyl acrylate, ethyl acrylate, methyl acrylate, acrylic acid, acrylamide, iso-butyl acrylate, methyl methacrylate, or combinations thereof. Said styrene selected from the list comprising styrene, tert-butyl styrene, para-methyl styrene, or combinations thereof.

In a preferred embodiment the polymer, as described above, has a molecular weight of no more than 40000 g/mol, preferably no more than 10000 g/mol.

In a preferred embodiment the polymer D is an emulsion polymer as described in WO 2017/202684.

The glass transition temperature (Tg) is known for many polymers and is determined in the present invention, if not defined otherwise, according to ASTM E1356-08 (2014) “Standard Test Method for Assignment of the Glass Transition Temperatures by Differential Scanning Calorimetry” wherein the sample is dried prior to DSC at 110° C. for one hour to eliminate effect of water and/or solvent, DSC sample size of 10-15 mg, measured from −100° C. to 100° C. at 20° C./min under N2, with Tg defined as midpoint of the transition region.

### e2) Surfactants:

Suitable non-ionic surfactants or dispersing aids e1) are all substances of this type which can customarily be employed in agrochemical agents. Preferably, polyethylene oxide-polypropylene oxide block copolymers, preferably having a molecular weight of more than 5,000 g/mol or a polyethylene oxide content of more than 35%, more preferably having a molecular weight of more than 6,000 g/mol and a polyethylene oxide content of more than 45%, polyoxyalkylenamine derivatives, polyvinylpyrrolidone, copolymers of polyvinyl alcohol and polyvinylpyrrolidone, and copolymers of (meth)acrylic acid and (meth)acrylic acid esters. Out of the examples mentioned above selected classes can be optionally phosphated, sulphonated or sulphated and neutralized with bases.

Possible anionic surfactants are all substances of this type which can customarily be employed in agrochemical agents. Alkali metal, alkaline earth metal and ammonium salts of alkylsulphonic or alkylphospohric acids as well as alkylarylsulphonic or alkylarylphosphoric acids are preferred. A further preferred group of anionic surfactants or dispersing aids are alkali metal, alkaline earth metal and ammonium salts of polystyrenesulphonic acids, salts of polyvinylsulphonic acids, salts of alkylnaphthalene sulphonic acids, salts of naphthalene-sulphonic acid-formaldehyde condensation products, salts of condensation products of naphthalenesulphonic acid, phenolsulphonic acid and formaldehyde, and salts of lignosulphonic acid.

### e3) Rheological Modifiers:

A rheological modifier is an additive that when added to the recipe at a concentration that reduces the gravitational separation of the dispersed active ingredient during storage results in a substantial increase in the viscosity at low shear rates. Low shear rates are defined as 0.1 s⁻¹ and below and a substantial increase as greater than ×2 for the purpose of this invention. The viscosity can be measured by a rotational shear rheometer.

Suitable rheological modifiers e3) by way of example are:
Polysaccharides including xanthan gum, and hydroxyethyl cellulose. Examples are Kelzan®, Rhodopol® G and 23, Satiaxane® CX911 and Natrosol® 250 range.
Clays including montmorillonite, bentonite, sepiolite, attapulgite, laponite, hectorite. Examples are Veegum® R, Van Gel© B, Bentone® 34, 38, CT, HC, EW, Pangel® M100, M200, M300, S, M, W, Attagel® 50, Laponite® RD,
   Fumed and precipitated silica, examples are Aerosil® 200, Sipernat® 22.
   Microcrystalline cellulose.

Preferred are xanthan gum, montmorillonite clays, bentonite clays and fumed silica.

### e4) Antifoam Substances:

Suitable antifoam substances e4) are all substances which can customarily be employed in agrochemical agents for this purpose. Silicone oils, silicone oil preparations are preferred. Examples are Silcolapse® 426 and 432 from Bluestar Silicones, Silfoam® SRE and SC132 from Wacker, SAF-184® fron Silchem, Foam-Clear ArraPro-S® from Basildon Chemical Company Ltd, SAG© 1572 and SAG© 30 from Momentive [Dimethyl siloxanes and silicones, CAS No. 63148-62-9]. Preferred is SAG© 1572.

### e5) Antifreeze Agents.

Suitable antifreeze agents are all substances which can customarily be employed in agrochemical agents for this purpose. Suitable examples are propylene glycol, ethylene glycol, urea and glycerine.

### e6) Further Formulants:

Further suitable formulants e6) are selected from preservatives, biocides, colourants, pH adjusters, buffers, stabilisers, antioxidants, inert filling materials, humectants, crystal growth inhibitors, micronutrients.

By way of example those are:

Possible preservatives are all substances which can customarily be employed in agrochemical agents for this purpose. Suitable examples for preservatives are preparations containing 5-chloro-2-methyl-4-isothiazolin-3-one [CAS-No. 26172-55-4], 2-methyl-4-isothiazolin-3-one [CAS-No. 2682-20-4] or 1,2-benzisothiazol-3(2H)-one [CAS-No. 2634-33-5]. Examples which may be mentioned are Preventol® D7 (Lanxess), Kathon® CG/ICP (Dow), Acticide® SPX (Thor GmbH) and Proxel® GXL (Arch Chemicals).

Possible colourants are all substances which can customarily be employed in agrochemical agents for this purpose. Titanium dioxide, carbon black, zinc oxide, blue pigments, Brilliant Blue FCF, red pigments and Permanent Red FGR may be mentioned by way of example.

Possible pH adjusters and buffers are all substances which can customarily be employed in agrochemical agents for this purpose. Citric acid, sulfuric acid, hydrochloric acid, sodium hydroxide, sodium hydrogen phosphate (Na₂HPO₄), sodium dihydrogen phosphate (NaH₂PO₄), potassium dihydrogen phosphate (KH₂PO₄), potassium hydrogen phosphate (K₂HPO₄), may be mentioned by way of example.

Suitable stabilisers and antioxidants are all substances which can customarily be employed in agrochemical agents for this purpose. Butylhydroxytoluene [3,5-Di-tert-butyl-4-hydroxytoluol, CAS-No. 128-37-0] is preferred.

Carriers f) are those which can customarily be used for this purpose in agrochemical formulations.

A carrier is a solid or liquid, natural or synthetic, organic or inorganic substance that is generally inert, and which may be used as a solvent. The carrier generally improves the application of the compounds, for instance, to plants, plants parts or seeds. Examples of suitable solid carriers include, but are not limited to, ammonium salts, in particular ammonium sulfates, ammonium phosphates and ammonium nitrates, natural rock flours, such as kaolins, clays, talc, chalk, quartz, attapulgite, montmorillonite and diatomaceous earth, silica gel and synthetic rock flours, such as finely divided silica, alumina and silicates. Examples of typically useful solid carriers for preparing granules include, but are not limited to crushed and fractionated natural rocks such as calcite, marble, pumice, sepiolite and dolomite, synthetic granules of inorganic and organic flours and granules of organic material such as paper, sawdust coconut shells, maize cobs and tobacco stalks.

Preferred solid carriers are selected from clays, talc and silica.

Examples of suitable liquid carriers include, but are not limited to, water, organic solvents and combinations thereof. Examples of suitable solvents include polar and nonpolar organic chemical liquids, for example from the classes of
alcohols and polyols (which may optionally also be substituted, etherified and/or esterified, such as ethanol, propanol, butanol, benzylalcohol, cyclohexanol or glycol, 2-ethyl hexanol),
ethers such as dioctyl ether, tetrahydrofuran, dimethyl isosorbide, solketal, cyclopentyl methyl ether, solvents offered by Dow under the Dowanol Product Range e.g. Dowanol DPM, anisole, phenetole, different molecular weight grades of dimethyl polyethylene glycol (less than 1000 g/mol), different molecular weight grades of dimethyl polypropylene glycol (less than 1000 g/mol), dibenzyl ether
ketones (such as acetone, methyl ethyl ketone, methyl isobutyl ketone, cyclopentanone, cyclohexanone, cycloheptanone, acetophenone, propiophenone),
lactate esters, such as methyl lactate, ethyl lactate, propyl lactate, butyl lactate, 2-ethyl hexyl lactate
unsubstituted and substituted amines
amides (such as dimethylformamide, or N,N-dimethyl lactamide, or N-formyl morpholine, or fatty acid amides such N,N-dimethyl decanamide or N,N-dimethyl dec-9-en-amide) and esters thereof
lactams (such as 2-pyrrolidone, or N-alkylpyrrolidones, such as N-methylpyrrolidone, or N-butylpyrrolidone, or N-octylpyrrolidone, or N-dodecylpyrrolidone or N-methyl caprolactam, N-alkyl caprolactam)
lactones (such as gamma-butyrolactone, gamma-valerolactone, delta-valerolactone, or alpha-methyl gamma-butyrolactone
sulfones and sulfoxides (such as dimethyl sulfoxide),
nitriles, such as linear or cyclic alkyl nitriles, in particular acetonitrile, cyclohexane carbonitrile, octanonitrile, dodecanonitrile).
linear and cyclic carbonates, such as diethyl carbonate, dipropyl carbonate, dibutyl carbonate, dioctyl carbonate, or ethylene carbonate, propylene carbonate, butylene carbonate, carbonate

Most preferred the carrier is water.

With the aid of the formulations according to the invention it is possible to deliver active agrochemical to plants and/or their habitat in a particularly advantageous way.

The present invention is also directed to the use of agrochemical formulations according to the invention for the application of the agrochemical active compounds contained to plants and/or their habitat.

With the formulations of the invention it is possible to treat all plants and plant parts. By plants here are meant all plants and plant populations, such as desirable and unwanted wild plants or crop plants (including naturally occurring crop plants). Crop plants may be plants which can be obtained by conventional breeding and optimization methods or by biotechnological and gene-technological methods or combinations of these methods, including the transgenic plants and including the plant cultivars which can or cannot be protected by varietal property rights. By plant parts are to be meant all above-ground and below-ground parts and organs of the plants, such as shoot, leaf, flower and root, an exemplary listing embracing leaves, needles, stems, trunks, flowers, fruit bodies, fruits and seeds and also roots, tubers and rhizomes. The plant parts also include harvested material and also vegetative and generative propagation material.

The application rate of the formulations or spray liquids containing the formulations according to the invention can be varied within a relatively wide range. It is guided by the particular active agrochemicals and by their amount in the formulations or spray liquids.

The formulations or spray liquids containing the formulations according to the invention are applied by customary methods, i.e., for example, by spraying, pouring or injecting, in particular by spraying, and most particular by spraying by unmanned aerial vehicles UAV or unmanned guided vehicles UGV or a spray nozzle device using pulse width modulation PWM.

One further aspect of the invention is the use of a formulation according to the invention in application of agrochemical compounds for controlling harmful organisms, wherein a formulation or spray liquid containing the formulation is applied by an unmanned aerial vehicle UAV or an unmanned guided vehicle UGV or a spray nozzle device using pulse width modulation PWM.

### FIGURES

FIG. 1 shows spray droplet size %<100 microns for different spray volumes for recipes in example FN1.

FIG. 2 shows spray droplet size %<100 microns for different spray volumes for recipes in example FN2.

FIG. 3 shows spray droplet size %<100 microns for different spray volumes for recipes in example FN3.

FIG. 4 shows spray droplet size %<100 microns for different spray volumes for recipes in example FN4.

FIG. 5 shows spray droplet size %<100 microns for different spray volumes for recipes in example FN5.

FIG. 6 shows spray droplet size %<100 microns for different spray volumes for recipes in example FN6.

FIG. 7 shows spray droplet size %<100 microns for different PEO polymer molar mass and concentrations for example Polymers1.

FIG. 8 shows spray droplet size %<100 microns for different PEO polymer molar mass and PCF value for example Polymers2.

FIG. 9 shows spray droplet size %<100 microns for different spray volumes for recipes in example IN1.

FIG. 10 shows spray droplet size %<100 microns for different spray volumes for recipes in example HB1.

FIG. 11 shows spray droplet size %<100 microns for different spray volumes for recipes in example HB2.

FIG. 12 shows spray droplet size %<100 microns for different spray volumes for recipes in example HB3.

FIG. 13 shows spray droplet size %<100 microns for different spray volumes for recipes in example HB4.

FIG. 14 shows spray droplet size %<100 microns for different spray volumes for recipes in example HB5.

### MATERIALS TABLES

### Materials

TABLE MAT1
Exemplified trade names and CAS-No's of preferred
drift reducing materials - Polymers b)

| Product | Chemical name | Cas No. | Supplier |
|---|---|---|---|
| Polyox ® | Poly(ethylene oxide) | 25322-68-3 | Dupont |
| WSR N12K | (average molecular | | |
| | weight 1 million g/mol) | | |
| Polyox ® | Poly(ethylene oxide) | 25322-68-3 | Dupont |
| WSR N60K | (average molecular | | |
| | weight 2 million g/mol) | | |
| Polyox ® | Poly(ethylene oxide) | 25322-68-3 | Dupont |
| WSR 301 | (average molecular | | |
| | weight 4 million g/mol) | | |
| Polyox ® | Poly(ethylene oxide) | 25322-68-3 | Dupont |
| WSR 308 | (average molecular | | |
| | weight 8 million g/mol) | | |
| AgRho ® DR2000 | hydroxypropyl guar | 68442-94-4. | Solvay |
| | | 39421-75-5 | |
| Jaguar ® HP-120 | hydroxypropyl guar | 68442-94-4. | Solvay |
| | | 39421-75-5 | |
| Jaguar ® HP-8 | hydroxypropyl guar | 68442-94-4. | Solvay |
| | | 39421-75-5 | |
| Jaguar ® 308 NB | hydroxypropyl guar | 68442-94-4. | Solvay |
| | | 39421-75-5 | |

TABLE MAT2
Exemplified trade names and CAS-No's of
preferred drift reducing materials - Oils c)

| Product | Chemical name | Cas No. | Supplier |
|---|---|---|---|
| Radia ® 7060 | methyl oleate | 112-62-9 | Oleon NV, BE |
| Radia ® 7120 | methyl palmitate | 112-39-0 | Oleon NV, BE |
| Agnique ME ® | Rape seed oil methyl | 67762-38-3. | Clariant |
| 18 RD-F, | ester | 85586-25-0 | BASF |
| Edenor ® MESU | | | |
| Crodamol ® EO | ethyl oleate | 111-62-6 | Croda |
| Estol ® 1514 | iso-propyl myristate | 110-27-0 | Croda |
| Crodamol ® IPM | | | |
| Radia ® 7732 | iso-propyl palmitate | 142-91-6 | Oleon NV, BE |
| Crodamol ® IPP | | | Croda, UK |
| Radia ® 7129 | ethylhexyl palmitate | 29806-73-3 | Oleon NV, BE |
| Crodamol ® OP | | | Croda, UK |
| Radia ® 7130 | ethylhexyl oleate | 26399-02-0 | Oleon NV, BE |
| Radia ® 7128 | ethylhexyl | 29806-75-5 | Oleon NV, BE |
| | myristate/laurate | | |
| | C12/C14 | | |
| Radia ® 7127 | ethylhexyl laurate | 20292-08-4 | Oleon NV, BE |
| Radia ® 7126 | ethylhexyl | 63321-70-0 | Oleon NV, BE |
| | caprylate/caprate | | |
| | C8/10 | | |
| Crodamol DA | di-isopropyl adipate | 6938-94-9 | Croda |
| Crodamol | Propyleneglycol di- | 85409-09-2 | Croda |
| PC DAB | ester of coconut | | |
| | fatty acids | | |
| Sunflower oil | Triglycerides from | 8001-21-6 | |
| | different C14-C18 | | |
| | fatty acids, predom- | | |
| | inantly unsaturated | | |
| Rapeseed oil | Triglycerides from | 8002-13-9 | |
| | different C14-C18 | | |
| | fatty acids, predom- | | |
| | inantly unsaturated | | |
| Corn oil | Triglycerides from | 8001-30-7 | |
| | different C14-C18 | | |
| | fatty acids, predom- | | |
| | inantly unsaturated | | |
| Soybean oil | Triglycerides from | 8001-22-7 | |
| | different C14-C18 | | |
| | fatty acids, predom- | | |
| | inantly unsaturated | | |
| Rice bran oil | Triglycerides from | 68553-81-1 | |
| | different C14-C18 | | |
| | fatty acids, predom- | | |
| | inantly unsaturated | | |
| Olive oil | | | |
| Peanut oil | | | |
| Radia ® 7104 | Caprylic, capric | 73398-61-5. | Oleon NV, BE |
| | triglycerides, neutral | 65381-09-1 | |
| | vegetable oil | | |
| Miglyol ® 812N | Glycerides, mixed | 73398-61-5. | IOI |
| | decanoyl and octanoy1 | 65381-09-1 | Oleochemical |
| Exxsol ® D80 | Mineral oil | 64742-47-8 | Exxon |

TABLE MAT3
Exemplified trade names and CAS-No's of preferred spreading agents d)

| Product | Chemical name | Cas No. | Supplier |
|---|---|---|---|
| Geropon ® | Dioctylsulfosuccinate sodium | 577-11-7 | Rhodia |
| DOS-PG | salt (65-70% in propylene | | |
| | glycol) | | |
| Synergen ® W 10 | Dioctylsulfosuccinate sodium | 577-11-7 | Clariant |
| | salt (65-70% in propylene | | |
| | glycol) | | |
| Aerosol ® | Dioctylsulfosuccinate sodium | 577-11-7 | Cytec |
| OT 70 PG | salt (65-70% in propylene | | |
| | glycol) | | |
| Lankropol KPH70 | Dioctylsulfosuccinate sodium | 577-11-7 | Nouryon |
| | salt (65-70% in propylene | | |
| | glycol) | | |
| Enviomet EM | Dioctylsulfosuccinate sodium | 577-11-7 | Innospec |
| 5669 | salt (65-70% in propylene | | |
| | glycol) | | |
| Surfynol ® S420 | 2,4,7,9-Tetramethy1-5-Decyne- | 9014-85-1 | Evonik |
| | 4,7-Diol ethoxylate (1 mole) | | |
| Surfynol ® S440 | 2,4,7,9-Tetramethyl-5-Decyne- | 9014-85-1 | Evonik |
| | 4,7-Diol ethoxylate (3.5 moles) | | |
| Surfynol ® S465 | 2,4,7,9-Tetramethyl-5-Decyne- | 9014-85-1 | Evonik |
| | 4,7-Diol ethoxylate (10 moles) | | |
| Surfynol ® S485 | 2,4,7,9-Tetramethyl-5-Decyne- | 9014-85-1 | Evonik |
| | 4,7-Diol ethoxylate (30 moles) | | |
| Break-Thru ® | 1-Hexanol, 3,5,5-trimethyl-, | 204336-40-3 | Evonik |
| Vibrant | ethoxylated, propoxylated | | |
| Genapol ® EP | C10-12 alcohol alkoxylate | | Clariant |
| 0244 | (PO + EO) | | |
| Synergen ® W06 | C11 alcohol alkoxylate | | Clariant |
| | (PO + EO) | | |
| Genapol ® EP | C12-15 alcohol alkoxylate | | Clariant |
| 2584 | (PO + EO) | | |
| Agnique ® | Oligomeric D-glucopyranose | 68515-73-1 | BASF |
| PG8107 | decyl octyl glycosides | | |
| Silwet ® L77 | 3-(2-methoxyethoxy)propyl- | 27306-78-1 | Momentive |
| | methyl- | | |
| | bis(trimethylsilyloxy)silane | | |
| Silwet ® 408 | 2-[3- | 67674-67-3 | Momentive |
| | [[dimethyl(trimethyl- | | |
| | silyloxy)silyl]oxy-methyl- | | |
| | trimethylsilyloxysilyl]pro- | | |
| | poxylethanol | | |
| Silwet ® 806 | 3-[methyl- | 134180-76-0 | Momentive |
| | bis(trimethylsilyloxy)silyl]pro- | | |
| | pan-1-ol;2-methyloxirane;oxirane | | |
| Break-thru ® S240 | 3-[methyl- | 134180-76-0 | Evonik |
| | bis(trimethylsilyloxy)silyl]pro- | | |
| | pan-1-ol;2-methyloxirane;oxirane | | |
| Break-thru ® S278 | 3-(2-methoxyethoxy)propyl- | 27306-78-1 | Evonik |
| | methyl- | | |
| | bis(trimethylsilyloxy)silane | | |
| Silwet ® HS 312 | Polyalkyleneoxide silane | Not disclosed | Momentive |
| Silwet ® HS 604 | Poly(oxy-1,2-ethanediyl), alpha- | 881689-05-0 | Momentive |
| | (3-(dimethyl(2- | | |
| | (trimethylsilyl)ethyl)sily1)propyl)- | | |
| | omega-methoxy- | | |
| BreakThru ® OE | Siloxanes and Silicones, cetyl | 191044-49-2 | Evonik |
| 444 | Me, di-Me | | |

TABLE MAT4
Exemplified trade names and CAS-No's
of preferred uptake promoting additives d)

| Product | Chemical name | Cas No. | Supplier |
|---|---|---|---|
| Emulsogen ® | Ethoxylated Castor Oil | 61791-12-6 | Clariant |
| EL 400 | with 40 EO | | |
| Etocas ® 10 | Ethoxylated Castor Oil | 61791-12-6 | Croda |
| | with 10 EO | | |
| Crovol ® CR70G | fats and glyceridic oils, | 70377-91-2 | Croda |
| | vegetable, ethoxylated | | |
| Synperonic ® A3 | alcohol ethoxylate | 68131-39-5 | Croda |
| | (C12/C15-EO3) | | |
| Synperonic ® A7 | alcohol ethoxylate | 68131-39-5 | Croda |
| | (C12/C15-EO7) | | |
| Genapol ® X060 | alcohol ethoxylate | 9043-30-5 | Clariant |
| | (iso-C13-EO6) | | |
| Alkamuls ® A | Oleic acid, ethoxylated | 9004-96-0 | Solvay |
| Lucramul ® HOT | alcohol ethoxylate- | 64366-70-7 | Levaco |
| 5902 | propoxylate | | |
| Antarox B/848 | Butyl alcohol | 9038-95-3 | Solvay |
| | propoxylate/ethoxylate | | |
| Tween ® 80 | Sorbitan monooleate, | 9005-65-6 | Croda |
| | ethoxylated (20EO) | | |
| Tween ® 85 | Sorbitan trioleate, | 9005-70-3 | Croda |
| | ethoxylated (20EO) | | |
| Tween ® 20 | Sorbitan monolaurate, | 9005-64-5 | Croda |
| | ethoxylated (20EO) | | |
| Tween ® L-1505 | Sorbitan monolaurate, | | Croda |
| | alkoxylated | | |
| Genapol ®C 100 | Alcohols, coco, | 61791-13-7 | Clariant |
| | ethoxylated | | |

TABLE MAT5
Exemplified trade names of preferred rain-fast additives e)

| Product | Chemical name | Tg | | MFFT | Supplier |
|---|---|---|---|---|---|
| Atplus ® FA | Aqueous styrene acrylic co- | <30° | C. | | Croda |
| | polymer emulsion dispersion | | | | |
| Acronal ® V215 | aqueous acrylate co-polymer | −43° | C. | | BASF |
| Acronal ® V115 | dispersion containing | −58° | C. | | |
| Acronal ® A245 | carboxylic groups. | −45° | C. | | |
| Acronal ® A240 | | −30° | C. | | |
| Acronal ® A225 | | −45° | C. | | |
| Acronal ® A145 | | −45° | C. | | |
| Acronal ® 500 D | aqueous acrylic co-polymer | −13° | C. | | BASF |
| Acronal ® S 201 | dispersion | −25° | C. | | |
| Acronal ® DS 3618 | aqueous acrylic ester co- | −40° | C. | | BASF |
| Acronal ® 3612 | polymer dispersion | +12° | C. | | |
| Acronal ® V 212 | | −40° | C. | | |
| Acronal ® DS 3502 | | +4° | C. | | |
| Acronal ® S 400 | | −8° | C. | | |
| Licomer ® ADH205 | aqueous acrylic ester co- | <30° | C. | | Michelman |
| Licomer ® ADH203 | polymer dispersion containing | | | | |
| | carboxylic groups. | | | | |
| Primal ® CM-160 | Aqueous acrylic copolymer | | | | DOW |
| Primal ® CM-330 | emulsion polymer | | | | |
| AxilatR UltraGreen | Aqueous acrylic emulsion | −15° | C. | 0° C. | Synthomer |
| 5500 | polymer | | | | |
| Povol ® 26/88 | Polyvinyl alcohol | | | | Kuraray |

TABLE MAT6
Exemplified trade names and CAS-No's of preferred other formulants e)

| Product | Chemical name | Cas No. | Supplier |
|---|---|---|---|
| Synperonic ® | block-copolymer of polyethylene | 9003-11-6 | Croda |
| PE/F127 | oxide and polypropylene oxide | | |
| Synperonic ® | block-copolymer of polyethylene | 9003-11-6 | Croda |
| PE/L62 | oxide and polypropylene oxide | | |
| Xanthan | Polysaccharide | 11138-66-2 | |
| Proxel ® GXL | 1.2-benzisothiazol-3(2H)-one | 2634-33-5 | Arch Chemicals |
| Kathon ® CG/ICP | 5-chloro-2-methyl-4-isothiazolin- | 26172-55-4 plus | Dow |
| | 3-one plus 2-methyl-4- | 2682-20-4 | |
| | isothiazolin-3-one | | |
| Propylene glycol | 1,2-Propylene glycol | 57-55-6 | |
| Glycerol | Propane-1,2,3-triol | 56-81-5 | |
| SAG ® 1572 | Dimethyl siloxanes and silicones | 63148-62-9 | Momentive |
| Atlox ® 4913 | methyl methacrylate graft | 119724-54-8 | Croda |
| | copolymer with polyethylene | | |
| | glycol | | |
| Atlox ® 4894 | Fatty Alcohol Ethoxylate | 68131-39-5 | Croda |
| Atlas ® G 5000 | Oxirane, methyl-, polymer with | 9038-95-3 | Croda |
| | oxirane, monobutyl ether | | |
| Geropon ® T36 | Sodium polycarboxylate | 37199-81-8 | Solvay |
| Lucramul ® PS 29 | Poly(oxy-1,2-ethanediy1),.alpha.- | 104376-75-2 | Levaco |
| | phenyl-.omega.-hydroxy-, | | |
| | styrenated | | |
| Soprophor ® TS/29 | Poly(oxy-1,2-ethanediy1),.alpha.- | 104376-75-2 | Solvay |
| | phenyl-.omega.-hydroxy-, | | |
| | styrenated | | |
| Soprophor ® TS/54 | Poly(oxy-1,2-ethanediy1),.alpha.- | 104376-75-2 | Solvay |
| | phenyl-.omega.-hydroxy-, | | |
| | styrenated | | |
| Morwet ® IP | Naphthalenesulfonic acid, bis(1- | 68909-82-0 | Akzo Nobel |
| | methylethyl)-, Me derivs., sodium | | |
| | salts | | |
| Van Gel ® B | Smectite-group minerals | 12199-37-0 | Vanderbilt |
| Veegum ® R | | | |
| Aerosil R972 | Silane, dichlorodimethyl-, reaction | 68611-44-9 | Evonik |
| | products with silica | | |
| Silcolapse ® 454 | Polydimethylsiloxanes and silica | 9016-00-6 | Bluestar Silicones |
| Silcolapse ® 426R | Polydimethylsiloxanes and silica | 9016-00-6 | Bluestar Silicones |
| Rhodopol ® 23 | Polysaccharide | 11138-66-2 | Solvay |
| Acticide ® MBS | Mixture of 2-methyl-4-isothiazolin- | 2682-20-4 | Thor GmbH |
| | 3-one (MIT) and 1,2- | 2634-33-5 | |
| | benzisothiazolin-3-one (BIT) in | | |
| | water | | |
| Sokalan ® K 30 | Polyvinylpyrrolidone | 9003-39-8 | BASF |
| Supragil ® WP | Sodium diisopropyl naphthalene | 1322-93-6 | Solvay |
| | sulfonate | | |
| Morwet ® D-425 | Sodium naphthalene sulphonate | 577773-56-9 | Akzo Nobel, |
| | formaldehyde condensate | 68425-94-5 | Nouryon |
| | | 9008-63-3 | |
| Soprophor ® 4 D 384 | Tristyrylphenol ethoxylate sulfate | 119432-41-6 | Solvay |
| | (16 EO) ammonium salt | | |
| Soprophor ® FLK | Poly(oxy-1,2-ethanediy1), alpha.- | 163436-84-8 | Solvay |
| | 2,4,6-tris(1- | | |
| | phenylethyl)phenyl-.omega.- | | |
| | hydroxy-, phosphate, potassium | | |
| | salt | | |
| Rhodorsil ® Antim | absorbed poly(dimethylsiloxane) | unknown | Solvay |
| EP 6703 | antifoam | | |
| Kaolin Tec 1 | Aluminium hydrosilicate | 1318-74-7 | Ziegler & Co. |
| | | 1332-58-7 | GmbH |
| Sipernat ® 22 S | synthetic amorphous silica (silicon | 112926-00-8 | Evonik |
| | dioxide) | 7631-86-9 | |
| Rhodacal ® 60 BE | Calcium- | 26264-06-2 | Solvay |
| | dodecylbenzenesulphonate in | 104-76-7 | |
| | 2-Ethylhexanol | | |
| Sodium hydrogen | Na₂HPO₄ | 7558-79-4 | |
| phosphate | | | |
| Sodium dihydrogen | NaH₂PO₄ | 7558-80-7 | |
| phosphate | | | |
| Citric Acid | C₆H₈O₇ | 77-92-9 | |
| Glycerine | C₃H₈O₃ | 56-81-5 | |
| Urea | CH₄N₂O | 57-13-6 | |
| Supragil WP | Sodium diisopropyl naphthalene | 1322-93-6 | Solvay |
| | sulfonate | | |
| Morwet D-425 | Naphthalene sulphonate | 9008-63-3 | Nouryon |
| | formaldehyde condensate Na salt | | |
| Sokalan K 30 | Polyvinylpyrrolidone | 9003-39-8 | BASF |
| Silcolapse 454 | Polydimethylsiloxane | 7631-86-9 | Solvay |
| | | 9016-00-6 | |
| Sipernat 50 S | synthetic amorphous silica (silicon | 112926-00-8 | Evonik |
| | dioxide) | 7631-86-9 | |
| Kaolin Tec 1 | Aluminiumhydrosilicate | 1318-74-7 | Ziegler & Co. |
| | | 1332-58-7 | GmbH |

### Experimental Methods

### Method 1: Flowables SC Preparation

The method of the preparation of flowable suspension concentrate formulations is known in the art and can be produced by known methods familiar to those skilled in the art. A 5% gel of Van Gel B (e) was prepared by mixing a 5% dispersion in water under high shear. A 2% gel of Rhodopol 23 (xanthan) (e) in water and the biocides (e) was prepared with low shear stirring. A 1-4% solution of drift reducing polymer (b) was prepared by mixing the polymer in glycerine (25%) and pouring this mixture into water (to 100%) with stirring until homogeneous. A 50% oil in water emulsion of drift reducing oil (c) was prepared by adding oil (50%) to water (49%) and Synperonic PE/F127 (1%) in solution under high shear mixing (Ultra-Turrax©) to achieve a droplet size of 1 to 4 microns (Dv50). The active ingredient (a), non-ionic and anionic dispersants (e), antifoam (e) and other formulants (e) were mixed with the water to form a slurry, first mixed with a high shear rotor-stator mixer (Ultra-Turrax©) to reduce the particle size D(v,0.9) to approximately 50 microns, then passed through one or more bead mills (Eiger® 250 Mini Motormill) to achieve a particles size D(v,0.9) typically 1 to 15 microns. Then if present in the recipe, the spreading and/or uptake promoting additive(s) (d) were added and mixed in with stirring, followed by the polymer (b) solution prepared above, the 50% oil (c) emulsion prepared above, the 5% Van Gel B gel and the 2% Rhodopol 23 (xanthan) gel prepared above were added and mixed in with low shear stirring until homogeneous. Further water was added as required to give the final amount. Finally, the pH was adjusted if needed to pH 6.5 to pH 7.5 with acid or base (e).

The polymer (b) solution is prepared according to the viscosity concentration limit and content required in the recipe. Typical example values are: Polyox WSR301 (1-2%), Polyox WSR N60K (1-3%), Polyox WSR N12K (2-4%), AgRho DR2000 (1-2%).

Flowable formulations containing small levels of emulsified oils can be described as both Suspension Concentrate and Suspo-emulsion formulation types (www.croplife.org, Technical Monograph No: 2, Catalogue of pesticide formulation types and international coding system, Edition: March 2017).

### Method 2: Spray Droplet Size P15 Measurement

The formulations were diluted in water (deionised) to the required concentration, sprayed through a TeeJet® TP8002EVS nozzle at a pressure of 3 bar and the droplet size spectra measured with an Oxford Lasers VisiSize P15 which captures images of the spray droplets and measures their size. The spray nozzle was positioned 20 cm above the image capture point and slowly moved by a motorised slider across the image capture window of the VisiSize P15, ensuring that the complete width of the spray fan was measured. A minimum of 5000 to 10000 droplet images were captured. The droplet size spectra were calculated by the instrument software as volume % less than 100 microns and volume % less than 150 microns, which are commonly regarded as the driftable fraction of the spray droplets.

### Method 3: Viscosity Measurement

The viscosity was measured in a rotational shear rheometer at 22° C. over an increasing shear rate range of 0.2 to 1000 s⁻¹. The measurements comprised a series of logarithmically spaced shear rates including 1 s⁻¹, 20 s⁻¹ and 100 s-1 and the viscosity recorded. The samples were not pre-sheared prior to measurement.

### Method 4: SL Preparation Method

The method of the preparation of soluble liquid formulations are known in the art and can be produced by known methods familiar to those skilled in the art. A 1-4% solution of drift reducing polymer (b) was prepared by mixing the polymer in glycerine (25%) and pouring this mixture into water (to 100%) with stirring until homogeneous. A 50% oil in water emulsion of drift reducing oil (c) was prepared by adding oil (50%) to water (49%) and Synperonic PE/F127 (1%) in solution under high shear mixing (Ultra-Turrax®) to achieve a droplet size of 1 to 4 microns (Dv50). The active ingredient (a), previously neutralised with base (for example diglycolamine), is added to the other surfactants as a 55% aqueous solution with stirring. Further water is added to give the total amount. The active ingredient (a), other formulants (e), the spreading and/or uptake promoting additive(s) (d) were mixed with the water with stirring, followed by the polymer (b) solution prepared above, the 50% oil (c) emulsion prepared above with low shear stirring until homogeneous. Finally, the pH was adjusted if needed with acid or base (e).

### EXAMPLES

### Fungicides

### Example FN1: Trifloxystrobin 80 SC

TABLE FN1.1
Recipes FN1.1, FN1.2, FN1.3, FN1.4 and FN1.5.

| | | | Recipe | | Recipe | Recipe |
|---|---|---|---|---|---|---|
| | Recipe | Recipe | FN1.3 | | FN1.5 | FN1.6 |
| | FN1.1 | FN1.2 | containing | | containing | containing |
| | containing | containing | drift | | drift | drift |
| | drift | drift | reducing | Recipe | reducing | reducing |
| Component | reducing | reducing | polymer (b) | FN1.4 | polymer (b) | polymer (b) |
| (g/l) | polymer (b) | oil (c) | and oil (c) | reference | and oil (c) | and oil (c) |
| Trifloxystrobin | 80.0 | 80.0 | 80.0 | 80.0 | 80.0 | 80.0 |
| Morwet ® | 5.0 | 5.0 | 5.0 | 5.0 | 5.0 | 5.0 |
| D425 | | | | | | |
| Atlox ® 4913 | 20.0 | 20.0 | 20.0 | 20.0 | 20.0 | 20.0 |
| Synperonic ® | 10.0 | 10.0 | 10.0 | 10.0 | 10.0 | 10.0 |
| PE/F127 | | | | | | |
| AgRho ® | 6.0 | 0.0 | 6.0 | 0.0 | 10.0 | 2.0 |
| DR2000 | | | | | | |
| Rapeseed oil | 0.0 | 12.0 | 12.0 | 0.0 | 12.0 | 12.0 |
| Silwet ® 408 | 20.0 | 20.0 | 20.0 | 20.0 | 20.0 | 20.0 |
| Crovol ® | 60.0 | 60.0 | 60.0 | 60.0 | 60.0 | 60.0 |
| CR70G | | | | | | |
| Xanthan | 3.0 | 3.0 | 3.0 | 3.0 | 3.0 | 3.0 |
| Van Gel ® B | 5.0 | 5.0 | 5.0 | 5.0 | 5.0 | 5.0 |
| Proxel ® GXL | 1.8 | 1.8 | 1.8 | 1.8 | 1.8 | 1.8 |
| Kathon ® | 0.8 | 0.8 | 0.8 | 0.8 | 0.8 | 0.8 |
| CG/ICP | | | | | | |
| Glycerine | 80.0 | 80.0 | 80.0 | 80.0 | 80.0 | 80.0 |
| SAG ® 1572 | 3.0 | 3.0 | 3.0 | 3.0 | 3.0 | 3.0 |
| Na₂HPO₄ | 1.5 | 1.5 | 1.5 | 1.5 | 1.5 | 1.5 |
| (Buffer | | | | | | |
| solution | | | | | | |
| pH = 7) | | | | | | |
| NaH₂PO₄ | 0.8 | 0.8 | 0.8 | 0.8 | 0.8 | 0.8 |
| (Buffer | | | | | | |
| solution | | | | | | |
| pH = 7) | | | | | | |
| Water (add to | To volume | To volume | To volume | To volume | To volume | To volume |
| 1 litre) | (~763) | (~757) | (~751) | (~769) | (~747) | (~755) |

The method of preparation used was according to Method 1.

### Physical Aspect

The physical aspect with regard to viscosity was assessed visually.

TABLE FN1.2
Physical aspect of recipes.

| | Drift reducing | | |
|---|---|---|---|
| | polymer (b) | | Shear viscosity at |
| | concentration | | 20 s⁻¹ shear |
| Recipe | in recipe g/l | Physical aspect | rate mPa s |
| FN1.1 | 6.0 | Fluid pourable suspension. | 290 |
| FN1.2 | 0.0 | Fluid pourable suspension. | 239 |
| FN1.3 | 6.0 | Fluid pourable suspension. | 268 |
| FN1.4 | 0.0 | Fluid pourable suspension. | 234 |
| FN1.5 | 10.0 | Fluid pourable suspension. | 469 |
| FN1.6 | 2.0 | Fluid pourable suspension. | 302 |

Viscosity measurement by Method 3.

The results show that the polymer AgRho® DR2000 (HP guar) can be incorporated into SC recipes at a concentration of 2.0 to 10.0 g/l. It can also be seen that increasing concentrations of the polymer AgRho® DR2000 cause an increase in the viscosity of the SC formulations and viscosity values greater than 600 mPa s (at 20 s⁻¹ shear rate) often result in inferior pour properties for the customer and are not desired.

### Spray Droplet Size

The spray droplet size was determined according to method 2.

TABLE FN1.3
Driftable fraction of spray droplets.

| | | | | | Amount of | Amount of |
|---|---|---|---|---|---|---|
| | | | | | driftable | driftable |
| | | | | Spreading | droplet | droplet |
| | | Drift | Drift | and uptake | fraction | fraction |
| | | reducing | reducing oil | promoting | (at % | (at % |
| | | polymer (b) | (c) | agent (d) | vol <100 | vol <150 |
| | Spray | concentration | concentration | concentration | microns) | microns) |
| | volume | in recipe | in recipe | in recipe | from | from |
| Recipe | l/ha | g/l | g/l | g/l | recipe % vol | recipe % vol |
| FN1.1 | 200 | 6.0 | 0.0 | 80.0 | 19.6 | 41.0 |
| | 40 | | | | 20.1 | 43.0 |
| | 20 | | | | 18.1 | 40.8 |
| | 10 | | | | 14.4 | 33.5 |
| | 5 | | | | 9.7 | 23.1 |
| FN1.2 | 200 | 0.0 | 12.0 | 80.0 | 9.4 | 26.2 |
| | 40 | | | | 12.1 | 31.2 |
| | 20 | | | | 16.0 | 37.3 |
| | 10 | | | | 19.2 | 42.7 |
| | 5 | | | | 23.6 | 49.3 |
| FN1.3 | 200 | 6.0 | 12.0 | 80.0 | 14.2 | 33.6 |
| | 40 | | | | 20.1 | 44.3 |
| | 20 | | | | 20.0 | 43.3 |
| | 10 | | | | 16.7 | 37.2 |
| | 5 | | | | 9.8 | 24.9 |
| FN1.4 | 200 | 0.0 | 0.0 | 80.0 | 20.6 | 42.2 |
| | 40 | | | | 21.1 | 45.2 |
| | 20 | | | | 23.4 | 46.7 |
| | 10 | | | | 22.9 | 49.1 |
| | 5 | | | | 24.6 | 48.7 |
| FN1.5 | 200 | 10.0 | 12.0 | 80.0 | 14.0 | 32.5 |
| | 40 | | | | 20.4 | 43.1 |
| | 20 | | | | 18.0 | 41.1 |
| | 10 | | | | 13.5 | 31.9 |
| | 5 | | | | 6.9 | 18.3 |
| FN1.6 | 200 | 2.0 | 12.0 | 80.0 | 9.3 | 27.6 |
| | 40 | | | | 15.4 | 36.8 |
| | 20 | | | | 21.8 | 46.7 |
| | 10 | | | | 26.6 | 53.6 |
| | 5 | | | | 23.1 | 47.7 |

Formulations sprayed at a dose rate of 1 l/ha.

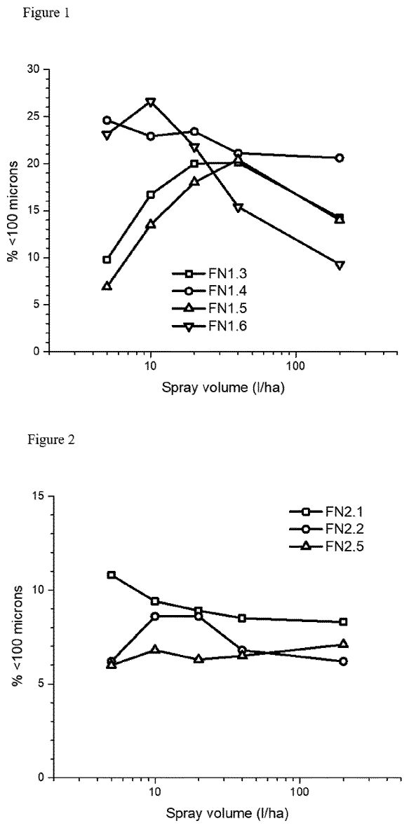

The results show that the addition of rapeseed oil is able to reduce the driftable fraction of spray droplets<100 microns and <150 microns at higher spray volumes and that the addition of polymer AgRho® DR2000 can reduce the driftable fraction of spray droplets at lower spray volumes. However, it is only the combination of the rapeseed oil and the AgRho® DR2000 polymer that is able to reduce the driftable fraction of spray droplets at both high and low spray volumes. Furthermore, it can be seen that the amount of the AgRho® DR2000 polymer is important with 2 g/l insufficient, 6 g/l and 10 g/l sufficient for the reduction at low spray volumes (see FIG. 1). This corresponds to only 6 to 10 g polymer/ha which is a surprisingly low amount to reduce the driftable fraction of spray droplets. It is further surprising how low an amount of the rapeseed oil is required to reduce the driftable fraction of spray droplets, with these amounts well below the typical use rates for these materials. The corresponding concentrations in the spray liquid are shown in Table FN1.4. and demonstrate that a combination of rapeseed oil at 0.06 to 2.4 g/l and AgRho® DR2000 polymer at 0.03 to 2.0 g/l (FN1.3 and FN1.5) in the spray liquid achieve the observed reduction of driftable fraction of spray droplets in Table FN1.3.

TABLE FN1.4
Concentrations of drift reducing polymer, drift reducing oil and
spreading and uptake promoting agents in the spray dilution.

| | | | | Spreading and |
|---|---|---|---|---|
| | | Drift reducing | Drift reducing | uptake promoting |
| | | polymer (b) | oil (c) | agent (d) |
| | Spray | concentration | concentration | concentration |
| | volume | in spray liquid | in spray liquid | in spray liquid |
| Recipe | l/ha | g/l | g/1 | g/l |
| FN1.1 | 200 | 0.03 | 0.0 | 0.4 |
| | 40 | 0.15 | 0.0 | 2.0 |
| | 20 | 0.3 | 0.0 | 4.0 |
| | 10 | 0.6 | 0.0 | 8.0 |
| | 5 | 1.2 | 0.0 | 16.0 |
| FN1.2 | 200 | 0.0 | 0.06 | 0.4 |
| | 40 | 0.0 | 0.3 | 2.0 |
| | 20 | 0.0 | 0.6 | 4.0 |
| | 10 | 0.0 | 1.2 | 8.0 |
| | 5 | 0.0 | 2.4 | 16.0 |
| FN1.3 | 200 | 0.03 | 0.06 | 0.4 |
| | 40 | 0.15 | 0.3 | 2.0 |
| | 20 | 0.3 | 0.6 | 4.0 |
| | 10 | 0.6 | 1.2 | 8.0 |
| | 5 | 1.2 | 2.4 | 16.0 |
| FN1.4 | 200 | 0.0 | 0.0 | 0.4 |
| | 40 | 0.0 | 0.0 | 2.0 |
| | 20 | 0.0 | 0.0 | 4.0 |
| | 10 | 0.0 | 0.0 | 8.0 |
| | 5 | 0.0 | 0.0 | 16.0 |
| FN1.5 | 200 | 0.05 | 0.06 | 0.4 |
| | 40 | 0.25 | 0.3 | 2.0 |
| | 20 | 0.5 | 0.6 | 4.0 |
| | 10 | 1.0 | 1.2 | 8.0 |
| | 5 | 2.0 | 2.4 | 16.0 |
| FN1.6 | 200 | 0.01 | 0.06 | 0.4 |
| | 40 | 0.05 | 0.3 | 2.0 |
| | 20 | 0.1 | 0.6 | 4.0 |
| | 10 | 0.2 | 1.2 | 8.0 |
| | 5 | 0.4 | 2.4 | 16.0 |

Formulations sprayed at a dose rate of 1 l/ha.

### Example FN2: Bixafen SC

TABLE FN2.1
Recipes FN2.1, FN2.2, FN2.3, FN2.4 and FN2.5.

| | | Recipe FN2.2 | | | Recipe FN2.5 |
|---|---|---|---|---|---|
| | | containing | Recipe FN2.3 | Recipe FN2.4 | containing |
| | | drift | containing | containing | drift |
| | Recipe | reducing | drift | drift | reducing |
| | FN2.1 | polymer (b) | reducing | reducing | polymer (b) |
| Component (g/l) | reference | and oil (c) | polymer (b) | oil (c) | and oil (c) |
| Bixafen | 100.0 | 100.0 | 100.0 | 100.0 | 100.0 |
| Morwet ® D425 | 5.0 | 5.0 | 5.0 | 5.0 | 5.0 |
| Soprophor ® FLK | 10.0 | 10.0 | 10.0 | 10.0 | 10.0 |
| Synperonic ® | 10.0 | 10.0 | 10.0 | 10.0 | 10.0 |
| PE/F127 | | | | | |
| Polyox ® WSR | 0.0 | 2.0 | 2.0 | 0.0 | 2.0 |
| 301 | | | | | |
| Crodamol ® OP | 0.0 | 10.0 | 0.0 | 10.0 | 10.0 |
| Silwet ® 408 | 0.0 | 0.0 | 50.0 | 50.0 | 50.0 |
| Xanthan | 3.0 | 3.0 | 3.0 | 3.0 | 3.0 |
| Van Gel ® B | 5.0 | 5.0 | 5.0 | 5.0 | 5.0 |
| Proxel ® GXL | 1.8 | 1.8 | 1.8 | 1.8 | 1.8 |
| Kathon ® CG/ICP | 0.8 | 0.8 | 0.8 | 0.8 | 0.8 |
| Glycerine | 80.0 | 80.0 | 80.0 | 80.0 | 80.0 |
| SAG ® 1572 | 3.0 | 3.0 | 3.0 | 3.0 | 3.0 |
| Na₂HPO₄ | 1.5 | 1.5 | 1.5 | 1.5 | 1.5 |
| (Buffer | | | | | |
| solution | | | | | |
| pH = 7) | | | | | |
| NaH₂PO₄ | 0.8 | 0.8 | 0.8 | 0.8 | 0.8 |
| (Buffer | | | | | |
| solution | | | | | |
| pH = 7) | | | | | |
| Water | To volume | To volume | To volume | To volume | To volume |
| (add to | (~849) | (~837) | (~797) | (~789) | (~787) |
| 1 litre) | | | | | |

The method of preparation used was according to Method 1.

### Physical Aspect

The physical aspect with regard to viscosity was assessed visually.

TABLE FN2.2
Physical aspect of recipes.

| | Drift reducing | |
|---|---|---|
| | polymer (b) | |
| | concentration | |
| Recipe | in recipe g/l | Physical aspect |
| FN2.1 | 0.0 | Fluid pourable suspension. |
| FN2.2 | 2.0 | Fluid pourable suspension. |
| FN2.3 | 2.0 | Fluid pourable suspension. |
| FN2.4 | 0.0 | Fluid pourable suspension. |
| FN2.5 | 2.0 | Fluid pourable suspension. |

The results show that the polymer Polyox® WSR301 can be incorporated into SC recipes at a concentration of 2.0 g/L.

### Spray Droplet Size

The spray droplet size was determined according to Method 2.

TABLE FN2.3
Driftable fraction of spray droplets.

| | | | | | Amount of | Amount of |
|---|---|---|---|---|---|---|
| | | | | | driftable | driftable |
| | | | | | droplet | droplet |
| | | Drift | Drift | | fraction | fraction |
| | | reducing | reducing oil | Spreading | (at % | (at % |
| | | polymer (b) | (c) | agent (d) | vol <100 | vol <150 |
| | Spray | concentration | concentration | concentration | microns) | microns) |
| | volume | in recipe | in recipe | in recipe | from | from |
| Recipe | l/ha | g/l | g/l | g/l | recipe % vol | recipe % vol |
| FN2.1 | 200 | 0.0 | 0.0 | 0.0 | 8.3 | 23.2 |
| | 40 | | | | 8.5 | 24.1 |
| | 20 | | | | 8.9 | 23.9 |
| | 10 | | | | 9.4 | 24.9 |
| | 5 | | | | 10.8 | 27.1 |
| FN2.2 | 200 | 2.0 | 10.0 | 0.0 | 6.2 | 20.0 |
| | 40 | | | | 6.8 | 21.2 |
| | 20 | | | | 8.6 | 23.5 |
| | 10 | | | | 8.6 | 23.7 |
| | 5 | | | | 6.2 | 17.7 |
| FN2.3 | 200 | 2.0 | 0.0 | 50.0 | 8.4 | 22.5 |
| | 40 | | | | 8.1 | 23.0 |
| | 20 | | | | 9.2 | 25.7 |
| | 10 | | | | 8.6 | 24.7 |
| | 5 | | | | 9.3 | 23.9 |
| FN2.4 | 200 | 0.0 | 10.0 | 50.0 | 7.8 | 22.9 |
| | 40 | | | | 8.9 | 25.5 |
| | 20 | | | | 9.7 | 27.5 |
| | 10 | | | | 11.1 | 30.5 |
| | 5 | | | | 14.2 | 35.6 |
| FN2.5 | 200 | 2.0 | 10.0 | 50.0 | 7.1 | 20.7 |
| | 40 | | | | 6.5 | 20.0 |
| | 20 | | | | 6.3 | 19.7 |
| | 10 | | | | 6.8 | 22.4 |
| | 5 | | | | 6.0 | 18.5 |

Formulations sprayed at a dose rate of 0.5 l/ha.

The results show that the combination of polymer Polyox® WSR301 (PEG 4 million) and oil Crodamol® OP can reduce the driftable fraction of spray droplets<100 microns and <150 microns over the spray volume range of 5 to 200 l/ha (see FIG. 2). The amounts of polymer Polyox® WSR301 and oil applied per hectare (ha) are 1 g/ha and 5 g/ha respectively which are remarkably low amounts and well below the typical use rates for these materials. The corresponding concentrations in the spray liquid are shown in Table FN2.4.

TABLE FN2.4
Concentrations of drift reducing polymer, drift reducing oil and
spreading and uptake promoting agents in the spray dilution.

| | | Drift reducing | Drift reducing | Spreading |
|---|---|---|---|---|
| | | polymer (b) | oil (c) | agent (d) |
| | Spray | concentration | concentration | concentration |
| | volume | in spray liquid | in spray liquid | in spray liquid |
| Recipe | l/ha | g/1 | g/l | g/l |
| FN2.1 | 200 | 0.0 | 0.0 | 0.0 |
| | 40 | 0.0 | 0.0 | 0.0 |
| | 20 | 0.0 | 0.0 | 0.0 |
| | 10 | 0.0 | 0.0 | 0.0 |
| | 5 | 0.0 | 0.0 | 0.0 |
| FN2.2 | 200 | 0.005 | 0.025 | 0.0 |
| | 40 | 0.025 | 0.125 | 0.0 |
| | 20 | 0.05 | 0.25 | 0.0 |
| | 10 | 0.1 | 0.5 | 0.0 |
| | 5 | 0.2 | 1.0 | 0.0 |
| FN2.3 | 200 | 0.005 | 0.0 | 0.125 |
| | 40 | 0.025 | 0.0 | 0.625 |
| | 20 | 0.05 | 0.0 | 1.25 |
| | 10 | 0.1 | 0.0 | 2.5 |
| | 5 | 0.2 | 0.0 | 5.0 |
| FN2.4 | 200 | 0.0 | 0.025 | 0.125 |
| | 40 | 0.0 | 0.125 | 0.625 |
| | 20 | 0.0 | 0.25 | 1.25 |
| | 10 | 0.0 | 0.5 | 2.5 |
| | 5 | 0.0 | 1.0 | 5.0 |
| FN2.5 | 200 | 0.005 | 0.025 | 0.125 |
| | 40 | 0.025 | 0.125 | 0.625 |
| | 20 | 0.05 | 0.25 | 1.25 |
| | 10 | 0.1 | 0.5 | 2.5 |
| | 5 | 0.2 | 1.0 | 5.0 |

Formulations sprayed at a dose rate of 0.5 l/ha.

### Example FN3: Isoflucypram SC

TABLE FN3.1
Recipes FN3.1, FN3.2, FN3.3, FN3.4 and FN3.5.

| | | Recipe FN3.2 | | | Recipe FN3.5 |
|---|---|---|---|---|---|
| | | containing | Recipe FN3.3 | Recipe FN3.4 | containing |
| | | drift | containing | containing | drift |
| | Recipe | reducing | drift | drift | reducing |
| Component | FN3.1 | polymer (b) | reducing | reducing | polymer (b) |
| (g/l) | reference | and oil (c) | polymer (b) | oil (c) | and oil (c) |
| Isoflucypram | 100.0 | 100.0 | 100.0 | 100.0 | 100.0 |
| Morwet ® D425 | 5.0 | 5.0 | 5.0 | 5.0 | 5.0 |
| Synperonic ® | 10.0 | 10.0 | 10.0 | 10.0 | 10.0 |
| PE/F127 | | | | | |
| Polyox ® WSR | 0.0 | 2.0 | 2.0 | 0.0 | 2.0 |
| N60K | | | | | |
| Rapeseed oil | 0.0 | 10.0 | 0.0 | 10.0 | 10.0 |
| methyl ester | | | | | |
| Silwet ® 806 | 0.0 | 0.0 | 40.0 | 40.0 | 40.0 |
| Xanthan | 3.0 | 3.0 | 3.0 | 3.0 | 3.0 |
| Van Gel ® B | 5.0 | 5.0 | 5.0 | 5.0 | 5.0 |
| Proxel ® GXL | 1.8 | 1.8 | 1.8 | 1.8 | 1.8 |
| Kathon ® CG/ICP | 0.8 | 0.8 | 0.8 | 0.8 | 0.8 |
| Glycerine | 80.0 | 80.0 | 80.0 | 80.0 | 80.0 |
| SAG ® 1572 | 3.0 | 3.0 | 3.0 | 3.0 | 3.0 |
| Na₂HPO₄ (Buffer | 1.5 | 1.5 | 1.5 | 1.5 | 1.5 |
| solution | | | | | |
| pH = 7) | | | | | |
| NaH₂PO₄ (Buffer | 0.8 | 0.8 | 0.8 | 0.8 | 0.8 |
| solution | | | | | |
| pH = 7) | | | | | |
| Water (add to | To volume | To volume | To volume | To volume | To volume |
| 1 litre) | (~859) | (~847) | (~817) | (~809) | (~807) |

The method of preparation used was according to Method 1.

### Physical Aspect

The physical aspect with regard to viscosity was assessed visually.

TABLE FN3.2
Physical aspect of recipes.

| | Drift reducing | |
|---|---|---|
| | polymer (b) | |
| | concentration | |
| Recipe | in recipe g/l | Physical aspect |
| FN3.1 | 0.0 | Fluid pourable suspension. |
| FN3.2 | 2.0 | Fluid pourable suspension. |
| FN3.3 | 2.0 | Fluid pourable suspension. |
| FN3.4 | 0.0 | Fluid pourable suspension. |
| FN3.5 | 2.0 | Fluid pourable suspension. |

The results show that the polymer Polyox® WSR N60K can be incorporated into SC recipes at a concentration of 2.0 g/L.

### Spray Droplet Size

The spray droplet size was determined according to Method 2.

TABLE FN3.3
Driftable fraction of spray droplets.

| | | | | | Amount of | Amount of |
|---|---|---|---|---|---|---|
| | | | | | driftable | driftable |
| | | | | | droplet | droplet |
| | | Drift | Drift | | fraction | fraction |
| | | reducing | reducing oil | Spreading | (at % | (at % |
| | | polymer (b) | (c) | agent (d) | vol <100 | vol <150 |
| | Spray | concentration | concentration | concentration | microns) | microns) |
| | volume | in recipe | in recipe | in recipe | from | from |
| Recipe | l/ha | g/l | g/l | g/l | recipe % vol | recipe % vol |
| FN3.1 | 200 | 0.0 | 0.0 | 0.0 | 17.6 | 39.9 |
| | 40 | | | | 17.7 | 40.2 |
| | 20 | | | | 16.9 | 38.4 |
| | 10 | | | | 16.4 | 37.4 |
| | 5 | | | | 18.0 | 39.6 |
| FN3.2 | 200 | 2.0 | 10.0 | 0.0 | 7.9 | 25.4 |
| | 40 | | | | 8.9 | 26.6 |
| | 20 | | | | 10.8 | 29.7 |
| | 10 | | | | 13.3 | 35.4 |
| | 5 | | | | 15.0 | 36.7 |
| FN3.3 | 200 | 2.0 | 0.0 | 40.0 | 12.0 | 31.1 |
| | 40 | | | | 13.3 | 33.3 |
| | 20 | | | | 15.8 | 27.0 |
| | 10 | | | | 16.2 | 37.9 |
| | 5 | | | | 15.1 | 35.0 |
| FN3.4 | 200 | 0.0 | 10.0 | 40.0 | 6.8 | 23.7 |
| | 40 | | | | 7.0 | 22.7 |
| | 20 | | | | 7.5 | 24.6 |
| | 10 | | | | 9.7 | 30.6 |
| | 5 | | | | 18.5 | 43.4 |
| FN3.5 | 200 | 2.0 | 10.0 | 40.0 | 6.9 | 22.7 |
| | 40 | | | | 9.0 | 27.1 |
| | 20 | | | | 10.8 | 29.7 |
| | 10 | | | | 15.1 | 37.9 |
| | 5 | | | | 15.9 | 38.2 |

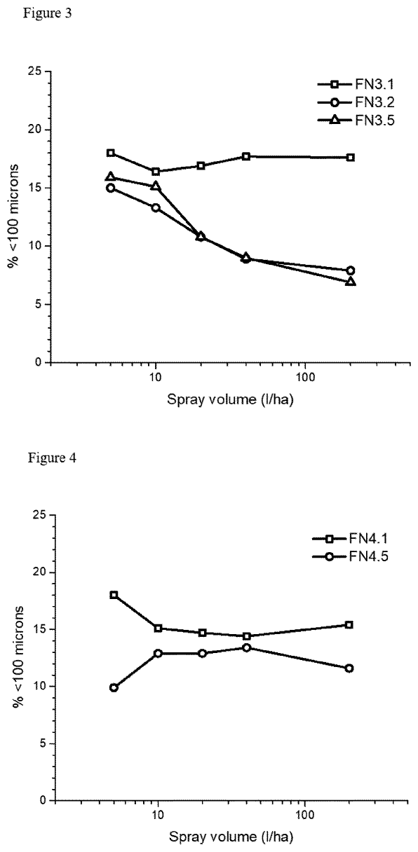

The results show that the combination of polymer Polyox® SR N12K (PEG 1 million) and methylated rapeseed oil can reduce the driftable fraction of spray droplets<100 microns and <150 microns over the spray volume range of 5 to 200 l/ha (see FIG. 3). The amounts of polymer Polyox® WSR N12K and oil applied per hectare (ha) are 1 g/ha and 5 g/ha respectively which are remarkably low amounts and well below the typical use rates for these materials. The corresponding concentrations in the spray liquid are shown in Table FN3.4. Here the effect at low spray volumes (5 and 10 l/ha) is limited demonstrating that 2 g/l of Polyox® WSR N12K in a formulation applied at 0.5 l/ha which corresponds to a dose of 1 g/ha is the lower limit, below which the polymer concentration is too low to affect the spray droplet size.

TABLE FN3.4
Concentrations of drift reducing polymer, drift reducing oil and
spreading and uptake promoting agents in the spray dilution.

| | | Drift reducing | Drift reducing | Spreading |
|---|---|---|---|---|
| | | polymer (b) | oil (c) | agent (d) |
| | Spray | concentration | concentration | concentration |
| | volume | in spray liquid | in spray liquid | in spray liquid |
| Recipe | l/ha | g/l | g/l | g/l |
| FN3.1 | 200 | 0.0 | 0.0 | 0.0 |
| | 40 | 0.0 | 0.0 | 0.0 |
| | 20 | 0.0 | 0.0 | 0.0 |
| | 10 | 0.0 | 0.0 | 0.0 |
| | 5 | 0.0 | 0.0 | 0.0 |
| FN3.2 | 200 | 0.005 | 0.025 | 0.0 |
| | 40 | 0.025 | 0.125 | 0.0 |
| | 20 | 0.05 | 0.25 | 0.0 |
| | 10 | 0.1 | 0.5 | 0.0 |
| | 5 | 0.2 | 1.0 | 0.0 |
| FN3.3 | 200 | 0.005 | 0.0 | 0.1 |
| | 40 | 0.025 | 0.0 | 0.5 |
| | 20 | 0.05 | 0.0 | 1.0 |
| | 10 | 0.1 | 0.0 | 2.0 |
| | 5 | 0.2 | 0.0 | 4.0 |
| FN3.4 | 200 | 0.0 | 0.025 | 0.1 |
| | 40 | 0.0 | 0.125 | 0.5 |
| | 20 | 0.0 | 0.25 | 1.0 |
| | 10 | 0.0 | 0.5 | 2.0 |
| | 5 | 0.0 | 1.0 | 4.0 |
| FN3.5 | 200 | 0.005 | 0.025 | 0.1 |
| | 40 | 0.025 | 0.125 | 0.5 |
| | 20 | 0.05 | 0.25 | 1.0 |
| | 10 | 0.1 | 0.5 | 2.0 |
| | 5 | 0.2 | 1.0 | 4.0 |

Formulations sprayed at a dose rate of 0.5 l/ha.

### Example FN4: Inpyrfluxam SC

TABLE FN4.1
Recipes FN4.1, FN4.2, FN4.3, FN4.4 and FN4.5.

| | | Recipe FN4.2 | | | Recipe FN4.5 |
|---|---|---|---|---|---|
| | | containing | Recipe FN4.3 | Recipe FN4.4 | containing |
| | | drift | containing | containing | drift |
| | Recipe | reducing | drift | drift | reducing |
| Component | FN4.1 | polymer (b) | reducing | reducing | polymer (b) |
| (g/l) | reference | and oil (c) | polymer (b) | oil (c) | and oil (c) |
| Inpyrfluxam | 120.0 | 120.0 | 120.0 | 120.0 | 120.0 |
| Morwet ® D425 | 5.0 | 5.0 | 5.0 | 5.0 | 5.0 |
| Synperonic ® | 10.0 | 10.0 | 10.0 | 10.0 | 10.0 |
| PE/F127 | | | | | |
| Polyox ® WSR | 0.0 | 2.0 | 2.0 | 0.0 | 2.0 |
| N60K | | | | | |
| Sunflower oil | 0.0 | 10.0 | 0.0 | 10.0 | 10.0 |
| Crovol ® CR70G | 0.0 | 0.0 | 120.0 | 120.0 | 120.0 |
| Xanthan | 3.0 | 3.0 | 3.0 | 3.0 | 3.0 |
| Van Gel ® B | 5.0 | 5.0 | 5.0 | 5.0 | 5.0 |
| Proxel ® GXL | 1.8 | 1.8 | 1.8 | 1.8 | 1.8 |
| Kathon ® CG/ICP | 0.8 | 0.8 | 0.8 | 0.8 | 0.8 |
| Glycerine | 80.0 | 80.0 | 80.0 | 80.0 | 80.0 |
| SAG ® 1572 | 3.0 | 3.0 | 3.0 | 3.0 | 3.0 |
| Na₂HPO₄ (Buffer | 1.5 | 1.5 | 1.5 | 1.5 | 1.5 |
| solution | | | | | |
| pH = 7) | | | | | |
| NaH₂PO₄ (Buffer | 0.8 | 0.8 | 0.8 | 0.8 | 0.8 |
| solution | | | | | |
| pH = 7) | | | | | |
| Water (add to | To volume | To volume | To volume | To volume | To volume |
| 1 litre) | (~841) | (~829) | (~719) | (~711) | (~709) |

The method of preparation used was according to Method 1.

### Physical Aspect

The physical aspect with regard to viscosity was assessed visually.

TABLE FN4.2
Physical aspect of recipes.

| | Drift reducing | |
|---|---|---|
| | polymer (b) | |
| | concentration | |
| Recipe | in recipe g/l | Physical aspect |
| FN4.1 | 0.0 | Fluid pourable suspension. |
| FN4.2 | 2.0 | Fluid pourable suspension. |
| FN4.3 | 2.0 | Fluid pourable suspension. |
| FN4.4 | 0.0 | Fluid pourable suspension. |
| FN4.5 | 2.0 | Fluid pourable suspension. |

The results show that the polymer Polyox® WSR N60K can be incorporated into SC recipes at a concentration of 2.0 g/L.

### Spray Droplet Size

The spray droplet size was determined according to Method 2.

TABLE FN4.3
Driftable fraction of spray droplets.

| | | | | | Amount of | Amount of |
|---|---|---|---|---|---|---|
| | | | | | driftable | driftable |
| | | | | | droplet | droplet |
| | | Drift | Drift | Uptake | fraction | fraction |
| | | reducing | reducing oil | promoting | (at % | (at % |
| | | polymer (b) | (c) | agent (d) | vol <100 | vol <150 |
| | Spray | concentration | concentration | concentration | microns) | microns) |
| | volume | in recipe | in recipe | in recipe | from | from |
| Recipe | l/ha | g/l | g/l | g/l | recipe % vol | recipe % vol |
| FN4.1 | 200 | 0.0 | 0.0 | 0.0 | 15.4 | 34.9 |
| | 40 | | | | 14.4 | 33.4 |
| | 20 | | | | 14.7 | 33.5 |
| | 10 | | | | 15.1 | 35.8 |
| | 5 | | | | 18.0 | 37.9 |
| FN4.2 | 200 | 2.0 | 10.0 | 0.0 | 7.8 | 25.0 |
| | 40 | | | | 7.4 | 26.2 |
| | 20 | | | | 10.4 | 30.5 |
| | 10 | | | | 12.1 | 35.4 |
| | 5 | | | | 14.9 | 35.6 |
| FN4.3 | 200 | 2.0 | 0.0 | 120.0 | 12.1 | 30.7 |
| | 40 | | | | 14.3 | 34.6 |
| | 20 | | | | 12.3 | 32.8 |
| | 10 | | | | 12.9 | 32.8 |
| | 5 | | | | 10.0 | 25.3 |
| FN4.4 | 200 | 0.0 | 10.0 | 120.0 | 13.3 | 35.0 |
| | 40 | | | | 15.7 | 37.4 |
| | 20 | | | | 16.1 | 39.5 |
| | 10 | | | | 19.3 | 43.6 |
| | 5 | | | | 19.2 | 44.4 |
| FN4.5 | 200 | 2.0 | 10.0 | 120.0 | 11.6 | 32.1 |
| | 40 | | | | 13.4 | 34.6 |
| | 20 | | | | 12.9 | 34.7 |
| | 10 | | | | 12.9 | 32.2 |
| | 5 | | | | 9.9 | 28.4 |

Formulations sprayed at a dose rate of 0.5 l/ha.

The results show that(the combination of polymer Polyox® WSR N12K (PEG 1 million) and sunflower oil can reduce the driftable fraction of spray droplets<100 microns and <150 microns over the spray volume range of 5 to 200 l/ha (see FIG. 4). The amounts of polymer Polyox® WSR N12K and oil applied per hectare (ha) are 1 g/ha and 5 g/ha respectively which are remarkably low amounts and well below the typical use rates for these materials.

TABLE FN4.4
Concentrations of drift reducing polymer, drift reducing oil and
spreading and uptake promoting agents in the spray dilution.

| | | Drift reducing | Drift reducing | Uptake enhancing |
|---|---|---|---|---|
| | | polymer (b) | oil (c) | agent (d) |
| | Spray | concentration | concentration | concentration |
| | volume | in spray liquid | in spray liquid | in spray liquid |
| Recipe | l/ha | g/l | g/l | g/l |
| FN4.1 | 200 | 0.0 | 0.0 | 0.0 |
| | 40 | 0.0 | 0.0 | 0.0 |
| | 20 | 0.0 | 0.0 | 0.0 |
| | 10 | 0.0 | 0.0 | 0.0 |
| | 5 | 0.0 | 0.0 | 0.0 |
| FN4.2 | 200 | 0.005 | 0.025 | 0.0 |
| | 40 | 0.025 | 0.125 | 0.0 |
| | 20 | 0.05 | 0.25 | 0.0 |
| | 10 | 0.1 | 0.5 | 0.0 |
| | 5 | 0.2 | 1.0 | 0.0 |
| FN4.3 | 200 | 0.005 | 0.0 | 0.3 |
| | 40 | 0.025 | 0.0 | 1.5 |
| | 20 | 0.05 | 0.0 | 3.0 |
| | 10 | 0.1 | 0.0 | 6.0 |
| | 5 | 0.2 | 0.0 | 12.0 |
| FN4.4 | 200 | 0.0 | 0.025 | 0.3 |
| | 40 | 0.0 | 0.125 | 1.5 |
| | 20 | 0.0 | 0.25 | 3.0 |
| | 10 | 0.0 | 0.5 | 6.0 |
| | 5 | 0.0 | 1.0 | 12.0 |
| FN4.5 | 200 | 0.005 | 0.025 | 0.3 |
| | 40 | 0.025 | 0.125 | 1.5 |
| | 20 | 0.05 | 0.25 | 3.0 |
| | 10 | 0.1 | 0.5 | 6.0 |
| | 5 | 0.2 | 1.0 | 12.0 |

Formulations sprayed at a dose rate of 0.5 l/ha.

### Example FN5: Fluoxapiprolin 40 SC

TABLE FN5.1
Recipes FN5.1, FN5.2, FN5.3, FN5.4 and FN5.5.

| | | Recipe | | | Recipe | |
|---|---|---|---|---|---|---|
| | | FN5.2 | Recipe | | FN5.5 | |
| | | containing | FN5.3 | Recipe | containing | |
| | | drift | containing | FN5.4 | drift | |
| | | reducing | drift | containing | reducing | |
| | Recipe | polymer | reducing | drift | polymer | Recipe |
| Component | FN5.1 | (b) and oil | polymer | reducing | (b) and oil | FN5.6 |
| (g/l) | reference | (c) | (b) | oil (c) | (c) | reference |
| Fluoxapiprolin | 40.0 | 40.0 | 40.0 | 40.0 | 40.0 | 40.0 |
| Morwet ® D425 | 5.0 | 5.0 | 5.0 | 5.0 | 5.0 | 5.0 |
| Soprophor ® | 8.0 | 8.0 | 8.0 | 8.0 | 8.0 | 8.0 |
| 4D384 | | | | | | |
| Synperonic ® | 10.0 | 10.0 | 10.0 | 10.0 | 10.0 | 10.0 |
| PE/F127 | | | | | | |
| Polyox ® WSR | 0.0 | 2.2 | 2.2 | 0.0 | 2.2 | 0.0 |
| 301 | | | | | | |
| Corn oil | 0.0 | 15.0 | 0.0 | 15.0 | 15.0 | 0.0 |
| Tween ® L1505 | 0.0 | 0.0 | 150.0 | 150.0 | 150.0 | 150.0 |
| Xanthan | 3.0 | 3.0 | 3.0 | 3.0 | 3.0 | 3.0 |
| Van Gel ® B | 5.0 | 5.0 | 5.0 | 5.0 | 5.0 | 5.0 |
| Proxel ® GXL | 1.8 | 1.8 | 1.8 | 1.8 | 1.8 | 1.8 |
| Kathon ® CG/ICP | 0.8 | 0.8 | 0.8 | 0.8 | 0.8 | 0.8 |
| Glycerine | 80.0 | 80.0 | 80.0 | 80.0 | 80.0 | 80.0 |
| SAG ® 1572 | 3.0 | 3.0 | 3.0 | 3.0 | 3.0 | 3.0 |
| Na₂HPO₄ (Buffer | 1.5 | 1.5 | 1.5 | 1.5 | 1.5 | 1.5 |
| solution pH = 7) | | | | | | |
| NaH₂PO₄ (Buffer | 0.8 | 0.8 | 0.8 | 0.8 | 0.8 | 0.8 |
| solution pH = 7) | | | | | | |
| Water (add to 1 | To volume | To volume | To volume | To volume | To volume | To volume |
| litre) | (~883) | (~866) | (~731) | (~718) | (~716) | (~733) |

The method of preparation used was according to Method 1.

### Physical Aspect

The physical aspect with regard to viscosity was assessed visually.

TABLE FN5.2
Physical aspect of recipes.

| | Drift reducing | |
|---|---|---|
| | polymer (b) | |
| | concentration | |
| Recipe | in recipe g/l | Physical aspect |
| FN5.1 | 0.0 | Fluid pourable suspension. |
| FN5.2 | 2.2 | Fluid pourable suspension. |
| FN5.3 | 2.2 | Fluid pourable suspension. |
| FN5.4 | 0.0 | Fluid pourable suspension. |
| FN5.5 | 2.2 | Fluid pourable suspension. |

The results show that the polymer Polyox® WSR301 (PEG 4 million) can be incorporated into SC recipes at a concentration of 2.2 g/l.

### Spray Droplet Size

The spray droplet size was determined according to Method 2.

TABLE FN5.3
Driftable fraction of spray droplets.

| | | | | | Amount of | Amount of |
|---|---|---|---|---|---|---|
| | | | | | driftable | driftable |
| | | | | | droplet | droplet |
| | | Drift | Drift | | fraction | fraction |
| | | reducing | reducing oil | Spreading | (at % | (at % |
| | | polymer (b) | (c) | agent (d) | vol <100 | vol <150 |
| | Spray | concentration | concentration | concentration | microns) | microns) |
| | volume | in recipe | in recipe | in recipe | from | from |
| Recipe | l/ha | g/l | g/l | g/l | recipe % vol | recipe % vol |
| FN5.1 | 200 | 0.0 | 0.0 | 0.0 | 15.2 | 34.5 |
| | 40 | | | | 14.8 | 33 |
| | 20 | | | | 13.9 | 32.1 |
| | 10 | | | | 15 | 33.3 |
| | 5 | | | | 16 | 25.8 |
| FN5.2 | 200 | 2.2 | 15.0 | 0.0 | 9 | 27 |
| | 40 | | | | 11.9 | 30.7 |
| | 20 | | | | 12.3 | 29.8 |
| | 10 | | | | 9.1 | 27.8 |
| | 5 | | | | 5.8 | 19.6 |
| FN5.3 | 200 | 2.2 | 0.0 | 150.0 | 13.1 | 31.3 |
| | 40 | | | | 12.6 | 31.6 |
| | 20 | | | | 11.5 | 29.6 |
| | 10 | | | | 7.7 | 22.2 |
| | 5 | | | | 5.6 | 17.2 |
| FN5.4 | 200 | 0.0 | 15.0 | 150.0 | 10.6 | 28.2 |
| | 40 | | | | 12.6 | 31.3 |
| | 20 | | | | 15.7 | 35.5 |
| | 10 | | | | 15.1 | 35.7 |
| | 5 | | | | 14.6 | 36.4 |
| FN5.5 | 200 | 2.2 | 15.0 | 150.0 | 8.6 | 26.2 |
| | 40 | | | | 12.2 | 31.9 |
| | 20 | | | | 11.5 | 31.3 |
| | 10 | | | | 8.1 | 25 |
| | 5 | | | | 5.2 | 16.3 |
| FN5.5 | 200 | 0.0 | 0.0 | 150.0 | 13.2 | 32.6 |
| | 40 | | | | 15.6 | 35.7 |
| | 20 | | | | 14.9 | 35.8 |
| | 10 | | | | 16 | 37.5 |
| | 5 | | | | 15.2 | 35.8 |

Formulations sprayed at a dose rate of 0.5 l/ha.

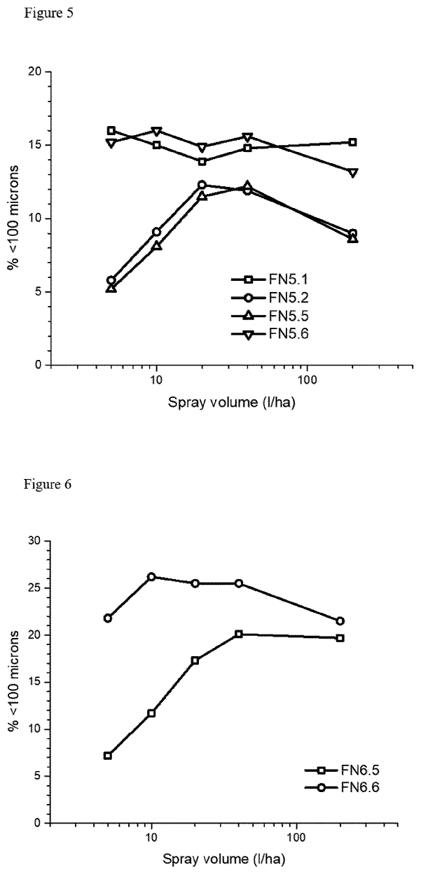

The results show that the combination of polymer Polyox® WSR301 and corn oil can reduce the driftable fraction of spray droplets<100 microns and <150 microns over the spray volume range of to 200 l/ha (see FIG. 5). The amounts of polymer Polyox® WSR30 and oil applied per hectare (ha) are 1 g/ha and 5 g/ha respectively which are remarkably low amounts and well below the typical use rates for these materials. Furthermore, it can be seen that Polyox® WSR301 has a stronger effect than Polyox® WSR N12K (examples FN2 and FN3) indicating that higher molecular weight (molar mass) grades of PEG are more effective at the same use rate, allowing for lower amounts in recipes.

TABLE FN5.4
Concentrations of drift reducing polymer, drift reducing oil and
spreading and uptake promoting agents in the spray dilution.

| | | Drift reducing | Drift reducing | Uptake |
|---|---|---|---|---|
| | | polymer (b) | oil (c) | enhancer (d) |
| | Spray | concentration | concentration | concentration |
| | volume | in spray liquid | in spray liquid | in spray liquid |
| Recipe | l/ha | g/l | g/l | g/l |
| FN5.1 | 200 | 0.0 | 0.0 | 0.0 |
| | 40 | 0.0 | 0.0 | 0.0 |
| | 20 | 0.0 | 0.0 | 0.0 |
| | 10 | 0.0 | 0.0 | 0.0 |
| | 5 | 0.0 | 0.0 | 0.0 |
| FN5.2 | 200 | 0.0055 | 0.0375 | 0.0 |
| | 40 | 0.0275 | 0.1875 | 0.0 |
| | 20 | 0.055 | 0.375 | 0.0 |
| | 10 | 0.11 | 0.75 | 0.0 |
| | 5 | 0.22 | 1.5 | 0.0 |
| FN5.3 | 200 | 0.0055 | 0.0 | 0.375 |
| | 40 | 0.0275 | 0.0 | 1.875 |
| | 20 | 0.055 | 0.0 | 3.75 |
| | 10 | 0.11 | 0.0 | 7.5 |
| | 5 | 0.22 | 0.0 | 15.0 |
| FN5.4 | 200 | 0.0 | 0.0375 | 0.375 |
| | 40 | 0.0 | 0.1875 | 1.875 |
| | 20 | 0.0 | 0.375 | 3.75 |
| | 10 | 0.0 | 0.75 | 7.5 |
| | 5 | 0.0 | 1.5 | 15.0 |
| FN5.5 | 200 | 0.0055 | 0.0375 | 0.375 |
| | 40 | 0.0275 | 0.1875 | 1.875 |
| | 20 | 0.055 | 0.375 | 3.75 |
| | 10 | 0.11 | 0.75 | 7.5 |
| | 5 | 0.22 | 1.5 | 15.0 |
| FN5.6 | 200 | 0.0 | 0.0 | 0.375 |
| | 40 | 0.0 | 0.0 | 1.875 |
| | 20 | 0.0 | 0.0 | 3.75 |
| | 10 | 0.0 | 0.0 | 7.5 |
| | 5 | 0.0 | 0.0 | 15.0 |

Formulations sprayed at a dose rate of 0.5 l/ha.

### Example FN6: Prothioconazole 200 SC

TABLE FN6.1
Recipes FN6.1, FN6.2, FN6.3, FN6.4 and FN6.5.

| | | Recipe | | | Recipe | |
|---|---|---|---|---|---|---|
| | | FN6.2 | Recipe | | FN6.5 | |
| | | containing | FN6.3 | Recipe | containing | |
| | | drift | containing | FN6.4 | drift | |
| | | reducing | drift | containing | reducing | |
| | Recipe | polymer | reducing | drift | polymer | Recipe |
| Component | FN6.1 | (b) and oil | polymer | reducing | (b) and oil | FN6.6 |
| (g/l) | reference | (c) | (b) | oil (c) | (c) | reference |
| Prothioconazole | 200.0 | 200.0 | 200.0 | 200.0 | 200.0 | 200.0 |
| Morwet ® D425 | 5.0 | 5.0 | 5.0 | 5.0 | 5.0 | 5.0 |
| Soprophor ® | 10.0 | 10.0 | 10.0 | 10.0 | 10.0 | 10.0 |
| 4D384 | | | | | | |
| Synperonic ® | 10.0 | 10.0 | 10.0 | 10.0 | 10.0 | 10.0 |
| PE/F127 | | | | | | |
| Polyox ® WSR | 0.0 | 10.0 | 10.0 | 0.0 | 10.0 | 0.0 |
| N12K | | | | | | |
| Crodamol ® IPP | 0.0 | 14.0 | 0.0 | 14.0 | 14.0 | 0.0 |
| Geropon ® DOS | 0.0 | 0.0 | 15.0 | 15.0 | 15.0 | 15.0 |
| PG70 | | | | | | |
| Surfynol ® 440 | 0.0 | 0.0 | 50.0 | 50.0 | 50.0 | 50.0 |
| Xanthan | 3.0 | 3.0 | 3.0 | 3.0 | 3.0 | 3.0 |
| Van Gel ® B | 5.0 | 5.0 | 5.0 | 5.0 | 5.0 | 5.0 |
| Proxel ® GXL | 1.8 | 1.8 | 1.8 | 1.8 | 1.8 | 1.8 |
| Kathon ® CG/ICP | 0.8 | 0.8 | 0.8 | 0.8 | 0.8 | 0.8 |
| Glycerine | 80.0 | 80.0 | 80.0 | 80.0 | 80.0 | 80.0 |
| SAG ® 1572 | 3.0 | 3.0 | 3.0 | 3.0 | 3.0 | 3.0 |
| Na₂HPO₄ (Buffer | 1.5 | 1.5 | 1.5 | 1.5 | 1.5 | 1.5 |
| solution pH = 7) | | | | | | |
| NaH₂PO₄ (Buffer | 0.8 | 0.8 | 0.8 | 0.8 | 0.8 | 0.8 |
| solution pH = 7) | | | | | | |
| Water (add to 1 | To volume | To volume | To volume | To volume | To volume | To volume |
| litre) | (~779) | (~755) | (~704) | (~700) | (~690) | (~714) |

The method of preparation used was according to Method 1.

### Physical Aspect

The physical aspect with regard to viscosity was assessed visually.

TABLE FN6.2
Physical aspect of recipes.

| | Drift reducing | |
|---|---|---|
| | polymer (b) | |
| | concentration | |
| Recipe | in recipe g/l | Physical aspect |
| FN6.1 | 0.0 | Fluid pourable suspension. |
| FN6.2 | 10.0 | Fluid pourable suspension. |
| FN6.3 | 10.0 | Fluid pourable suspension. |
| FN6.4 | 0.0 | Fluid pourable suspension. |
| FN6.5 | 10.0 | Fluid pourable suspension. |

The results show that the polymer Polyox® WSR N12K can be incorporated into SC recipes at a concentration of 10.0 g/L.

### Spray Droplet Size

The spray droplet size was determined according to Method 2.

TABLE FN6.3
Driftable fraction of spray droplets.

| | | | | | Amount of | Amount of |
|---|---|---|---|---|---|---|
| | | | | | driftable | driftable |
| | | | | | droplet | droplet |
| | | Drift | Drift | | fraction | fraction |
| | | reducing | reducing oil | Spreading | (at % | (at % |
| | | polymer (b) | (c) | agent (d) | vol <100 | vol <150 |
| | Spray | concentration | concentration | concentration | microns) | microns) |
| | volume | in recipe | in recipe | in recipe | from | from |
| Recipe | l/ha | g/l | g/l | g/l | recipe % vol | recipe % vol |
| FN6.1 | 200 | 0.0 | 0.0 | 0.0 | 20.2 | 41.9 |
| | 40 | | | | 19.8 | 40.2 |
| | 20 | | | | 19.9 | 40.8 |
| | 10 | | | | 21.4 | 43.2 |
| | 5 | | | | 22.3 | 44.3 |
| FN6.2 | 200 | 10.0 | 14.0 | 0.0 | 11.5 | 30.0 |
| | 40 | | | | 17.1 | 38.7 |
| | 20 | | | | 16.1 | 38.4 |
| | 10 | | | | 15.0 | 37.7 |
| | 5 | | | | 14.9 | 34.7 |
| FN6.3 | 200 | 10.0 | 0.0 | 65.0 | 19.8 | 41.7 |
| | 40 | | | | 21.3 | 45.3 |
| | 20 | | | | 17.9 | 42.4 |
| | 10 | | | | 11.8 | 30.8 |
| | 5 | | | | 6.9 | 18.0 |
| FN6.4 | 200 | 0.0 | 14.0 | 65.0 | 21.6 | 44.2 |
| | 40 | | | | 23.5 | 50.3 |
| | 20 | | | | 24.4 | 52.5 |
| | 10 | | | | 26.2 | 54.5 |
| | 5 | | | | 24.0 | 51.0 |
| FN6.5 | 200 | 10.0 | 14.0 | 65.0 | 19.7 | 43.0 |
| | 40 | | | | 20.1 | 45.6 |
| | 20 | | | | 17.3 | 40.9 |
| | 10 | | | | 11.7 | 28.6 |
| | 5 | | | | 7.2 | 17.2 |
| FN6.6 | 200 | 0.0 | 0.0 | 65.0 | 21.5 | 45.2 |
| | 40 | | | | 25.5 | 51.3 |
| | 20 | | | | 25.5 | 54.4 |
| | 10 | | | | 26.2 | 54.6 |
| | 5 | | | | 21.8 | 45.4 |

Formulations sprayed at a dose rate of 0.5 l/ha.

The results show that the combination of polymer Polyox® WSR N12K and oil Crodamol® IPP can reduce the driftable fraction of spray droplets<100 microns and <150 microns over the spray volume range of 5 to 200 l/ha (see FIG. 6). The amounts of polymer Polyox® WSR N12K and oil applied per hectare (ha) are 5 g/ha and 7 g/ha respectively which are remarkably low amounts and well below the typical use rates for these materials.

TABLE FN6.4
Concentrations of drift reducing polymer, drift reducing oil and
spreading and uptake promoting agents in the spray dilution.

| | | Drift reducing | Drift reducing | Spreading |
|---|---|---|---|---|
| | | polymer (b) | oil (c) | agent (d) |
| | Spray | concentration | concentration | concentration |
| | volume | in spray liquid | in spray liquid | in spray liquid |
| Recipe | l/ha | g/l | g/l | g/l |
| FN6.1 | 200 | 0.0 | 0.0 | 0.0 |
| | 40 | 0.0 | 0.0 | 0.0 |
| | 20 | 0.0 | 0.0 | 0.0 |
| | 10 | 0.0 | 0.0 | 0.0 |
| | 5 | 0.0 | 0.0 | 0.0 |
| FN6.2 | 200 | 0.025 | 0.035 | 0.0 |
| | 40 | 0.125 | 0.175 | 0.0 |
| | 20 | 0.25 | 0.35 | 0.0 |
| | 10 | 0.5 | 0.7 | 0.0 |
| | 5 | 1.0 | 1.4 | 0.0 |
| FN6.3 | 200 | 0.025 | 0.0 | 0.1625 |
| | 40 | 0.125 | 0.0 | 0.8125 |
| | 20 | 0.25 | 0.0 | 1.625 |
| | 10 | 0.5 | 0.0 | 3.25 |
| | 5 | 1.0 | 0.0 | 6.5 |
| FN6.4 | 200 | 0.0 | 0.035 | 0.1625 |
| | 40 | 0.0 | 0.175 | 0.8125 |
| | 20 | 0.0 | 0.35 | 1.625 |
| | 10 | 0.0 | 0.7 | 3.25 |
| | 5 | 0.0 | 1.4 | 6.5 |
| FN6.5 | 200 | 0.025 | 0.035 | 0.1625 |
| | 40 | 0.125 | 0.175 | 0.8125 |
| | 20 | 0.25 | 0.35 | 1.625 |
| | 10 | 0.5 | 0.7 | 3.25 |
| | 5 | 1.0 | 1.4 | 6.5 |
| FN6.6 | 200 | 0.0 | 0.0 | 0.1625 |
| | 40 | 0.0 | 0.0 | 0.8125 |
| | 20 | 0.0 | 0.0 | 1.625 |
| | 10 | 0.0 | 0.0 | 3.25 |
| | 5 | 0.0 | 0.0 | 6.5 |

Formulations sprayed at a dose rate of 0.5 l/ha.

### Example Polymers 1

TABLE P1.1
Spray droplet size for aqueous polymer solutions

| | | Amount of | Amount of | | |
|---|---|---|---|---|---|
| | | driftable | driftable | % reduction | % reduction |
| | | droplet | droplet | of driftable | of driftable |
| | | fraction | fraction | droplet | droplet |
| | | (at % vol < | (at % vol < | fraction | fraction |
| | Concentration | 100 microns) | 150 microns) | (at % vol < | (at % vol < |
| Polymer | g/l | % vol | % vol | 100 microns) | 150 microns) |
| Water (reference) | — | 12.7 | 30.0 | — | — |
| Gum Arabic | 2 | 15 | 34 | −18.1 | −13.4 |
| Gum Arabic | 0.5 | 12.2 | 28.9 | 3.9 | 3.6 |
| Dextran | 2 | 13.8 | 32.3 | −8.7 | −7.8 |
| Dextran | 0.5 | 13.5 | 32 | −6.3 | −6.8 |
| k-Carrageenan | 2 | 8.9 | 23.6 | 29.9 | 21.3 |
| k-Carrageenan | 1 | 11.3 | 29 | 11.0 | 3.2 |
| k-Carrageenan | 0.5 | 11.1 | 28.2 | 12.6 | 5.9 |
| Polyox ® WSR 301 | 1 | 0.5 | 1.3 | 96.1 | 95.7 |
| (PEO 4mio) | | | | | |
| Polyox ® WSR 301 | 0.25 | 1.9 | 6.1 | 85.0 | 79.6 |
| (PEO 4mio) | | | | | |
| Polyox ® WSR | 1 | 1.4 | 4.7 | 89.0 | 84.3 |
| N12K (PEO Imio) | | | | | |
| Polyox ® WSR | 0.25 | 2.1 | 8.1 | 83.5 | 73.0 |
| N12K (PEO 1mio) | | | | | |
| AgRho ® DR2000 | 0.5 | 7.00 | 19.2 | 44.9 | 35.9 |
| (HP Guar) | | | | | |
| AgRho ® DR2000 | 0.25 | 10.7 | 27 | 15.7 | 9.9 |
| (HP Guar) | | | | | |
| Rhodopol ® 23 | 1 | 8.6 | 23.7 | 32.3 | 20.9 |
| (xanthan) | | | | | |
| Rhodopol ® 23 | 0.25 | 11.9 | 28.3 | 6.3 | 5.6 |
| (xanthan) | | | | | |
| Natrosol ® 250 | 1 | 14.4 | 32.3 | −13.4 | −7.8 |
| HHX (HEC | | | | | |
| 1.3mio) | | | | | |
| Tylose ® MH50 | 1 | 13.1 | 31.3 | −3.1 | −4.4 |
| (MHEC) | | | | | |

Measurement by Method 2.

These results show that many high molecular weight (molar mass) polymers have little or no effect on reducing the driftable fraction of spray droplets. However, the effect of poly(ethylene oxide) (PEG) is clearly visible and shows the strongest effect here. The AgRho® DR2000 (HP Guar) also stands out as being effective in reducing the driftable fraction of spray droplets.

For k-carrageenan and xanthan polymers a limited reduction in the driftable fraction of spray droplets is observed. However, the amount of polymer required in the formulation to achieve a significant reduction in the driftable fraction of spray droplets is very high with the result that with such an amount the formulation is too viscous to be poured from its bottle and dispersed in the spray liquid. Furthermore, although xanthan (Rhodopol® 23) is commonly used in SC formulations, the amount used is typically 2 to 3.5 g/l which is sufficiently low that the concentration in the spray liquid is not sufficient to significantly reduce the driftable droplet fraction as shown in table P1.1.

### Example Polymers 2

TABLE P2.1
Spray droplet size for aqueous polymer solutions of PEO.

| | | | Amount of | Amount of | |
|---|---|---|---|---|---|
| | | | driftable | driftable | |
| | | | droplet | droplet | |
| | | | fraction | fraction | |
| | Concen- | Crovol | (at % vol < | (at % vol < | |
| | tration | CR70G | 100 microns) | 150 microns) | |
| Polymer | g/l | g/l | % vol | % vol | PCF |
| Water | — | — | 20.8 | 42.6 | — |
| (reference) | | | | | |
| Crovol CR70G | — | 5.0 | 19.6 | 48.1 | — |
| 5 g/l | | | | | |
| Polyox WSR | 0.2 | 0.0 | 3.3 | 7.7 | 13.93 |
| 301 (4mio) | | | | | |
| Polyox WSR | 0.1 | 0.0 | 4.8 | 11.8 | 6.96 |
| 301 (4mio) | | | | | |
| Polyox WSR | 0.05 | 0.0 | 7.5 | 18 | 3.48 |
| 301 (4mio) | | | | | |
| Polyox WSR | 0.025 | 0.0 | 12.6 | 26.7 | 1.74 |
| 301 (4mio) | | | | | |
| Polyox WSR | 0.01 | 0.0 | 16.8 | 36.1 | 0.70 |
| 301 (4mio) | | | | | |
| Polyox WSR | 0.4 | 0.0 | 3.7 | 9.4 | 10.56 |
| N60K (2mio) | | | | | |
| Polyox WSR | 0.2 | 0.0 | 4.5 | 11.9 | 5.28 |
| N60K (2mio) | | | | | |
| Polyox WSR | 0.1 | 0.0 | 8.7 | 20 | 2.64 |
| N60K (2mio) | | | | | |
| Polyox WSR | 0.05 | 0.0 | 13.4 | 29.7 | 1.32 |
| N60K (2mio) | | | | | |
| Polyox WSR | 0.02 | 0.0 | 16.5 | 35.8 | 0.53 |
| N60K (2mio) | | | | | |
| Polyox WSR | 0.8 | 0.0 | 3.1 | 8 | 8.00 |
| N12K (1mio) | | | | | |
| Polyox WSR | 0.4 | 0.0 | 5.5 | 15.1 | 4.00 |
| N12K (1mio) | | | | | |
| Polyox WSR | 0.2 | 0.0 | 10.4 | 24.6 | 2.00 |
| N12K (1mio) | | | | | |
| Polyox WSR | 0.1 | 0.0 | 16.1 | 35.1 | 1.00 |
| N12K (1mio) | | | | | |
| Polyox WSR | 0.04 | 0.0 | 18 | 38.4 | 0.40 |
| N12K (1mio) | | | | | |
| Polyox WSR | 0.2 | 5.0 | 3.3 | 8.4 | 13.93 |
| 301 (4mio) | | | | | |
| Polyox WSR | 0.1 | 5.0 | 5 | 13.3 | 6.96 |
| 301 (4mio) | | | | | |
| Polyox WSR | 0.05 | 5.0 | 6.3 | 16.1 | 3.48 |
| 301 (4mio) | | | | | |
| Polyox WSR | 0.025 | 5.0 | 9.3 | 23.6 | 1.74 |
| 301 (4mio) | | | | | |
| Polyox WSR | 0.01 | 5.0 | 13.3 | 33.1 | 0.70 |
| 301 (4mio) | | | | | |
| Polyox WSR | 0.4 | 5.0 | 3.4 | 9.2 | 10.56 |
| N60K (2mio) | | | | | |
| Polyox WSR | 0.2 | 5.0 | 4.7 | 13.1 | 5.28 |
| N60K (2mio) | | | | | |
| Polyox WSR | 0.1 | 5.0 | 7.2 | 18.6 | 2.64 |
| N60K (2mio) | | | | | |
| Polyox WSR | 0.05 | 5.0 | 11.1 | 27.9 | 1.32 |
| N60K (2mio) | | | | | |
| Polyox WSR | 0.02 | 5.0 | 17.2 | 40.1 | 0.53 |
| N60K (2mio) | | | | | |
| Polyox WSR | 0.8 | 5.0 | 3.1 | 9.1 | 8.00 |
| N12K (1mio) | | | | | |
| Polyox WSR | 0.4 | 5.0 | 6.1 | 16.7 | 4.00 |
| N12K (1mio) | | | | | |
| Polyox WSR | 0.2 | 5.0 | 9.6 | 24.9 | 2.00 |
| N12K (1mio) | | | | | |
| Polyox WSR | 0.1 | 5.0 | 15.1 | 36.2 | 1.00 |
| N12K (1mio) | | | | | |
| Polyox WSR | 0.04 | 5.0 | 17.3 | 41.8 | 0.40 |
| N12K (1mio) | | | | | |

Measurement by Method 2. Dose rate of the polymer for PCF calculation: 0.5 l/ha.

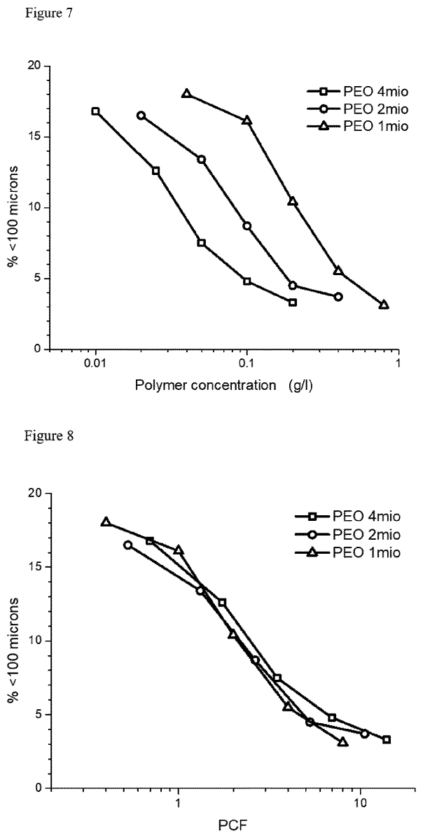

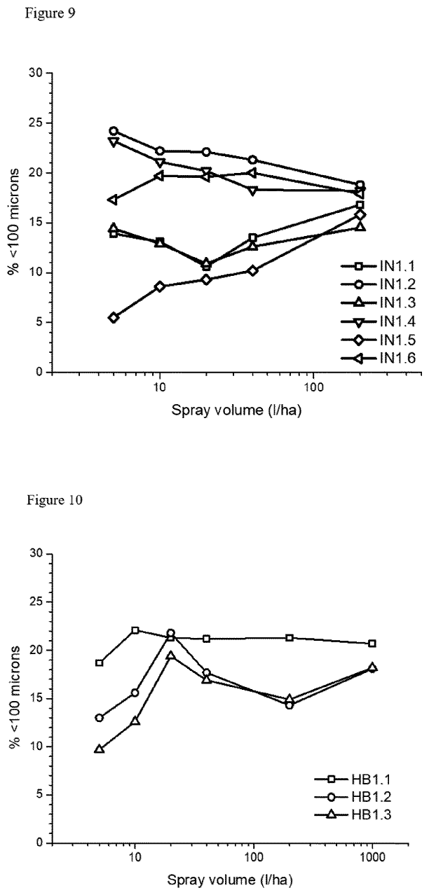

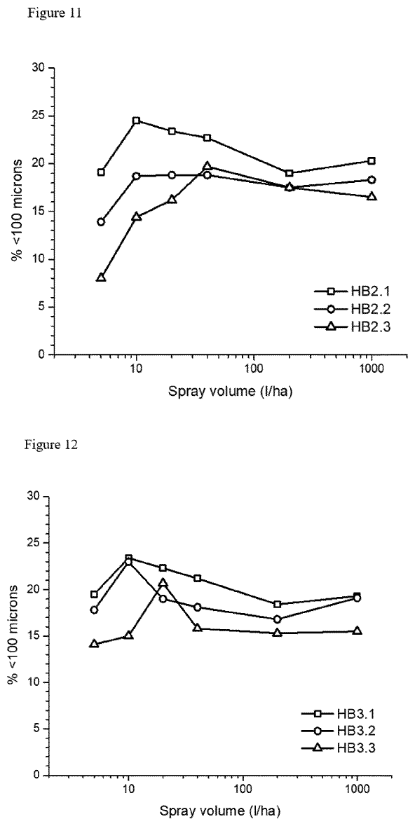

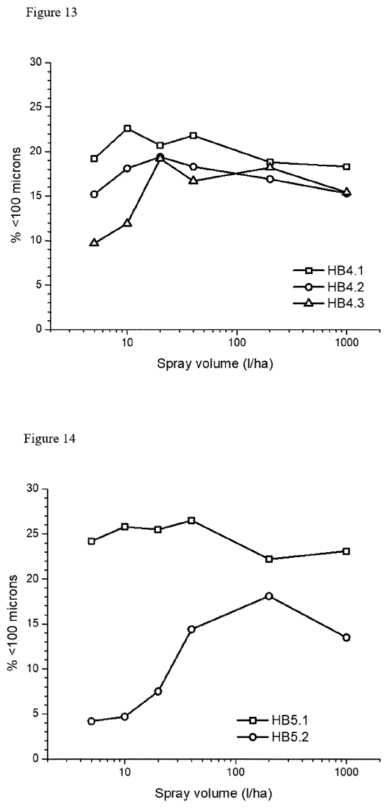

The results in Table P2.1 show that the molar mass (molecular weight) of the PE Polyox polymer has a large effect on the driftable droplet fraction with the 4 million molar mass PEG having a much stronger effect than the 2 million molar mass PEG, which in turn has a stronger effect than the 1 million molar mass PEG. This is plotted in FIG. 7.

To account for this effect a Polymer Concentration Factor (PCF) for the PEG polymer content in the formulation is defined where C is the drift reducing polymer (b) concentration in the formulation (g/l), M is the molar mass of the drift reducing polymer (b) (g/mol/1×10⁶), a has a value of 1.4 and D is the SC (or formulation) dose rate per ha (l/ha). The PCF value is calculated from the following equation:

$$P C F = C \times {M}^{a} \times D$$

PCF values of recipes used in the examples are listed in Table P2.2 and span a range of approximately 2 to 9. The correlation between PCF value and driftable fraction of spray droplets is plotted in FIG. 8 and shows that higher PCF values correspond to lower fractions of driftable spray droplets. These results demonstrate that the preferred range of PCF values is from about 2 to about 10. Furthermore, PCF values allow for the polymer content of other molar mass grades of PEG for example down to 0.5 million g/mol and up to 10 million g/mol, and also intermediate molar mass grades such as 1.5 million and 3 million g/mol.

TABLE P2.2
PCF values for recipe examples

| | | | Polymer | SC dose |
|---|---|---|---|---|
| | | Concentration | molar mass | rate |
| Recipe examples | PCF | g/L | g/mol/1 × 10⁶ | l/ha |
| FN2.2, FN2.3, FN2.5 | 7.0 | 2 | 4 | 0.5 |
| FN3.2, FN3.3, FN3.5 | 2.6 | 2 | 2 | 0.5 |
| FN4.2, FN4.3, FN4.5 | 2.6 | 2 | 2 | 0.5 |
| FN5.2, FN5.3, FN5.5 | 7.7 | 2.2 | 4 | 0.5 |
| FN6.2, FN6.3, FN6.5 | 5.0 | 10 | 1 | 0.5 |
| IN1.1, IN1.3, IN1.5 | 8.4 | 2.4 | 4 | 0.5 |
| HB1.2, HB2.2, HB3.2, | 7.0 | 1 | 4 | 1 |
| HB4.2 | | | | |
| HB1.3, HB2.3, HB3.3, | 5.3 | 2 | 2 | 1 |
| HB4.3 | | | | |
| HB5.2 | 7.9 | 1.5 | 2 | 2 |

### Insecticides

### Example IN1: Deltamethrin 200 SC, Spirotetramat 200 SC and Ethiprole 200 SC

TABLE IN1.1
Recipes IN1.1, IN1.2, IN1.3, IN1.4, IN1.5 and IN1.6.

| | Recipe | | Recipe | | Recipe | |
|---|---|---|---|---|---|---|
| | IN1.1 | | IN1.3 | | IN1.5 | |
| | containing | | containing | | containing | |
| | drift | | drift | | drift | |
| | reducing | | reducing | | reducing | |
| | polymer | Recipe | polymer | Recipe | polymer | Recipe |
| Component | (b) and oil | IN1.2 | (b) and oil | IN1.4 | (b) and oil | IN1.6 |
| (g/l) | (c) | reference | (c) | reference | (c) | reference |
| Deltamethrin | 200.0 | 200.0 | 0.0 | 0.0 | 0.0 | 0.0 |
| Spirotetramat | 0.0 | 0.0 | 200.0 | 200.0 | 0.0 | 0.0 |
| Ethiprole | 0.0 | 0.0 | 0.0 | 0.0 | 200.0 | 200.0 |
| Morwet ® D425 | 4.0 | 4.0 | 4.0 | 4.0 | 4.0 | 4.0 |
| Soprophor ® | 10.0 | 10.0 | 10.0 | 10.0 | 10.0 | 10.0 |
| FLK | | | | | | |
| Synperonic ® | 12.0 | 12.0 | 12.0 | 12.0 | 12.0 | 12.0 |
| PE/F127 | | | | | | |
| Polyox ® WSR | 2.4 | 0.0 | 2.4 | 0.0 | 2.4 | 0.0 |
| 301 | | | | | | |
| Rapeseed oil | 20.0 | 0.0 | 20.0 | 0.0 | 20.0 | 0.0 |
| Silwet ® 408 | 40.0 | 40.0 | 40.0 | 40.0 | 40.0 | 40.0 |
| Crovol ® | 100.0 | 100.0 | 100.0 | 100.0 | 100.0 | 100.0 |
| CR70G | | | | | | |
| Xanthan | 3.6 | 3.6 | 3.6 | 3.6 | 3.6 | 3.6 |
| Proxel ® GXL | 1.8 | 1.8 | 1.8 | 1.8 | 1.8 | 1.8 |
| Kathon ® | 0.8 | 0.8 | 0.8 | 0.8 | 0.8 | 0.8 |
| CG/ICP | | | | | | |
| Glycerine | 80.0 | 80.0 | 80.0 | 80.0 | 80.0 | 80.0 |
| SAG ® 1572 | 3.0 | 3.0 | 3.0 | 3.0 | 3.0 | 3.0 |
| Na₂HPO₄ | 1.5 | 1.5 | 1.5 | 1.5 | 1.5 | 1.5 |
| (Buffer solution | | | | | | |
| pH = 7) | | | | | | |
| NaH₂PO₄ | 0.8 | 0.8 | 0.8 | 0.8 | 0.8 | 0.8 |
| (Buffer solution | | | | | | |
| pH = 7) | | | | | | |
| Water (add to 1 | To volume | To volume | To volume | To volume | To volume | To volume |
| litre) | (~620) | (~742) | (~620) | (~742) | (~620) | (~742) |

The method of preparation used was according to Method 1.

### Physical Aspect

The physical aspect with regard to viscosity was assessed visually.

TABLE IN1.2
Physical aspect of recipes.

| | Drift reducing | |
|---|---|---|
| | polymer (b) | |
| | concentration | |
| Recipe | in recipe g/l | Physical aspect |
| IN1.1 | 2.4 | Fluid pourable suspension. |
| IN1.2 | 0.0 | Fluid pourable suspension. |
| IN1.3 | 2.4 | Fluid pourable suspension. |
| IN1.4 | 0.0 | Fluid pourable suspension. |
| IN1.5 | 2.4 | Fluid pourable suspension. |
| IN1.6 | 0.0 | Fluid pourable suspension. |

The results show that the polymer Polyox® WSR 301 can be incorporated into SC recipes at a concentration of 2.4 g/L.

### Spray Droplet Size

The spray droplet size was determined according to Method 2.

TABLE IN1.3
Driftable fraction of spray droplets.

| | | | | | Amount of | Amount of |
|---|---|---|---|---|---|---|
| | | | | | driftable | driftable |
| | | | | Spreading | droplet | droplet |
| | | Drift | Drift | and uptake | fraction | fraction |
| | | reducing | reducing oil | promoting | (at % | (at % |
| | | polymer (b) | (c) | agent (d) | vol <100 | vol <150 |
| | Spray | concentration | concentration | concentration | microns) | microns) |
| | volume | in recipe | in recipe | in recipe | from | from |
| Recipe | l/ha | g/l | g/l | g/l | recipe % vol | recipe % vol |
| IN1.1 | 200 | 2.4 | 20.0 | 140.0 | 16.8 | 37.7 |
| | 40 | | | | 13.5 | 32.4 |
| | 20 | | | | 10.6 | 24.9 |
| | 10 | | | | 13.1 | 27.4 |
| | 5 | | | | 13.9 | 22.8 |
| IN1.2 | 200 | 0.0 | 0.0 | 140.0 | 18.8 | 40.8 |
| | 40 | | | | 21.3 | 43.3 |
| | 20 | | | | 22.1 | 46.8 |
| | 10 | | | | 22.2 | 47.5 |
| | 5 | | | | 24.2 | 50.1 |
| IN1.3 | 200 | 2.4 | 20.0 | 140.0 | 14.5 | 32.4 |
| | 40 | | | | 12.6 | 30.1 |
| | 20 | | | | 10.9 | 25.7 |
| | 10 | | | | 12.9 | 26.9 |
| | 5 | | | | 14.4 | 25.7 |
| IN1.4 | 200 | 0.0 | 0.0 | 140.0 | 18.2 | 40.2 |
| | 40 | | | | 18.3 | 40.8 |
| | 20 | | | | 20.2 | 44.0 |
| | 10 | | | | 21.1 | 45.3 |
| | 5 | | | | 23.2 | 46.6 |
| IN1.5 | 200 | 2.4 | 20.0 | 140.0 | 15.8 | 34.4 |
| | 40 | | | | 10.2 | 25.9 |
| | 20 | | | | 9.3 | 22.8 |
| | 10 | | | | 8.6 | 20.3 |
| | 5 | | | | 5.5 | 13.2 |
| IN1.6 | 200 | 0.0 | 0.0 | 140.0 | 17.9 | 40.6 |
| | 40 | | | | 20.0 | 39.1 |
| | 20 | | | | 19.6 | 41.6 |
| | 10 | | | | 19.7 | 41.5 |
| | 5 | | | | 17.3 | 41.9 |

Formulations sprayed at a dose rate of 0.5 l/ha.

The results show that the combination of polymer Polyox® WSR 301 and rapeseed oil can reduce the driftable fraction of spray droplets<100 microns and <150 microns over the spray volume range of to 200 l/ha (see FIG. 5). The amounts of polymer Polyox® WSR31 and oil applied per hectare (ha) are 1.2 g/ha and 10 g/ha respectively which are remarkably low amounts and well below the typical use rates for these materials. Furthermore, it can be seen that similar results are obtained with the same recipe containing a range of active ingredients.

TABLE IN1.4
Concentrations of drift reducing polymer, drift reducing oil and
spreading and uptake promoting agents in the spray dilution.

| | | | | Spreading |
|---|---|---|---|---|
| | | | | and uptake |
| | | Drift reducing | Drift reducing | promoting |
| | | polymer (b) | oil (c) | agent (d) |
| | Spray | concentration | concentration | concentration |
| | volume | in spray liquid | in spray liquid | in spray liquid |
| Recipe | l/ha | g/l | g/l | g/l |
| IN1.1 | 200 | 0.006 | 0.05 | 0.35 |
| | 40 | 0.03 | 0.25 | 1.75 |
| | 20 | 0.06 | 0.5 | 3.5 |
| | 10 | 0.12 | 1.0 | 7.0 |
| | 5 | 0.24 | 2.0 | 14.0 |
| IN1.2 | 200 | 0.0 | 0.0 | 0.35 |
| | 40 | 0.0 | 0.0 | 1.75 |
| | 20 | 0.0 | 0.0 | 3.5 |
| | 10 | 0.0 | 0.0 | 7.0 |
| | 5 | 0.0 | 0.0 | 14.0 |
| IN1.3 | 200 | 0.006 | 0.05 | 0.35 |
| | 40 | 0.03 | 0.25 | 1.75 |
| | 20 | 0.06 | 0.5 | 3.5 |
| | 10 | 0.12 | 1.0 | 7.0 |
| | 5 | 0.24 | 2.0 | 14.0 |
| IN1.4 | 200 | 0.0 | 0.0 | 0.35 |
| | 40 | 0.0 | 0.0 | 1.75 |
| | 20 | 0.0 | 0.0 | 3.5 |
| | 10 | 0.0 | 0.0 | 7.0 |
| | 5 | 0.0 | 0.0 | 14.0 |
| IN1.5 | 200 | 0.006 | 0.05 | 0.35 |
| | 40 | 0.03 | 0.25 | 1.75 |
| | 20 | 0.06 | 0.5 | 3.5 |
| | 10 | 0.12 | 1.0 | 7.0 |
| | 5 | 0.24 | 2.0 | 14.0 |
| IN1.6 | 200 | 0.0 | 0.0 | 0.35 |
| | 40 | 0.0 | 0.0 | 1.75 |
| | 20 | 0.0 | 0.0 | 3.5 |
| | 10 | 0.0 | 0.0 | 7.0 |
| | 5 | 0.0 | 0.0 | 14.0 |

Formulations sprayed at a dose rate of 0.5 l/ha.

### Herbicides

### Example HB1: Ethofumesate SC 50

TABLE HB1.1
Recipes HB1.1, HB1.2 and HB1.3

| | | Recipe HB1.2 | Recipe HB1.3 |
|---|---|---|---|
| | | containing | containing |
| | | drift | drift |
| | Recipe | reducing | reducing |
| Component | HB1.1 | polymer (b) | polymer (b) |
| (g/l) | reference | and oil (c) | and oil (c) |
| A.I. | 50.0 | 50.0 | 50.0 |
| Ethofumesate | | | |
| Morwet ® | 6.0 | 6.0 | 6.0 |
| D425 | | | |
| Atlox ® 4913 | 20.0 | 20.0 | 20.0 |
| Synperonic ® | 12.5 | 12.5 | 12.5 |
| PE/F127 | | | |
| Polyox ® | 0.0 | 1.0 | 0.0 |
| WSR301 | | | |
| (PEO 4mio) | | | |
| Polyox ® | 0.0 | 0.0 | 2.0 |
| WSR N60K | | | |
| (PEO 2mio) | | | |
| Rapeseed oil | 0.0 | 12.0 | 12.0 |
| methylester | | | |
| Silwet ® 408 | 20.0 | 20.0 | 20.0 |
| Genapol ® C | 60.0 | 60.0 | 60.0 |
| 100 | | | |
| Xanthan | 3.1 | 3.1 | 3.1 |
| Van Gel ® B | 5.0 | 5.0 | 5.0 |
| Proxel ® | 1.8 | 1.8 | 1.8 |
| GXL | | | |
| Kathon ® | 0.8 | 0.8 | 0.8 |
| CG/ICP | | | |
| Glycerine | 80.0 | 80.0 | 80.0 |
| SAG ® 1572 | 3.6 | 3.6 | 3.6 |
| Na₂HPO₄ | 1.5 | 1.5 | 1.5 |
| (Buffer | | | |
| solution | | | |
| pH = 7) | | | |
| NaH₂PO₄ | 0.8 | 0.8 | 0.8 |
| (Buffer | | | |
| solution | | | |
| pH = 7) | | | |
| Water | To volume | To volume | To volume |
| (add to | (~854) | (~841) | (~840) |
| 1 litre) | | | |

The method of preparation used was according to Method 1.

### Physical Aspect

The physical aspect with regard to viscosity was assessed visually.

TABLE HB1.2
Physical aspect of recipes.

| | Drift reducing | |
|---|---|---|
| | polymer (b) | |
| | concentration | |
| Recipe | in recipe g/l | Physical aspect |
| HB1.1 | 0.0 | Fluid pourable suspension. |
| HB1.2 | 1.0 | Fluid pourable suspension. |
| HB1.3 | 2.0 | Fluid pourable suspension. |

### Spray Droplet Size

The spray droplet size was determined according to Method 2.

TABLE HB1.3
Driftable fraction of spray droplets.

| | | | | | Amount of | Amount of |
|---|---|---|---|---|---|---|
| | | | | | driftable | driftable |
| | | | | Spreading | droplet | droplet |
| | | Drift | Drift | and uptake | fraction | fraction |
| | | reducing | reducing oil | promoting | (at % | (at % |
| | | polymer (b) | (c) | agent (d) | vol <100 | vol <150 |
| | Spray | concentration | concentration | concentration | microns) | microns) |
| | volume | in recipe | in recipe | in recipe | from | from |
| Recipe | l/ha | g/l | g/l | g/l | recipe % vol | recipe % vol |
| HB1.1 | 1000 | 0.0 | 0.0 | 80.0 | 19.3 | 39.5 |
| | 200 | | | | 18.4 | 38.0 |
| | 40 | | | | 21.2 | 43.1 |
| | 20 | | | | 22.3 | 46.5 |
| | 10 | | | | 23.4 | 47.5 |
| | 5 | | | | 19.5 | 43.3 |
| HB1.2 | 1000 | 1.0 | 12.0 | 80.0 | 19.1 | 38.5 |
| | 200 | | | | 16.8 | 36.1 |
| | 40 | | | | 18.1 | 39.3 |
| | 20 | | | | 19.0 | 44.3 |
| | 10 | | | | 23.0 | 48.3 |
| | 5 | | | | 17.8 | 43.4 |
| HB1.3 | 1000 | 2.0 | 12.0 | 80.0 | 15.5 | 37.7 |
| | 200 | | | | 15.3 | 38.5 |
| | 40 | | | | 15.8 | 39.6 |
| | 20 | | | | 20.7 | 48.0 |
| | 10 | | | | 15.0 | 40.9 |
| | 5 | | | | 14.1 | 34.5 |

Formulations sprayed at a dose rate of 1 l/ha.

The results show that the combination of polymer Polyox® WSR N60K or Polyox® WSR 301 and methylated rapeseed oil can reduce the driftable fraction of spray droplets<100 microns and <150 microns over the spray volume range of 5 to 1000 l/ha.

TABLE HB1.4
Concentrations of drift reducing polymer, drift reducing oil and
spreading and uptake promoting agents in the spray dilution.

| | | | | Spreading and |
|---|---|---|---|---|
| | | Drift reducing | Drift reducing | uptake promoting |
| | | polymer (b) | oil (c) | agent (d) |
| | Spray | concentration | concentration | concentration |
| | volume | in spray liquid | in spray liquid | in spray liquid |
| Recipe | l/ha | g/l | g/l | g/l |
| HB1.1 | 1000 | 0.0 | 0.0 | 0.08 |
| | 200 | 0.0 | 0.0 | 0.4 |
| | 40 | 0.0 | 0.0 | 2.0 |
| | 20 | 0.0 | 0.0 | 4.0 |
| | 10 | 0.0 | 0.0 | 8.0 |
| | 5 | 0.0 | 0.0 | 16.0 |
| HB1.2 | 1000 | 0.001 | 0.012 | 0.08 |
| | 200 | 0.005 | 0.06 | 0.4 |
| | 40 | 0.025 | 0.3 | 2.0 |
| | 20 | 0.05 | 0.6 | 4.0 |
| | 10 | 0.1 | 1.2 | 8.0 |
| | 5 | 0.2 | 2.4 | 16.0 |
| HB1.3 | 1000 | 0.002 | 0.012 | 0.08 |
| | 200 | 0.01 | 0.06 | 0.4 |
| | 40 | 0.05 | 0.3 | 2.0 |
| | 20 | 0.1 | 0.6 | 4.0 |
| | 10 | 0.2 | 1.2 | 8.0 |
| | 5 | 0.4 | 2.4 | 16.0 |

Formulations sprayed at a dose rate of 1 l/ha.

### Example HB2: Tembotrione SC 50

TABLE HB2.1
Recipes HB2.1, HB2.2 and HB2.3

| | | Recipe HB1.2 | Recipe HB1.3 |
|---|---|---|---|
| | | containing | containing |
| | | drift | drift |
| | Recipe | reducing | reducing |
| Component | HB1.1 | polymer (b) | polymer (b) |
| (g/l) | reference | and oil (c) | and oil (c) |
| A.I. | 50.0 | 50.0 | 50.0 |
| Tembotrione | | | |
| Morwet ® | 6.0 | 6.0 | 6.0 |
| D425 | | | |
| Atlox ® 4913 | 20.0 | 20.0 | 20.0 |
| Synperonic ® | 12.5 | 12.5 | 12.5 |
| PE/F127 | | | |
| Polyox ® | 0.0 | 1.0 | 0.0 |
| WSR301 | | | |
| (PEO 4mio) | | | |
| Polyox ® | 0.0 | 0.0 | 2.0 |
| WSR N60K | | | |
| (PEO 2mio) | | | |
| Rapeseed oil | 0.0 | 12.0 | 12.0 |
| methylester | | | |
| Silwet ® 408 | 20.0 | 20.0 | 20.0 |
| Genapol C | 60.0 | 60.0 | 60.0 |
| 100 | | | |
| Xanthan | 3.1 | 3.1 | 3.1 |
| Van Gel ® B | 5.0 | 5.0 | 5.0 |
| Proxel ® | 1.8 | 1.8 | 1.8 |
| GXL | | | |
| Kathon ® | 0.8 | 0.8 | 0.8 |
| CG/ICP | | | |
| Glycerine | 80.0 | 80.0 | 80.0 |
| SAG ® 1572 | 3.6 | 3.6 | 3.6 |
| Na₂HPO₄ | 1.5 | 1.5 | 1.5 |
| (Buffer | | | |
| solution | | | |
| pH = 7) | | | |
| NaH₂PO₄ | 0.8 | 0.8 | 0.8 |
| (Buffer | | | |
| solution | | | |
| pH = 7) | | | |
| Water (add | To volume | To volume | To volume |
| to 1 litre) | (~854) | (~841) | (~840) |

The method of preparation used was according to Method 1.

### Physical Aspect

The physical aspect with regard to viscosity was assessed visually.

TABLE HB2.2
Physical aspect of recipes.

| | Drift reducing | |
|---|---|---|
| | polymer (b) | |
| | concentration | |
| Recipe | in recipe g/l | Physical aspect |
| HB2.1 | 0.0 | Fluid pourable suspension. |
| HB2.2 | 1.0 | Fluid pourable suspension. |
| HB2.3 | 2.0 | Fluid pourable suspension. |

### Spray Droplet Size

The spray droplet size was determined according to Method 2.

TABLE HB2.3
Driftable fraction of spray droplets.

| | | | | | Amount of | Amount of |
|---|---|---|---|---|---|---|
| | | | | | driftable | driftable |
| | | | | Spreading | droplet | droplet |
| | | Drift | Drift | and uptake | fraction | fraction |
| | | reducing | reducing oil | promoting | (at % | (at % |
| | | polymer (b) | (c) | agent (d) | vol <100 | vol <150) |
| | Spray | concentration | concentration | concentration | microns) | microns |
| | volume | in recipe | in recipe | in recipe | from | from |
| Recipe | l/ha | g/l | g/l | g/l | recipe % vol | recipe % vol |
| HB2.1 | 1000 | 0.0 | 0.0 | 80.0 | 20.3 | 41.6 |
| | 200 | | | | 19.0 | 42.7 |
| | 40 | | | | 22.7 | 46.3 |
| | 20 | | | | 23.4 | 48.4 |
| | 10 | | | | 24.5 | 50.8 |
| | 5 | | | | 19.1 | 44.4 |
| HB2.2 | 1000 | 1.0 | 12.0 | 80.0 | 18.3 | 41.1 |
| | 200 | | | | 17.5 | 40.0 |
| | 40 | | | | 18.8 | 42.5 |
| | 20 | | | | 18.8 | 45.2 |
| | 10 | | | | 18.7 | 44.0 |
| | 5 | | | | 13.9 | 39.2 |
| HB2.3 | 1000 | 2.0 | 12.0 | 80.0 | 16.5 | 38.7 |
| | 200 | | | | 17.5 | 40.0 |
| | 40 | | | | 19.7 | 44.0 |
| | 20 | | | | 16.2 | 45.1 |
| | 10 | | | | 14.4 | 36.3 |
| | 5 | | | | 8.0 | 24.8 |

Formulations sprayed at a dose rate of 1 l/ha.

The results show that the combination of polymer Polyox® WSR N60K or Polyox® WSR 301 and methylated rapeseed oil can reduce the driftable fraction of spray droplets<100 microns and <150 microns over the spray volume range of 5 to 1000 l/ha.

TABLE HB2.4
Concentrations of drift reducing polymer, drift reducing oil and
spreading and uptake promoting agents in the spray dilution.

| | | | | Spreading and |
|---|---|---|---|---|
| | | Drift reducing | Drift reducing | uptake promoting |
| | | polymer (b) | oil (c) | agent (d) |
| | Spray | concentration | concentration | concentration |
| | volume | in spray liquid | in spray liquid | in spray liquid |
| Recipe | l/ha | g/l | g/l | g/l |
| HB2.1 | 1000 | 0.0 | 0.0 | 0.08 |
| | 200 | 0.0 | 0.0 | 0.4 |
| | 40 | 0.0 | 0.0 | 2.0 |
| | 20 | 0.0 | 0.0 | 4.0 |
| | 10 | 0.0 | 0.0 | 8.0 |
| | 5 | 0.0 | 0.0 | 16.0 |
| HB2.2 | 1000 | 0.001 | 0.012 | 0.08 |
| | 200 | 0.005 | 0.06 | 0.4 |
| | 40 | 0.025 | 0.3 | 2.0 |
| | 20 | 0.05 | 0.6 | 4.0 |
| | 10 | 0.1 | 1.2 | 8.0 |
| | 5 | 0.2 | 2.4 | 16.0 |
| HB2.3 | 1000 | 0.002 | 0.012 | 0.08 |
| | 200 | 0.01 | 0.06 | 0.4 |
| | 40 | 0.05 | 0.3 | 2.0 |
| | 20 | 0.1 | 0.6 | 4.0 |
| | 10 | 0.2 | 1.2 | 8.0 |
| | 5 | 0.4 | 2.4 | 16.0 |

Formulations sprayed at a dose rate of 1 l/ha.

### Example HB3: Triafamone SC 50

TABLE HB3.1
Recipes HB3.1, HB3.2 and HB3.3

| | | Recipe HB1.2 | Recipe HB1.3 |
|---|---|---|---|
| | | containing | containing |
| | | drift | drift |
| | Recipe | reducing | reducing |
| Component | HB1.1 | polymer (b) | polymer (b) |
| (g/l) | reference | and oil (c) | and oil (c) |
| A.I. | 50.0 | 50.0 | 50.0 |
| Triafamone | | | |
| Morwet ® | 6.0 | 6.0 | 6.0 |
| D425 | | | |
| Atlox ® 4913 | 20.0 | 20.0 | 20.0 |
| Synperonic ® | 12.5 | 12.5 | 12.5 |
| PE/F127 | | | |
| Polyox ® | 0.0 | 1.0 | 0.0 |
| WSR301 | | | |
| (PEO 4mio) | | | |
| Polyox ® | 0.0 | 0.0 | 2.0 |
| WSR N60K | | | |
| (PEO 2mio) | | | |
| Methylated | 0.0 | 12.0 | 12.0 |
| rapeseed oil | | | |
| Silwet ® 408 | 20.0 | 20.0 | 20.0 |
| Genapol C | 60.0 | 60.0 | 60.0 |
| 100 | | | |
| Xanthan | 3.1 | 3.1 | 3.1 |
| Van Gel ® B | 5.0 | 5.0 | 5.0 |
| Proxel ® | 1.8 | 1.8 | 1.8 |
| GXL | | | |
| Kathon ® | 0.8 | 0.8 | 0.8 |
| CG/ICP | | | |
| Glycerine | 80.0 | 80.0 | 80.0 |
| SAG ® 1572 | 3.6 | 3.6 | 3.6 |
| Na₂HPO₄ | 1.5 | 1.5 | 1.5 |
| (Buffer | | | |
| solution | | | |
| pH = 7) | | | |
| NaH₂PO₄ | 0.8 | 0.8 | 0.8 |
| (Buffer | | | |
| solution | | | |
| pH = 7) | | | |
| Water (add | To volume | To volume | To volume |
| to 1 litre) | (~854) | (~841) | (~840) |

The method of preparation used was according to Method 1.

### Physical Aspect

The physical aspect with regard to viscosity was assessed visually.

TABLE HB1.2
Physical aspect of recipes.

| | Drift reducing | |
|---|---|---|
| | polymer (b) | |
| | concentration | |
| Recipe | in recipe g/l | Physical aspect |
| HB3.1 | 0.0 | Fluid pourable suspension. |
| HB3.2 | 1.0 | Fluid pourable suspension. |
| HB3.3 | 2.0 | Fluid pourable suspension. |

### Spray Droplet Size

The spray droplet size was determined according to Method 2.

TABLE HB3.3
Driftable fraction of spray droplets.

| | | | | | Amount of | Amount of |
|---|---|---|---|---|---|---|
| | | | | | driftable | driftable |
| | | | | Spreading | droplet | droplet |
| | | Drift | Drift | and uptake | fraction | fraction |
| | | reducing | reducing oil | promoting | (at % | (at % |
| | | polymer (b) | (c) | agent (d) | vol <100 | vol <150 |
| | Spray | concentration | concentration | concentration | microns) | microns) |
| | volume | in recipe | in recipe | in recipe | from | from |
| Recipe | l/ha | g/l | g/l | g/l | recipe % vol | recipe % vol |
| HB3.1 | 1000 | 0.0 | 0.0 | 80.0 | 19.3 | 39.5 |
| | 200 | | | | 18.4 | 38.0 |
| | 40 | | | | 21.2 | 43.1 |
| | 20 | | | | 22.3 | 46.5 |
| | 10 | | | | 23.4 | 47.5 |
| | 5 | | | | 19.5 | 43.3 |
| HB3.2 | 1000 | 1.0 | 12.0 | 80.0 | 19.1 | 38.5 |
| | 200 | | | | 16.8 | 36.1 |
| | 40 | | | | 18.1 | 39.3 |
| | 20 | | | | 19.0 | 44.3 |
| | 10 | | | | 23.0 | 48.3 |
| | 5 | | | | 17.8 | 43.4 |
| HB3.3 | 1000 | 2.0 | 12.0 | 80.0 | 15.5 | 37.7 |
| | 200 | | | | 15.3 | 38.5 |
| | 40 | | | | 15.8 | 39.6 |
| | 20 | | | | 20.7 | 48.0 |
| | 10 | | | | 15.0 | 40.9 |
| | 5 | | | | 14.1 | 34.5 |

Formulations sprayed at a dose rate of 1 l/ha.

The results show that the combination of polymer Polyox® WSR N60K or Polyox® WSR 301 and methylated rapeseed oil can reduce the driftable fraction of spray droplets<100 microns and <150 microns over the spray volume range of 5 to 1000 l/ha.

TABLE HB3.4
Concentrations of drift reducing polymer, drift reducing oil and
spreading and uptake promoting agents in the spray dilution.

| | | | | Spreading and |
|---|---|---|---|---|
| | | Drift reducing | Drift reducing | uptake promoting |
| | | polymer (b) | oil (c) | agent (d) |
| | Spray | concentration | concentration | concentration |
| | volume | in spray liquid | in spray liquid | in spray liquid |
| Recipe | l/ha | g/l | g/l | g/l |
| HB3.1 | 1000 | 0.0 | 0.0 | 0.08 |
| | 200 | 0.0 | 0.0 | 0.4 |
| | 40 | 0.0 | 0.0 | 2.0 |
| | 20 | 0.0 | 0.0 | 4.0 |
| | 10 | 0.0 | 0.0 | 8.0 |
| | 5 | 0.0 | 0.0 | 16.0 |
| HB3.2 | 1000 | 0.001 | 0.012 | 0.08 |
| | 200 | 0.005 | 0.06 | 0.4 |
| | 40 | 0.025 | 0.3 | 2.0 |
| | 20 | 0.05 | 0.6 | 4.0 |
| | 10 | 0.1 | 1.2 | 8.0 |
| | 5 | 0.2 | 2.4 | 16.0 |
| HB3.3 | 1000 | 0.002 | 0.012 | 0.08 |
| | 200 | 0.01 | 0.06 | 0.4 |
| | 40 | 0.05 | 0.3 | 2.0 |
| | 20 | 0.1 | 0.6 | 4.0 |
| | 10 | 0.2 | 1.2 | 8.0 |
| | 5 | 0.4 | 2.4 | 16.0 |

Formulations sprayed at a dose rate of 1 l/ha.

### Example HB4: Methyl(2R*,4R*)-4-[[(5S)-3-(3,5-difluorophenyl)-5-vinyl-4H-isoxazole-5-carbonyl]amino]tetrahydrofuran-2-carboxylate SC 50

TABLE HB4.1
Recipes HB4.1, HB4.2 and HB4.3

| | | Recipe HB1.2 | Recipe HB1.3 |
|---|---|---|---|
| | | containing | containing |
| | | drift | drift |
| | Recipe | reducing | reducing |
| | HB1.1 | polymer (b) | polymer (b) |
| Component (g/l) | reference | and oil (c) | and oil (c) |
| A.I. Methyl(2R*,4R*)-4- | 50.0 | 50.0 | 50.0 |
| [[(5S)-3-(3,5- | | | |
| difluorophenyl)-5-vinyl- | | | |
| 4H-isoxazole-5- | | | |
| carbonyl]amino]tetra- | | | |
| hydrofuran-2-carboxylate | | | |
| Morwet ® D425 | 6.0 | 6.0 | 6.0 |
| Atlox ® 4913 | 20.0 | 20.0 | 20.0 |
| Synperonic ® PE/F127 | 12.5 | 12.5 | 12.5 |
| Polyox ® WSR301 | 0.0 | 1.0 | 0.0 |
| (PEO 4mio) | | | |
| Polyox ® WSR N60K | 0.0 | 0.0 | 2.0 |
| (PEO 2mio) | | | |
| Rapeseed oil methylester | 0.0 | 12.0 | 12.0 |
| Silwet ® 408 | 20.0 | 20.0 | 20.0 |
| Genapol C 100 | 60.0 | 60.0 | 60.0 |
| Xanthan | 3.1 | 3.1 | 3.1 |
| Van Gel ® B | 5.0 | 5.0 | 5.0 |
| Proxel ® GXL | 1.8 | 1.8 | 1.8 |
| Kathon ® CG/ICP | 0.8 | 0.8 | 0.8 |
| Glycerine | 80.0 | 80.0 | 80.0 |
| SAG ® 1572 | 3.6 | 3.6 | 3.6 |
| Na₂HPO₄ | 1.5 | 1.5 | 1.5 |
| (Buffer | | | |
| solution | | | |
| pH = 7) | | | |
| NaH₂PO₄ | 0.8 | 0.8 | 0.8 |
| (Buffer | | | |
| solution | | | |
| pH = 7) | | | |
| Water | To volume | To volume | To volume |
| (add to | (~854) | (~841) | (~840) |
| 1 litre) | | | |

The method of preparation used was according to Method 1.

### Physical Aspect

The physical aspect with regard to viscosity was assessed visually.

TABLE HB4.2
Physical aspect of recipes.

| | Drift reducing | |
|---|---|---|
| | polymer (b) | |
| | concentration | |
| Recipe | in recipe g/l | Physical aspect |
| HB4.1 | 0.0 | Fluid pourable suspension. |
| HB4.2 | 1.0 | Fluid pourable suspension. |
| HB4.3 | 2.0 | Fluid pourable suspension. |

### Spray Droplet Size

The spray droplet size was determined according to Method 2.

TABLE HB4.3
Driftable fraction of spray droplets.

| | | | | | Amount of | Amount of |
|---|---|---|---|---|---|---|
| | | | | | driftable | driftable |
| | | | | Spreading | droplet | droplet |
| | | Drift | Drift | and uptake | fraction | fraction |
| | | reducing | reducing oil | promoting | (at % | (at % |
| | | polymer (b) | (c) | agent (d) | vol <100 | vol <150 |
| | Spray | concentration | concentration | concentration | microns) | microns) |
| | volume | in recipe | in recipe | in recipe | from | from |
| Recipe | l/ha | g/l | g/l | g/l | recipe % vol | recipe % vol |
| HB4.1 | 1000 | 0.0 | 0.0 | 80 | 18.3 | 38.2 |
| | 200 | | | | 18.8 | 40.4 |
| | 40 | | | | 21.8 | 43.3 |
| | 20 | | | | 20.7 | 45.4 |
| | 10 | | | | 22.6 | 47.4 |
| | 5 | | | | 19.2 | 44.6 |
| HB4.2 | 1000 | 2.0 | 12.0 | 80.0 | 15.3 | 33.7 |
| | 200 | | | | 16.9 | 37.0 |
| | 40 | | | | 18.3 | 39.7 |
| | 20 | | | | 19.4 | 42.0 |
| | 10 | | | | 18.1 | 41.1 |
| | 5 | | | | 15.2 | 35.6 |
| HB4.3 | 1000 | 2.0 | 12.0 | 80.0 | 15.4 | 36.7 |
| | 200 | | | | 18.2 | 39.1 |
| | 40 | | | | 16.7 | 42.6 |
| | 20 | | | | 19.2 | 45.3 |
| | 10 | | | | 11.9 | 35.3 |
| | 5 | | | | 9.7 | 25.6 |

Formulations sprayed at a dose rate of 1 l/ha.

The results show that the combination of polymer Polyox® WSR N6K or Polyox® WSR 301 and methylated rapeseed oil can reduce the driftable fraction of spray droplets<100 microns and <150 microns over the spray volume range of 5 to 1000 l/ha.

TABLE HB4.4
Concentrations of drift reducing polymer, drift reducing oil and
spreading and uptake promoting agents in the spray dilution.

| | | | | Spreading and |
|---|---|---|---|---|
| | | Drift reducing | Drift reducing | uptake promoting |
| | | polymer (b) | oil (c) | agent (d) |
| | Spray | concentration | concentration | concentration |
| | volume | in spray liquid | in spray liquid | in spray liquid |
| Recipe | l/ha | g/l | g/l | g/l |
| HB4.1 | 1000 | 0.0 | 0.0 | 0.08 |
| | 200 | 0.0 | 0.0 | 0.4 |
| | 40 | 0.0 | 0.0 | 2.0 |
| | 20 | 0.0 | 0.0 | 4.0 |
| | 10 | 0.0 | 0.0 | 8.0 |
| | 5 | 0.0 | 0.0 | 16.0 |
| HB4.2 | 1000 | 0.001 | 0.012 | 0.08 |
| | 200 | 0.005 | 0.06 | 0.4 |
| | 40 | 0.025 | 0.3 | 2.0 |
| | 20 | 0.05 | 0.6 | 4.0 |
| | 10 | 0.1 | 1.2 | 8.0 |
| | 5 | 0.2 | 2.4 | 16.0 |
| HB4.3 | 1000 | 0.002 | 0.012 | 0.08 |
| | 200 | 0.01 | 0.06 | 0.4 |
| | 40 | 0.05 | 0.3 | 2.0 |
| | 20 | 0.1 | 0.6 | 4.0 |
| | 10 | 0.2 | 1.2 | 8.0 |
| | 5 | 0.4 | 2.4 | 16.0 |

Formulations sprayed at a dose rate of 1 l/ha.

### Example HB5: Dicamba-diglycolamin SL 110 (ae)

TABLE HB5.1
Recipes HB5.1 and HB5.2

| | | Recipe HB5.2 |
|---|---|---|
| | | containing |
| | | drift |
| | Recipe | reducing |
| | HB5.1 | polymer (b) |
| Component (g/l) | reference | and oil (c) |
| A.I. Dicamba- | 110.0 | 110.0 |
| diglycolamin | | |
| Diglycolamine | 52.7 | 52.7 |
| Crovol ® CR70 | 75.0 | 75.0 |
| Rapeseed oil methyl | 0.0 | 10.0 |
| ester | | |
| Synperonic ® | 1.0 | 1.0 |
| PE/F 127 | | |
| Polyox ® WSR | 0.0 | 1.5 |
| N60K | | |
| Glycerine | 0.0 | 0.4 |
| Water | To volume | To volume |
| (add to | (~812) | (~800) |
| 1 litre) | | |

The method of preparation used was according to Method 4.

### Physical Aspect

The physical aspect with regard to viscosity was assessed visually.

TABLE HB5.2
Physical aspect of recipes.

| | Drift reducing | |
|---|---|---|
| | polymer (b) | |
| | concentration | |
| Recipe | in recipe g/l | Physical aspect |
| HB5.1 | 0.0 | Fluid pourable liquid. |
| HB5.2 | 1.5 | Fluid pourable liquid. |

### Spray Droplet Size

The spray droplet size was determined according to Method 2.

TABLE HB5.3
Driftable fraction of spray droplets.

| | | | | | Amount of | Amount of |
|---|---|---|---|---|---|---|
| | | | | | driftable | driftable |
| | | | | Spreading | droplet | droplet |
| | | Drift | Drift | and uptake | fraction | fraction |
| | | reducing | reducing oil | promoting | (at % | (at % |
| | | polymer (b) | (c) | agent (d) | vol <100 | vol <150 |
| | Spray | concentration | concentration | concentration | microns) | microns) |
| | volume | in recipe | in recipe | in recipe | from | from |
| Recipe | l/ha | g/l | g/l | g/l | recipe % vol | recipe % vol |
| HB5.1 | 1000 | 0.0 | 0.0 | 70.0 | 23.1 | 45.1 |
| | 200 | | | | 22.2 | 44.4 |
| | 40 | | | | 26.5 | 51.3 |
| | 20 | | | | 25.5 | 49.8 |
| | 10 | | | | 25.8 | 51.2 |
| | 5 | | | | 24.2 | 49.1 |
| HB5.2 | 1000 | 1.5 | 10.0 | 70.0 | 13.5 | 33.7 |
| | 200 | | | | 18.1 | 39.9 |
| | 40 | | | | 14.4 | 35.6 |
| | 20 | | | | 7.5 | 19.9 |
| | 10 | | | | 4.7 | 11.9 |
| | 5 | | | | 4.2 | 10.0 |

Formulations sprayed at a dose rate of 2 l/ha.

The results show that the combination of polymer Polyox® WSR N60K and methylated rapeseed oil can reduce the driftable fraction of spray droplets<100 microns and <150 microns over the spray volume range of 5 to 1000 l/ha.

TABLE HB5.4
Concentrations of drift reducing polymer. drift reducing oil and
spreading and uptake promoting agents in the spray dilution.

| | | | | Spreading and |
|---|---|---|---|---|
| | | Drift reducing | Drift reducing | uptake promoting |
| | | polymer (b) | oil (c) | agent (d) |
| | Spray | concentration | concentration | concentration |
| | volume | in spray liquid | in spray liquid | in spray liquid |
| Recipe | l/ha | g/l | g/l | g/l |
| HB5.1 | 1000 | 0.0 | 0.0 | 0.15 |
| | 200 | 0.0 | 0.0 | 0.7 |
| | 40 | 0.0 | 0.0 | 3.5 |
| | 20 | 0.0 | 0.0 | 7.0 |
| | 10 | 0.0 | 0.0 | 14.0 |
| | 5 | 0.0 | 0.0 | 28.0 |
| HB5.2 | 1000 | 0.003 | 0.02 | 0.15 |
| | 200 | 0.015 | 0.1 | 0.7 |
| | 40 | 0.075 | 0.5 | 3.5 |
| | 20 | 0.15 | 1.0 | 7.0 |
| | 10 | 0.3 | 2.0 | 14.0 |
| | 5 | 0.6 | 4.0 | 28.0 |

Formulations sprayed at a dose rate of 2 l/ha.

1. An agrochemical formulation comprising
a) one or more active ingredients,
b) one or more polymer-based drift reducing additives selected from poly(ethyleneoxide) (PEO) and hydroxypropylated guar,
c) one or more oil-based drift reducing additives,
d) one or more spreading or uptake promoting additives,
e) other formulants,
f) one or more carriers to volume, wherein at least one carrier is water,
characterized in that
a) is present in 10-550 g/l,
b) is present in 0.2-50 g/l,
c) is present in 0.5-45 g/l,
d) is present in 10-200 g/l,
e) is present in 20-300 g/l.

2. An agrochemical formulation according to claim 1, wherein
a) is present in 20-200 g/l,
b) is present in 1-15 g/l,
c) is present in 5-25 g/l,
d) is present in 25-140 g/l,
e) is present in 30-135 g/l,
f) carrier to volume.

3. An agrochemical formulation according to claim 1, wherein b) is selected from the group comprising poly(ethylene oxide) with an average molecular weight from 0.5 to 14 million g/mol.

4. An agrochemical formulation according to claim 3, wherein the formulation has a Polymer Concentration Factor (PCF) between 1 and 10.

5. An agrochemical formulation according to claim 4, wherein the Polymer Concentration Factor (PCF) for the poly(ethylene oxide) (PEO) content in the formulation is calculated from the following equation:
$$P C F = C \times {M}^{a} \times D$$
where C is the drift reducing polymer (a) concentration in the formulation (g/1), M is the molar mass of the drift reducing polymer (a) (g/mol/1×10⁶), α has a value of 1.4 and D is the formulation dose rate per ha (l/ha).

6. An agrochemical formulation according to claim 1, wherein c) is selected from vegetable oils, vegetable oil esters, and vegetable oil diesters.

7. An agrochemical formulation according to claim 1 wherein the spreading agent d) is selected from the group comprising sodium dioctylsulfosuccinate, polyalkyleneoxide modified heptamethyltrisiloxanes, ethoxylated diacetylene-diols with 1 to 6 ethylenoxide units or ethoxylated alcohols or propoxy-ethoxylated alcohols with 6-22 carbon atoms and an average of 5-40 ethylenoxide or propylenoxide units.

8. An agrochemical formulation according to claim 1, wherein the uptake promoting additive d) is selected from the group comprising alcohol alkoxylates comprising 6-22 carbon atoms, ethoxylated carboxylic acids or propoxy-ethoxylated carboxylic acids comprising 6-22 carbon atoms, ethoxylated mono-, di- or triesters of glycerine comprising fatty acids with 8-18 carbon atoms and an average of 5-60 ethyleneoxide units, alkoxylated sorbitan fatty acid esters comprising fatty acids with 8-18 carbon atoms and an average of 10-50 ethylene oxide and propylene oxide units, ethoxylated coconut alcohols comprising 2-20 EO units or castor oil ethoxylates comprising an average of 5-40 EO units.

9. An agrochemical formulation according to claim 1 wherein the ratio in the formulation of b) to c) is from 1:40 to 10:1.

10. An agrochemical formulation according to claim 1, wherein the ratio in the formulation of b) to c) to d) is from 1:40:150 to 10:1:10.

11. An agrochemical formulation according to claim 1, wherein the active ingredient is selected from the group consisting of trifloxystrobin, bixafen, prothioconazole, inpyrfluxam, isoflucypram, fluoxapiprolin, spirotetramat, ethiprole, deltamethrin, triafamone, Tembotrione, ethofumesate and Methyl(2R*,4R*)-4-[[(5S)-3-(3,5-difluorophenyl)-5-vinyl-4H-isoxazole-5-carbonyl]amino]tetrahydrofuran-2-carboxylate.

12. An agrochemical formulation according to claim 1, wherein the other formulants e) are one or more substances selected from rain-fast additives, surfactants, rheological modifiers, antifoam substances, antifreeze agents, preservatives, biocides, colourants, pH adjusters, buffers, stabilisers, antioxidants, inert filling materials, humectants, crystal growth inhibitors or micronutrients.

13. An agrochemical formulation according to claim 11, wherein the other formulants e) comprise at least one non-ionic surfactant or ionic surfactant, one rheological modifier, one antifoam substance and at least one antifreeze agent.

14. A method of applying a formulation according to claim 1 onto crops, wherein the formulation is applied at a spray volume of between 1 l/ha to 2000 l/ha.

15. A method of applying an agrochemical formulation according to claim 1 onto crops, wherein the formulation is applied at a spray volume of between 1 and 20 l/ha.

16. The use of an agrochemical formulation according to claim 1 to deliver to the agricultural target plot in an amount of b) between 0.5 and 15 g/ha, and an amount of c) between 0.5 and 40 g/ha, and an amount of d) between 10 and 200 g/ha.

17. The use of an agrochemical formulation according to claim 1 in application of agrochemical compounds for controlling harmful organisms, wherein a formulation or spray liquid containing the formulation is applied by an unmanned aerial vehicle UAV or an unmanned guided vehicle UGV or a spray nozzle device using pulse width modulation PWM.
